(19) United States
(12) Patent Application Publication
(10) Pub. No.: US 2026/0269250 A1
(43) Pub. Date: Sep. 10, 2026

(54) HYBRID ORGANIC-INORGANIC REDOX ACTIVE MATERIAL AND RELATED COMPOSITES, COMPOSITIONS, ELECTRODE MATERIAL, ELECTRODES, ELECTROCHEMICAL CELLS, BATTERIES, METHODS AND SYSTEMS

(71) Applicant: LiNova Energy Inc., Monrovia, CA (US)

(72) Inventors: Jasim UDDIN, Pasadena, CA (US); Wilson NG, Los Angeles, CA (US); Mufeng WEI, Arcadia, CA (US); Simon JONES, Monrovia, CA (US); Zeiad MUNTASSER, Arcadia, CA (US); Lin-Feng LI, Croton-on-Hudson, NY (US)

(21) Appl. No.: 19/352,069

(22) Filed: Oct. 7, 2025

Related U.S. Application Data
(60) Provisional application No. 63/704,550, filed on Oct. 7, 2024.

(51) Int. Cl. H01M 4/60; C08G 75/14; H01G 11/30; H01M 4/02; H01M 4/04; H01M 4/137; H01M 4/1399; H01M 4/587; H01M 4/62

(52) U.S. Cl. CPC H01M 4/606; C08G 75/14; H01G 11/30; H01M 4/0404; H01M 4/137; H01M 4/1399; H01M 4/587; H01M 4/628; H01M 2004/021; H01M 2004/028

(57) ABSTRACT

Provided herein hybrid organic-inorganic redox active materials and related composites, compositions, electrode materials, electrodes electrochemical cells, batteries, methods and systems, which, can be used as to provide high performance cathode active materials in high capacity, high energy density, safe, and long-lasting electrochemical cells and batteries when coupled with Li, Na, K, graphite, lithiated graphite, in situ lithiated graphite, silicon, lithiated silicon, in situ lithiated silicon, silicon-graphite, in situ lithiated silicon-graphite, hard carbon, sodiated hard carbon, graphite-silicone, lithiated graphite-silicon etc. anodes in non-aqueous electrolytes.

### CROSS REFERENCE TO RELATED APPLICATIONS

This application claims priority to U.S. provisional application No. 63/704,550, entitled “hybrid organic-inorganic redox active material, and related composites, compositions, electrode materials, electrodes, electrochemical cells, batteries, methods, and systems” filed on Oct. 7, 2024, with attorney docket P3087-USP, the content of which is herein incorporated by reference in its entirety. This application is also related to U.S. provisional application No. 63/339,684, entitled “S-linked Quinone Polymers, Sulfurized Carbon Matrices and Related Composites, Compositions, Electrode Material, Electrodes, Electrochemical Cells, Batteries, Methods and Systems,” filed on May 9, 2022, related to U.S. application Ser. No. 18/144,806, entitled “S-linked quinone polymers, sulfurized carbon matrices and Related Composites, Compositions, Electrode Material, Electrodes, Electrochemical Cells, Batteries, Methods, and Systems,” filed on May 8, 2023 and published as US20240026082, and related to International application No. PCT/US23/21414 entitled “S-linked Quinone Polymers, Sulfurized Carbon matrices and Related Composites, Compositions, Electrode Material, Electrodes, Electrochemical Cells, Batteries, Methods, and Systems,” filed on May 8, 2023 and published as WO2023219977, the content of each of which are incorporated herein by reference in their entirety.

### FIELD

The present disclosure relates to electrode active materials, and battery systems that feature electrodes incorporating organosulfur redox active matrices. In particular, the present disclosure relates to a hybrid organic-inorganic redox active material, and related composites, compositions, electrode materials, electrodes, electrochemical cells, batteries, methods, and systems, that can be used to improve electrochemical cells and batteries. performance.

### BACKGROUND

Performance, economics, and safety has been at the center of various efforts to improve electrode active materials and battery technologies.

Despite progresses made in the recent years, however, production for high reliability, high capacity, long-life, cheap and/or safe energy storage devices is still challenging, in particular with reference to batteries in large-scale applications, for example in, electric vehicles, utility grid storage supporting renewable power generation or in full-home backup battery installations.

### SUMMARY

Described herein is hybrid organic-inorganic redox active material and related composites, compositions, electrode material, electrodes electrochemical cells, batteries, methods and systems, which, in several embodiments, allow production of high performance redox active materials which can be used as cathode active materials in high capacity, high energy density, safe, good cycling stability and long-lasting electrochemical cells and batteries with non-aqueous electrolytes.

According to a first aspect, a hybrid organic-inorganic redox active composite material is described, comprising an organic redox active material and an inorganic additive in weight ratios from 3:1 to 49:1, possibly from 4:1 to 35:1, 3:1 to 30:1, or 4:1 to 19:1, and with weight ratios from 91:9 to 93:7.

In the hybrid organic-inorganic redox active composite material, the organic redox active material has a redox active material density and comprises a sulfurized carbon matrix represented by Formula (V),

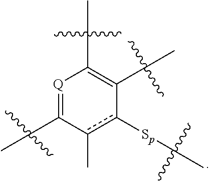

wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, and wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt %, and less than 60 wt %, equal to or greater than 60 wt %, and less than 70 wt %, or equal to or greater than 70 wt % and less than 80 wt %.

In the hybrid organic-inorganic redox active composite material, the organic redox active material forms redox active aggregates each having an organic redox active aggregate size and an organic redox active aggregate surface area.

In the hybrid organic-inorganic redox active composite material, the inorganic additive is an inorganic material which has an inorganic material density higher than the redox active material density preferably ≥2 g/cm³, and lower than 6.0 g/cm³, and which is chemically inert with respect to the organic redox active material.

According to a second aspect, a hybrid organic-inorganic redox active composite material is described, comprising an organic redox active material and an inorganic additive in weight ratios from 3:1 to 49:1, possibly from 4:1 to 35:1, or from 3:1 to 30:1, possibly from 4:1 to 19:1.

In the hybrid organic-inorganic redox active composite material, the organic redox active material has a redox active material density and comprises a sulfurized carbon matrix represented by Formula (V),

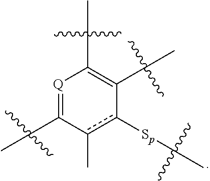

wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, and wherein the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % and less than 60 wt %, equal to or greater than 60 wt % and less than 70 wt %, or equal to or greater than 70 wt % and less than 80 wt %.

In the hybrid organic-inorganic redox active composite material, the organic redox active material forms redox active aggregates each having an organic redox active aggregate size and an organic redox active aggregate surface area.

In the hybrid organic-inorganic redox active composite material, the inorganic additive is an inorganic material which has an inorganic material density higher than the redox active material density preferably ≥2 g/cm³, and lower than 6.0 g/cm³, and which is chemically inert with respect to the organic redox active material. In the hybrid organic-inorganic redox active material, the inorganic additive material is in the form of inorganic particles each having an inorganic particle size and an inorganic particle surface area.

In the hybrid organic-inorganic redox active composite material, the redox active aggregate size and the inorganic particles size are in a ratio from 20:1 to 5:1, and the inorganic particle surface is ≥1 X, possibly up to 10× or higher, the redox aggregate surface area.

According to a third aspect a method and a system are described to provide an hybrid organic-inorganic redox active composite material of the disclosure. The method comprises mixing an organic redox active material of the disclosure and an inorganic additive material of the disclosure optionally in a solvent to provide a redox active composite material comprising the organic redox active material and the inorganic additive material.

The system to provide a hybrid organic-inorganic redox active composite material of the disclosure, comprises one or more organic redox active material in the sense of the disclosure and one or more inorganic additive material and optionally a solvent in amounts and formulation enabling the related combined use in the method to provide hybrid organic-inorganic redox active composite material of the disclosure.

According to a fourth aspect, a cathode material is described wherein the cathode material comprises at least one of the hybrid organic-inorganic redox active material herein described in a configuration enabling sufficient contact with a non-aqueous electrolyte of an electrochemical cells and electrical conductivities optionally in combination with at least one an additive, such as a binder or a filler.

According to a fifth aspect a method and system to provide a cathode material are described. The method comprises mixing one or more hybrid organic-inorganic redox active composite materials of the disclosure together with a coating solvent at least an additive to provide a redox composition and/or a redox composite configured and coating the redox composition and/or redox composite on a current collector to provide a cathode material configured to enable sufficient contact with a non-aqueous electrolyte of an electrochemical cells and electrical conductivities.

The system to provide a cathode material of the disclosure comprises at least one hybrid organic-inorganic redox active composite material herein described and a current collector optionally together with an additive for combined use to provide a cathode material according to the fourth aspect herein described.

According to a sixth aspect a method and a system are described to screen one or more inorganic additives to be combined with a set organic redox active material to provide a hybrid organic-inorganic redox active material of the disclosure. The method comprises providing a testing cathode material in which a hybrid organic-inorganic redox active material of the disclosure comprises the set organic redox active material in combination with a candidate inorganic additive. The method further comprises detecting at least one of discharge capacity, specific energy, volumetric energy density and cyclability of the testing cathode material and selecting the candidate inorganic additive when the testing cathode material has at least one of a detected discharge capacity higher than a set threshold, a detected specific energy volumetric higher than a set threshold a detected energy density higher than a set threshold and a detected cyclability higher than a set threshold.

The system screen inorganic additive comprises one or more candidate inorganic additive (e. g. different inorganic material, or same material, having same or different shapes, sizes and surfaces areas), one or more organic redox active material (e.g. SPoly or other matrices alone or in combination with redox active polymers) and a suitable solvent (preferably water), in one or more combinations directed to test the candidate inorganic additive according to the screening methods of the disclosure.

According to a seventh aspect a method and system to manufacture a hybrid organic-inorganic material of the disclosure is described. The method comprises providing an organic redox active material of the disclosure and an inorganic additive selected by the screening method of the disclosure for combination with the organic redox active material. The method comprises mixing the organic redox active material with the selected inorganic additive to provide a hybrid organic-inorganic material of the disclosure.

The system comprises one or more organic redox active material of the disclosure and one or more inorganic additives selected by the screening method of the disclosure to be combined with the one or more organic redox active material, In the system the one or more organic redox active material and the one or more inorganic additives are comprised in amounts and formulations for combined use in the manufacture in a hybrid organic-inorganic redox active material of the disclosure.

According to an eighth aspect a hybrid organic-inorganic redox active material is described obtained by any one of the methods of the disclosure to provide or manufacture the hybrid organic-inorganic redox active material of the disclosure.

According to a ninth aspect, an electrochemical cell is described. The electrochemical cell comprises an anode, a cathode, and a non-aqueous electrolyte, wherein the cathode electrode comprises a cathode material described herein. In preferred embodiments, the anode comprises alkali-ion battery anode materials, preferably lithium anode material, or graphite anode material or lithiated graphite material, or in situ lithiated graphite anode material, or a hard carbon anode material, or potassium anode material, or sodium anode material, or in situ sodiated hard carbon anode material aluminum (Al) anode material, Magnesium (Mg) anode material, Al—Mg alloys as anode material, Li—Al alloys as anode material or a combination thereof as will be understood by a skilled person.

According to a tenth aspect, a electrochemical cell are herein described, the electrochemical cell comprising an anode, a cathode and a non-aqueous electrolyte, wherein the cathode electrode material herein described.

According to an eleventh aspect, a method and system are described to provide an electrochemical cell herein described. The method comprises combining an anode electrode with a cathode electrode comprising any cathode material herein described.

The system comprises any one of the cathode materials herein described in combination with an anode material for combined use in the method to provide an electrochemical cell herein described. In preferred embodiments of the methods and systems according to the seventh aspect, the anode comprises alkali-ion battery anode materials preferably lithium anode material, or graphite anode material or lithiated graphite material, or in situ lithiated graphite anode material, or a hard carbon anode material, or potassium anode material, or sodium anode material, or in situ sodiated hard carbon anode material aluminum (Al) anode material, Magnesium (Mg) anode material, Al—Mg alloys as anode material, Li—Al alloys as anode material or a combination thereof.

According to a twelfth aspect, a battery is described, the battery comprising at least one electrochemical cell herein described.

The hybrid organic-inorganic redox active material and related composites, compositions, electrode material, electrodes electrochemical cells, batteries, methods and systems, allow in several embodiments to provide batteries with increased performance in terms of terms of specific energy (Wh/kg) and volumetric energy density (Wh/L), by developing a dense cathode material (electrode packing density >1.2 g/cm³) having a high areal capacity loading (3 mAh/cm² or higher) which is a major challenge for many application of alkali metal or metal ion batteries with organic carbon matrix.

Accordingly, the hybrid organic-inorganic redox active material and related composites, compositions, electrode material, electrodes electrochemical cells, batteries, methods and systems, allow in several embodiments to provide batteries with an increased specific energy with respect to the organic redox active material alone.

In particular, hybrid organic-inorganic redox active material and related composites, compositions, electrode material, electrodes electrochemical cells, batteries, methods and systems, allow in several embodiments to provide a battery with a specific energy >1100 Wh/kg, possibly >1200 Wh/kg, or >1250 Wh/kg all measured at 10-hour discharge/charge rate (0.1 C rate).

The hybrid organic-inorganic redox active material and related composites, compositions, electrode material, electrodes electrochemical cells, batteries, methods and systems, by increasing the electrode packing density (g/cm³) and areal capacity loading (mAh/cm²) of the cathode material, also allow in several embodiments to provide batteries with a cyclability higher than two times or more the cyclability of the organic redox active material alone.

In particular, the hybrid organic-inorganic redox active material and related composites, compositions, electrode material, electrodes electrochemical cells, batteries, methods and systems herein described, allow in several embodiments to provide a battery with a cyclability >100 cycles to 80% original capacity, possibly >150 cycles, and possibly >200 cycles, possibly >300 cycles, possibly greater than 400 cycles up to 1000 or up to 10000 cycles.

In view of the related features, the hybrid organic-inorganic redox active material and related composites, compositions, electrode material, electrodes electrochemical cells, batteries, methods and systems, further allow in several embodiments to provide batteries having longer cycle life than the organic redox material alone. In some embodiments, the inorganic materials with redox activity can provide additional capacities when the cells are cycled within certain voltage ranges.

The hybrid organic-inorganic redox active material and related composites, compositions, electrode material, electrodes electrochemical cells, batteries, methods and systems, can be used in connection with applications wherein electrochemical cell with high capacity, long life, low safety hazards, low spatial footprint and/or low replacement are desired. Exemplary applications comprise batteries for electric vehicles, grid storage, telecommunication, automotive start-stop.

The details of one or more embodiments of the disclosure are set forth in the accompanying drawings and the description below. Other features and objects will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, explain the principles and implementations of the disclosure.

FIG. 1 top panel shows a schematic representation of an exemplary electrochemical cell including a Li anode and a cathode comprising an organic-inorganic hybrid material herein described. FIG. 1 bottom panel shows a schematic representation of an exemplary Pouch Housing electrochemical cell including a Li anode and a cathode comprising an organic-inorganic hybrid material herein described.

FIG. 2 shows exemplary arrangement of a plurality of electrochemical cells in a battery herein described.

FIG. 3 shows a schematic representation of an exemplary plurality of electrically connected electrochemical cells in accordance with the disclosure.

FIG. 4 shows structures of sulfurized organic carbon matrix (SPoly) capable of being used as one component in combination with S-linked organosulfur quinone polymers described in FIGS. 6 and 7. Sulfurized carbon matrix SPoly (1), covalent triazine frameworks (S-CTF-1) (2), Covalent triazine frameworks (SF-CTF-1) (3) Poly(Sulfur random-1,3-diisopropylbenzene)(Poly(S-r-DIB) (4), S—BOP (5), Carbon/polymeric sulfur (C/PS) composites (6), Covalently grafted polysulfur graphene, nanocomposite (PolySGN, 7), Graphene-supported crosslinked sulfur copolymer nanoparticles, cp(STTCA)@rGO-80 (8) are examples of sulfurized carbon matrices comprising a polymer wherein S is present, for example, as C—S, C—S—S, C—S—S—S, C—S—S—S—S, C—S—S—S—S—S bonds, as will be understood by a skilled person upon reading of the present disclosure.

FIG. 5 shows a comparison of the structures of elemental S (S₈) and a sulfurized organic carbon matrix polymer (herein also identified as SPoly).

FIG. 6 shows a Table of exemplary S-linked organosulfur polymers including PAQS (11, herein also known as Gen1), 36PPAQS (12), 27PPAQS (13), and PAQT (14) as cathode redox active material and the theoretical capacity (mAh/g), voltage vs. Li/Li⁺ and theoretical energy density (Wh/kg) in a lithium battery. The molecular weight these polymers range from 1,000 Da to 2,000,000 Da. As can be understood by a skilled person, theoretical values consider the amount of charge available to transfer per unit mass or volume by looking at the basic electrochemical processes in the redox reaction (number of electrons, voltage, mass).

FIG. 7 shows structures of S-linked quinone polymers PAQS (11, herein also identified as Gen1), 36PPAQS (12), 27PPAQS (13), PAQT (14), and PBQS (15). The molecular weight of these polymers ranges from 1,000 Da to 2,000,000 Da.

FIG. 8 shows structures of the copolymers of PAQS and PAQT and PBQS. The molecular weight of these polymers ranges from 1,000 Da to 2,000,000 Da.

FIG. 9. Voltage profile for Li-LFP cell at C/10 within the voltage range 1.0-3.6 V. In particular, FIG. 9 shows a chart reporting voltages for electrochemical cells comprising exemplary Li-LFP cell described herein in Example 20. The y-axis indicates the voltage of the cell. The x-axis reports the detected discharge capacity (mAh/g) expressed as milliampere-hours per gram which indicates the energy storage capability of the cell. The curves represent the charge step, and discharge step within the voltage range 1.0-3.6 V.

FIG. 10: Cycling data for the Li-LFP cell with different voltage cutoffs at C/10. In particular FIG. 10, shows a chart reporting the electrochemical cycling performance of an exemplary Li-LFP cell described in Example 20. The y-axis shows the detected discharge capacity (mAh/g) expressed as milliampere-hours per gram which indicates the energy storage capability of the cell. The x-axis shows the number of cycles, which includes only discharge steps.

FIG. 11: Voltage profile for Li-organic sulfurized carbon matrix (SPoly) cell at C/10. In particular, FIG. 11 shows a chart reporting voltages for an exemplary Li-organic sulfurized carbon matrix (SPoly) electrochemical cell described in Example 21. The y-axis indicates the voltage of the cell. The x-axis reports the detected discharge capacity (mAh/g) expressed as milliampere-hours per gram which indicates the energy storage capability of the cell. The curves represent a charge step, and a discharge step.

FIG. 12: Cycling data for Li-organic sulfurized carbon matrix (SPoly) cell at C/10. In particular, FIG. 12 shows a chart reporting the electrochemical cycling performance of an exemplary Li-SPoly cell described in Example 21. The y-axis shows the detected discharge capacity (mAh/g) expressed as milliampere-hours per gram which indicates the energy storage capability of the cell. The x-axis shows the number of cycles, which includes only the discharge steps.

FIG. 13: Voltage profile for Li-SPoly:LFP hybrid organic-inorganic cathode cell at C/10. In particular FIG. 13 shows a chart reporting voltages for an exemplary electrochemical cells comprising an Li-SPoly:LFP cathode described in Example 22. The y-axis indicates the voltage of the cell. The x-axis reports the detected discharge capacity (mAh/g) expressed as milliampere-hours per gram which indicates the energy storage capability of the cell. The curves represent a charge step, and a discharge step.

FIG. 14: Cycling data for Li-SPoly:LFP hybrid organic-inorganic cathode cell at C/10. In particular, FIG. 14, shows a chart reporting the electrochemical cycling performance of an exemplary Li-SPoly:LFP cathode described in Example 22. The y-axis shows the detected discharge capacity (mAh/g) expressed as milliampere-hours per gram which indicates the energy storage capability of the cell. The x-axis shows the number of cycles, which includes only the discharge steps.

FIG. 15: Voltage profile for Li-SPoly:Gen1:LFP hybrid organic-inorganic cathode cell at C/10. In particular FIG. 15 shows a chart reporting voltages for an exemplary electrochemical cell comprising a Li-SPoly:Gen1:LFP cell described in Example 23. The y-axis indicates the voltage of the cell. The x-axis reports the detected discharge capacity (mAh/g) expressed as milliampere-hours per gram which indicates the energy storage capability of the cell. The curve represents a charge step, and a discharge step.

FIG. 16: Cycling data for Li-SPoly:Gen1:LFP hybrid organic-inorganic cathode cell at C/10. In particular FIG. 16 shows a chart reporting the electrochemical cycling performance of an exemplary Li-SPoly:Gen1:LFP cathode cell described in Example 23. The y-axis shows the discharge capacity (mAh/g) expressed as milliampere-hours per gram which indicates the energy storage capability of the cell. The x-axis shows the number of cycles, which includes only the discharge steps.

FIG. 17: Voltage profile for Li-LTO cathode cell at C/10. In particular FIG. 17 shows a chart reporting voltages for electrochemical cells comprising Li-LTO cathode described in Example 24. The y-axis indicates the voltage of the cell. The x-axis reports discharge capacity (mAh/g) expressed as milliampere-hours per gram which indicates the energy storage capability of the cell. The curve represents a charge step, and a discharge step.

FIG. 18: Cycling data for Li-LTO cathode cell at C/10. In particular, FIG. 18 shows a chart reporting the electrochemical cycling performance of an exemplary electrochemical cell comprising Li-LTO cathode described in Example 24. The y-axis shows the discharge capacity (mAh/g) expressed as milliampere-hours per gram which indicates the energy storage capability of the cell. The x-axis shows the number of cycles, which includes only the discharge steps.

FIG. 19: Voltage profile for Li-SPoly:LTO hybrid organic-inorganic cathode cell at C/10. In particular FIG. 19 shows a chart reporting voltages for an exemplary electrochemical cell comprising Li-SPoly:LTO cathode described in Example 25. The y-axis indicates the voltage of the cell. The x-axis reports the discharge capacity (mAh/g) expressed as milliampere-hours per gram which indicates the energy storage capability of the cell. The curve represents a charge step, and a discharge step.

FIG. 20: Cycling data for Li-SPoly:LTO hybrid organic-inorganic cathode cell at C/10. In particular FIG. 20 shows a chart reporting the electrochemical cycling performance of an exemplary electrochemical cell comprising a Li-SPoly:LTO cathode described in Example 25. The y-axis shows the discharge capacity (mAh/g) expressed as milliampere-hours per gram which indicates the energy storage capability of the cell. The x-axis shows the number of cycles, which includes only the discharge steps.

FIG. 21: Voltage profile for Li-SPoly:Gen1:LTO hybrid organic-inorganic cathode cell at C/10. In particular FIG. 21 shows a chart reporting voltages for an exemplary electrochemical cell comprising Li-SPoly:Gen1:LTO cathode cell described in Example 26. The y-axis indicates the voltage of the cell. The x-axis reports discharge capacity (mAh/g) expressed as milliampere-hours per gram which indicates the energy storage capability of the cell. The curves represent a charge step, and a discharge step.

FIG. 22: Cycling data for Li-SPoly:Gen1:LTO hybrid organic-inorganic cathode cell at C/10. In particular FIG. 22 shows a chart reporting the electrochemical cycling performance of an exemplary Li-SPoly:Gen1:LTO cathode cell described in Example 26. The y-axis shows the discharge capacity (mAh/g) expressed as milliampere-hours per gram which indicates the energy storage capability of the cell. The x-axis shows the number of cycles, only the discharge steps.

FIG. 23: Voltage profile for Li—TiS₂ cell at C/10. In particular, FIG. 23 shows a chart reporting voltages for an exemplary Li—TiS₂ electrochemical cell described in Example 27. The y-axis indicates the voltage of the cell. The x-axis reports the detected discharge capacity (mAh/g) expressed as milliampere-hours per gram which indicates the energy storage capability of the cell. The curves represent a charge step, and a discharge step.

FIG. 24: Cycling data for Li—TiS₂ cell at C/10. In particular, FIG. 24 shows a chart reporting the electrochemical cycling performance an exemplary Li—TiS₂ cell discussed in Example 27. The y-axis shows the detected discharge capacity (mAh/g) expressed as milliampere-hours per gram which indicates the energy storage capability of the cell. The x-axis shows the number of cycles, which includes only the discharge steps.

FIG. 25: Voltage profile for Li-SPoly:TiS₂ hybrid organic-inorganic cathode cell at C/10. In particular FIG. 25 shows a chart reporting voltages for an exemplary Li-SPoly:TiS₂ electrochemical cell described in Example 28. The y-axis indicates the voltage of the cell. The x-axis reports the detected discharge capacity (mAh/g) expressed as milliampere-hours per gram which indicates the energy storage capability of the cell. The curves represent a charge step, and a discharge step.

FIG. 26: Cycling data for Li-SPoly:TiS₂ hybrid organic-inorganic cathode cell at C/10. In particular FIG. 26 shows a chart reporting the electrochemical cycling performance of an n exemplary Li-SPoly:TiS₂ cell described in Example 28. The y-axis shows the detected discharge capacity (mAh/g) expressed as milliampere-hours per gram which indicates the energy storage capability of the cell. The x-axis shows the number of cycles, which includes only the discharge steps.

FIG. 27: Voltage profile for Li-SPoly:Al₂O₃ hybrid organic-inorganic cathode cell at C/10. In particular FIG. 27 shows a chart reporting voltages for an exemplary Li-SPoly:Al₂O₃ electrochemical cell described in Example 29. The y-axis indicates the voltage of the cell. The x-axis reports the detected discharge capacity (mAh/g) expressed as milliampere-hours per gram which indicates the energy storage capability of the cell. The curves represent a charge step, and a discharge step.

FIG. 28: Cycling data for Li-SPoly:Al₂O₃ hybrid organic-inorganic cathode cell at C/10. In particular FIG. 28 shows a chart reporting the electrochemical cycling performance of an exemplary Li-SPoly:Al₂O₃ cell described in Example 29. The y-axis shows the detected discharge capacity (mAh/g) expressed as milliampere-hours per gram which indicates the energy storage capability of the cell. The x-axis shows the number of cycles, which includes only the discharge steps.

FIG. 29: Voltage profile for Li-SPoly:DAAQ-TFP-COF cell at C/10. In particular FIG. 29 shows a chart reporting voltages for an exemplary SPoly:DAAQ-TFP-COF electrochemical cells described in Example 30. The y-axis shows the detected discharge capacity (mAh/g) expressed as milliampere-hours per gram which indicates the energy storage capability of the cell. The curves represent a charge step and a discharge step.

FIG. 30: Cycling data for Li-SPoly:DAAQ-TFP-COF cell at C/10. In particular FIG. 30 shows a chart reporting the electrochemical cycling performance of an exemplary SPoly:DAAQ-TFP-COF electrochemical cells described in Example 30. The y-axis shows the detected discharge capacity (mAh/g) expressed as milliampere-hours per gram which indicates the energy storage capability of the cell. The x-axis shows the number of cycles, which includes only the discharge steps.

FIG. 31: Voltage profiles for SPoly, SPoly:LTO and SPoly:TiS₂ cathodes with the electrode densities of 1.3 g/cm³ cells at C/10. In particular FIG. 31 shows a chart reporting voltages for electrochemical cells comprising exemplary SPoly, SPoly:LTO and SPoly:TiS₂ cathodes described in Examples 21, 25, 28. The y-axis indicates the voltage of the cell. The x-axis reports the detected discharge capacity (mAh/g) expressed as milliampere-hours per gram which indicates the energy storage capability of the cell. The curves represent the charge steps, and discharge steps.

FIG. 32: Voltage profiles for SPoly, SPoly:DAAQ-TFP:COF and SPoly:LTO cathodes with the electrode densities of 1.3 g/cm³ cells at C/10. In particular FIG. 32 shows a chart reporting voltages for electrochemical cells comprising exemplary SPoly, SPoly:DAAQ-TFP:COF and SPoly:LTO cathodes described in Examples 21, 30, 25. The y-axis indicates the voltage of the cell. The x-axis reports the detected discharge capacity (mAh/g) expressed as milliampere-hours per gram which indicates the energy storage capability of the cell. The curves represent the charge steps, and discharge steps.

FIG. 33: Voltage profile for in situ lithiated graphite (LiGr)-SPoly:LFP hybrid organic-inorganic cathode cell at C/10. In particular FIG. 33 shows a plot reporting the cell voltage for an exemplary electrochemical cell comprising an in situ lithiated graphite (LiGr) anode (Example 41) and an organic-inorganic hybrid cathode (SPoly:LFP, 91:9) (Example 11). The LiGr-SPoly:LFP (91:9) cell construction is described in Example 42. The y-axis indicates the voltage of the cell (V). The x-axis reports the detected discharge capacity (mAh/g) expressed as milliampere-hours per gram which indicates the energy storage capability of the cell. The curves represent a charge step, and a discharge step.

FIG. 34: Cycling data for LiGr-SPoly:LFP (91:9) hybrid organic-inorganic cathode cell at C/10. In particular, FIG. 34, shows a chart reporting the electrochemical cycling performance of an exemplary cell with an in situ lithiated graphite (LiGr) anode (Example 41) and an organic-inorganic hybrid cathode (SPoly:LFP, 91:9) (Example 11). The LiGr-SPoly:LFP (91:9) cell construction described in Example 42. The y-axis shows the detected discharge capacity (mAh/g) expressed as milliampere-hours per gram which indicates the energy storage capability of the cell. The x-axis shows the number of cycles, which includes only the discharge steps.

FIG. 35: Voltage profile for in situ lithiated graphite (LiGr)-SPoly:LTO hybrid organic-inorganic cathode cell at C/10. In particular FIG. 35 shows a plot reporting the cell voltage for an exemplary electrochemical cell comprising an in situ lithiated graphite (LiGr) anode (Example 41) and an organic-inorganic hybrid cathode (SPoly:LTO, 91:9) (Example 12). The LiGr-SPoly:LTO (91:9) cell construction is described in Example 43. The y-axis indicates the voltage of the cell (V). The x-axis reports the detected discharge capacity (mAh/g) expressed as milliampere-hours per gram which indicates the energy storage capability of the cell. The curves represent a charge step, and a discharge step.

FIG. 36: Cycling data for LiGr-SPoly:LTO (91:9) hybrid organic-inorganic cathode cell at C/10. In particular, FIG. 36, shows a chart reporting the electrochemical cycling performance of an exemplary cell with an in situ lithiated graphite (LiGr) anode (Example 41) and an organic-inorganic hybrid cathode (SPoly:LTO, 91:9) (Example 12). The LiGr-SPoly:LTO (91:9) the cell construction described in Example 43. The y-axis shows the detected discharge capacity (mAh/g) expressed as milliampere-hours per gram which indicates the energy storage capability of the cell. The x-axis shows the number of cycles, which includes only the discharge steps.

FIG. 37: Voltage profile for in situ lithiated graphite (LiGr)-SPoly:TiS₂ hybrid organic-inorganic cathode cell at C/10. In particular FIG. 37 shows a plot reporting the cell voltage for an exemplary electrochemical cell comprising an in situ lithiated graphite (LiGr) anode (Example 41) and an organic-inorganic hybrid cathode (SPoly:TiS₂, 91:9) (Example 13). The LiGr-SPoly:TiS₂ (91:9) cell construction is described in Example 44. The y-axis indicates the voltage of the cell (V). The x-axis reports the detected discharge capacity (mAh/g) expressed as milliampere-hours per gram which indicates the energy storage capability of the cell. The curves represent a charge step, and a discharge step.

FIG. 38: Cycling data for LiGr-SPoly:TiS₂ (91:9) hybrid organic-inorganic cathode cell at C/10. In particular, FIG. 38, shows a chart reporting the electrochemical cycling performance of an exemplary cell with an in situ lithiated graphite (LiGr) anode (Example 41) and an organic-inorganic hybrid cathode (SPoly:TiS₂, 91:9) (Example 13). The LiGr-SPoly:TiS₂ cell construction is described in Example 44. The y-axis shows the detected discharge capacity (mAh/g) expressed as milliampere-hours per gram which indicates the energy storage capability of the cell. The x-axis shows the number of cycles, which includes only the discharge steps.

FIG. 39: Voltage profile for in situ lithiated graphite (LiGr)-SPoly:ccLTO hybrid organic-inorganic cathode cell at C/10. In particular FIG. 39 shows a plot reporting the cell voltage for an exemplary electrochemical cell comprising an in situ lithiated graphite (LiGr) anode (Example 41) and an organic-inorganic hybrid cathode (SPoly:ccLTO, 91:9). The LiGr-SPoly:ccLTO (91:9) cell construction is described in Example 45. The y-axis indicates the voltage of the cell (V). The x-axis reports the detected discharge capacity (mAh/g) expressed as milliampere-hours per gram which indicates the energy storage capability of the cell. The curves represent a charge step, and a discharge step.

FIG. 40: Cycling data for LiGr-SPoly:ccLTO (91:9) hybrid organic-inorganic cathode cell at C/10. In particular, FIG. 40, shows a chart reporting the electrochemical cycling performance of an exemplary cell with an in situ lithiated graphite (LiGr) anode (Example 41) and an organic-inorganic hybrid cathode (SPoly:ccLTO, 91:9). The LiGr-SPoly:ccLTO (91:9) cell construction is described in Example 45. The y-axis shows the detected discharge capacity (mAh/g) expressed as milliampere-hours per gram which indicates the energy storage capability of the cell. The x-axis shows the number of cycles, which includes only the discharge steps.

### DETAILED DESCRIPTION

Described herein are hybrid organic-inorganic redox active materials and related composites, compositions, electrode material, electrodes electrochemical cells, batteries, methods and system.

The term “redox active” as used herein with reference to a chemical moiety (e. g. polymer or monomer or portion thereof) indicated a moiety capable of being reversibly oxidized or reduced in a nonaqueous electrolytes to produce a detectable redox potential. Redox active functional groups comprise ketones, aldehydes, and carboxylic acids, imines, organo-sulfides and additional functional groups identifiable by a skilled person.

The term “chemical moiety” as used herein indicates an atom or group of atoms that when included in a molecule is responsible for a characteristic chemical reaction of that molecule or an atom or group of atoms that that is retained to become part of the reaction product after the reaction. A chemical moiety comprising at least one carbon atom is also indicated as organic moiety as will be understood by a skilled person.

In particular, as used here, the wording “organic moiety” refers to a carbon containing portion of an organic molecule. For example, within an organic polymer organic moieties can be formed by a distinct portion of the polymer, such as a distinct portions of a monomer that is retained in the polymer following polymerization as part of the monomeric unit of the polymer. An exemplary organic moiety is provided by a 1,5-dichloroanthraquinone or by an anthraquinone moiety retained in a S-linked polymer as disclosed herein.

Exemplary chemical moieties in the sense of the disclosure are provided by functional groups such as hydrocarbon groups containing double or triple bonds, groups containing halogen, groups containing oxygen, groups containing nitrogen and groups containing phosphorus and sulfur all identifiable by a skilled person.

A skilled person will be able to identify the moiety that can be used in methods of the disclosure to provide the redox active polycyclic compound of the disclosure.

The term “redox active” as used herein in connection with a material indicates a material including is a redox active moiety and having i) a cyclability greater than 100 cycles ii) a capacity greater than 600 mAh/g and iii) a specific energy equal or greater than 1100 possibly equal or greater than 1200 Wh/kg.

In embodiments of the present disclosure, a redox active material is a hybrid organic-inorganic redox active material comprising an organic redox active material and an inorganic additive as will be understood by a skilled person.

The term “organic” as used herein indicates a molecule or portion of a molecule comprising carbon atoms bound to other carbon atoms, and other elements such as hydrogen, nitrogen, oxygen, sulfur, phosphorous or halogens. Accordingly, exemplary organic compounds and molecules in the sense of the disclosure primarily contain carbon atoms covalently bonded to other elements, most commonly hydrogen, oxygen, sulfur, or nitrogen. For example, within an organic polymer organic moieties can be formed by a distinct portion of the polymer, such as a distinct portions of a monomer that is retained in the polymer following polymerization as part of the monomeric unit of the polymer.

In the organic redox active materials herein described, the redox active moiety has a redox potential of 0.50 V to 3.5 V with reference to Li/Li⁺ electrode potential under standard conditions. It is to be understood that a person of skill in the art would know that Li/Li⁺ has a potential of −3.04 V vs. SHE, a potential of a redox moiety relative to the potential of Li/Li⁺ can be converted to a potential of a redox moiety relative to SHE by subtraction of the potential vs. Li/Li⁺ by 3.04 V to give the potential vs. SHE.

Accordingly, the organic redox active material herein described has a charging capacity as will be understood by a skilled person. As used herein, the wording “charging capacity” is a measurement of the product of current times time of the charge that the anode material accepts until a cutoff voltage is reached. Discharging capacity is the product of current times time of the charge that the cathode material accepts until a cutoff voltage is reached.

$$Q = \frac{n F}{3600 * M W}$$

where Q is the theoretical capacity,
n is the number of electrons exchanged,
F is Faraday's constant, and
MW is the molecular weight of the electroactive material.

In embodiments, herein described the organic redox active material comprises one or more sulfurized carbon matrices.

The term a “sulfurized carbon matrix” or “sulfur-incorporated carbon matrices” as used herein indicates carbon based matrix wherein elemental sulfur is embedded into a carbon based matrix wherein the elemental sulfur is linked to a C atom of the matrix material, in structures such as C—S, C—S—S, C—S—S—S, C—S—S—S—S, C—S—S—S—S—S bonds or other higher polysulfide. The term “carbon matrix” as used herein indicates a solid carbon-based material wherein inorganic graphite or organic monomeric moieties of the polymeric matrix are configured to link to a C atom within a surrounding organic mass, a Group 16 element, and in particular S, as described herein in the form of C—S, C—S—S, C—S—S—S, C—S—S—S—S, C—S—S—S—S—S bonds For example, any configuration of aromatic monomer herein described linked to one another in any configuration resulting in the presentation of the C—S, C—S—S, C—S—S—S, C—S—S—S—S, C—S—S—S—S—S bonds on the resulting organic moieties for electrochemical reactions with other molecules or compounds such as an electrolyte and/or S-linked polymer herein described. Exemplary carbon-based matrix includes graphite, polyacrylonitrile, as well as additional carbon-based matrices as would be understood by a skilled person.

The sulfurized carbon matrices herein described can be provided by sulfurizing elemental sulfur at high temperature in presence of a polymer comprising aromatic and/or non-aromatic moieties to form a carbon-based matrix wherein the sulfur atom embedded into the matrix and carbonized at a suitable temperature, suitable temperature can be for example, >300° C. and preferably >400° C., or ranges from 300° C. to 1000° C., or from 500° C. to 800° C.

Sulfur-incorporated carbon matrices can deliver a relatively high theoretical capacity based on reversible breakage and formation of disulfide (S—S) bonds. Three types of organosulfur cathodes are being used: (i) small organosulfur molecules, (ii) high sulfur content polymers, and (iii) sulfurized carbon matrices. Small organosulfur molecules are soluble in organic electrolytes, therefore their use as cathode active materials is very limited. High sulfur content polymers and sulfurized polymers are not soluble in organic solvents, but they still form small amount of soluble polysulfides during deep discharge, consequently overcharging such soluble sulfides during the charge process due to shuttle mechanism. Even though a significant progress is made over the years for realizing organosulfur polymers as cathode active materials for practical batteries, but significant hurdles need to overcome due to shuttle effects, high electrolyte loading, high conducting carbon loading, and low tap density.

In some embodiments the sulfur-incorporated carbon matrices can be sulfurized poly[acrylonitrile] herein and in application incorporated by reference in their entirety also indicates as SPoly or SPAN, a sulfurized carbon matrix polymer of elemental sulfur and polyacrylonitrile (SPoly) which exhibits high capacity (>400 mAh/g from 3.5 to 0.500 V) with better cycling stability compared to standard sulfur cathodes in electrochemical cells with a lithium anode; however, the majority of the capacity is accessed at lower potentials than conventional Li/S cells (lower than 2.0V, for example). The overall S content in sulfurized carbon matrices (SPoly) is ~30 to 50% and its capacity can vary from 300-800 mAh/g of active material, SPoly. Those features can be found in other sulfurized carbon matrix polymer which can have an overall S content of ~30 to 50 w/w % with respect to the total weight of the sulfurized carbon matrix polymer and a capacity varying from 300-800 mAh/g of active polymer as will be understood by a skilled person.

In some embodiments, a redox active composite as described herein comprises a sulfurized carbon matrix represented by Formula (V), wherein Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight averaged MW ranging from 2000 to 2,000,000 Daltons, from 10,000 to 1,500,000 Daltons, from 100,000 to 1,000,000 Daltons,

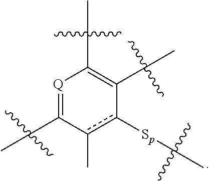

In some embodiments, the sulfurized carbon matrix has a sulfur content based on the total weight of the sulfurized carbon matrix equal to or greater than 5 wt % and less than 20 wt %, equal to or greater than 20 wt % and less than 40 wt %, equal to or greater than 40 wt % and less than 60 wt %, equal to or greater than 60 wt % and less than 70 wt %, or equal to or greater than 70 wt % and less than 80 wt %.

In some embodiments, the redox active composite as disclosed herein comprises a sulfurized carbon matrix represented by Formula (V), wherein Q is N.

In some embodiments, the redox active composite as disclosed herein comprises a sulfurized carbon matrix represented by Formula (V), wherein Q is C.

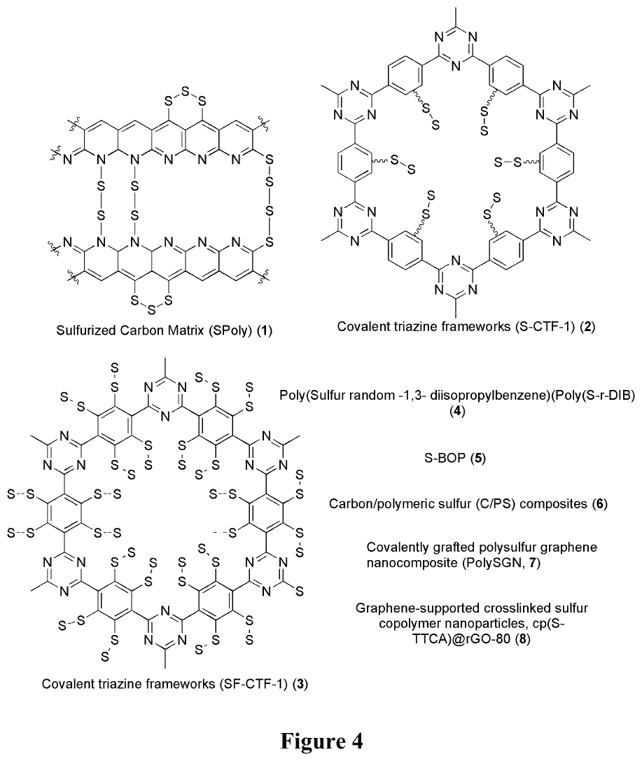

In some embodiments, sulfurized carbon matrix of the Formula (V) can be selected from any one shown in Examples in FIG. 4 including sulfurized carbon matrix polymers SPoly (1), covalent trizaine frameworks (S-CTF-1) (2), covalent trizaine frameworks (5-CTF-1) (3), poly(sulfur random-1,3-diisopropylbenzene) (poly(S-r-DIB) (4), S—BOP (5), carbon/polymeric sulfur (C/PS) composite (6), covalently grafted polysulfur graphene nanocomposite (PolySGN, 7), and Graphene-supported crosslinked sulfur copolymer nanoparticles, cp(S-TTCA)@rGO-80 (8) or any combination thereof.

Since the organic redox active material herein described has a redox potential of 0.5 V to 3.5 V with reference to Li/Li⁺ electrode potential, to increase or decrease the redox potential of a starting redox active monomeric moiety of the sulfurized carbon matrix polymer, a substituent group can be selected, based on the Hammett Sigma constant such as the constants shown in the following Table 1.

TABLE 1
Hammett Sigma Constants*

| Group | Σmeta | Σpara | σI | Σν | II | Es | MR |
|---|---|---|---|---|---|---|---|
| H | 0.00 | 0.00 | 0.00 | 0.00 | 0.00 | 0.00 | 1.03 |
| CH₃ | −0.07 | −0.17 | −0.04 | 0.52 | 0.56 | −1.24 | 5.65 |
| C₂H₅ | −0.07 | −0.15 | −0.05 | 0.56 | 1.02 | −1.31 | 10.30 |
| n-C₃H₇ | −0.07 | −0.13 | −0.03 | 0.68 | 1.55 | −1.60 | 14.96 |
| i-C₃H₇ | −0.07 | −0.15 | −0.03 | 0.76 | 1.53 | −1.71 | 14.96 |
| n-C₄H₉ | −0.08 | −0.16 | −0.04 | 0.68 | 2.13 | −1.63 | 19.61 |
| t-C₄H₉ | −0.10 | −0.20 | −0.07 | 1.24 | 1.98 | −2.78 | 19.62 |
| H₂C═CH** | 0.05 | −0.02 | 0.09 | 2.11 | 0.82 | | 10.99 |
| C₆H₅** | 0.06 | −0.01 | 0.10 | 2.15 | 1.96 | −3.82 | 25.36 |
| CH₂Cl | 0.11 | 0.12 | 0.15 | 0.60 | 0.17 | −1.48 | 10.49 |
| CF₃ | 0.43 | 0.54 | 0.42 | 0.91 | 0.88 | −2.40 | 5.02 |
| CN | 0.56 | 0.66 | 0.53 | 0.40 | −0.57 | −0.51 | 6.33 |
| CHO | 0.35 | 0.42 | 0.25 | | −0.65 | | 6.88 |
| COCH₃ | 0.38 | 0.50 | 0.29 | 0.50 | −0.55 | | 11.18 |
| CO₂H** | 0.37 | 0.45 | 0.39 | 1.45 | −0.32 | | 6.93 |
| Si(CH₃)₃ | −0.04 | −0.07 | −0.13 | 1.40 | 2.59 | | 24.96 |
| F | 0.34 | 0.06 | 0.52 | 0.27 | 0.14 | −0.46 | 0.92 |
| Cl | 0.37 | 0.23 | 0.47 | 0.55 | 0.71 | −0.97 | 6.03 |
| Br | 0.39 | 0.23 | 0.50 | 0.65 | 0.86 | −1.16 | 8.88 |
| I | 0.35 | 0.18 | 0.39 | 0.78 | 1.12 | −1.40 | 13.94 |
| OH | 0.12 | −0.37 | 0.29 | 0.32 | −0.67 | −0.55 | 2.85 |
| OCH₃ | 0.12 | −0.27 | 0.27 | 0.36 | −0.02 | −0.55 | 7.87 |
| OCH₂CH₃ | 0.10 | −0.24 | 0.27 | 0.48 | 0.38 | | 12.47 |
| SH | 0.25 | 0.15 | 0.26 | 0.60 | 0.39 | −1.07 | 9.22 |
| SCH₃ | 0.15 | 0.00 | 0.23 | 0.64 | 0.61 | −1.07 | 13.82 |
| NO₂** | 0.71 | 0.78 | 0.76 | 1.39 | −0.28 | −2.52 | 7.36 |
| NO | 0.62 | 0.91 | 0.37 | | −0.12 | | 5.20 |
| NH₂ | −0.16 | −0.66 | 0.12 | | −1.23 | −0.61 | 5.42 |
| NHCHO | 0.19 | 0.00 | 0.27 | | −0.98 | | 10.31 |
| NHCOCH₃ | 0.07 | −0.15 | 0.26 | | −0.37 | | 16.53 |
| N(CH₃)₂ | −0.15 | −0.83 | 0.06 | 0.43 | 0.18 | | 15.55 |
| N(CH₃)₃⁺ | 0.88 | 0.82 | 0.93 | 1.22 | −5.96 | | 21.20 |

*ometa, opara = Hammett constants; σI = inductive sigma constant; σv = Charton's v (size) values; p = hydrophobicity parameter; Es = Taft size parameter; MR = molar refractivity (polarizability) parameter.
**indicates that the group is in the most sterically hindered conformation.

For example, to increase redox potential of a starting redox active monomeric moiety having an aromatic ring, a CN or a CF₃ group can be comprised as can be comprised in view of the related Hammett Sigma Constant. Additional modifications to increase or decrease the redox potential of a starting moiety will be understood by a skilled person upon reading of the present disclosure.

In the hybrid organic-inorganic redox active composite material, the organic redox active material and sulfurized carbon matrices have thus a density <1.0 g/cm³ as will be understood by a skilled person.

In the hybrid organic-inorganic redox active composite material, the organic redox active material forms redox active aggregates.

The term “aggregate” indicates an assembly of individual redox-active material moieties that may be larger than an individual molecule or polymer attached together to form a bulk particle or group of particles with a larger particle size and smaller surface area than an individual molecule or polymer of redox active material alone.

In the hybrid organic-inorganic redox active composite material, each of the redox active aggregates has an organic redox active aggregate size and a redox active aggregate surface area which refer to average size and areas of aggregates of the material. Aggregate size can be detected by techniques such as light scattering (dynamic or static) or sieving as well as by additional techniques identifiable by a skilled person

In the hybrid organic-inorganic redox active composite material, the organic redox active aggregate size can range from 10 nm to 500 μm, 10 nm to 1 μm, 5 to 500 um, possible from 10 to 250 μm, and preferably from 10 to 100 um as will be understood by a skilled person. In some exemplary embodiments, an organic redox active aggregate (e.g. SPoly) can have a dimension from 10 μm to 50 um as will be understood by a skilled person.

The term “surface area” as used herein indicates the total active area of the materials measured in squared meter per unit mass (m²/g).

The surface area of aggregate can be detected by techniques such as gas sorption analysis (BET) as well as by additional techniques identifiable by a skilled person.

In the hybrid organic-inorganic redox active composite material, organic redox active aggregates have a redox active aggregate surface area. can range from 1 to 50 m²/g possibly from 10-100 m²/g. In some embodiments, the redox active aggregate surface area can range from 1 to 10 m²/g and from 10 to 50 m²/g as well as from 50 to 100 m²/g as will be understood by a skilled person.

An exemplary embodiments, the surface area of an organic redox active aggregate was found to be 13 m²/g. In additional exemplary embodiments, the surface area of an organic redox active aggregate can be 5 m²/g, 20 m²/g, 40 m²/g, 60 m²/g, 100 m²/g, and any value within related ranges.

Organic redox active material having low density will result in a lower density electrode thus lower volumetric energy density and higher electrolyte loading requirements, therefore, increasing the electrode density is an important parameter for the cell chemistry to be suitable for practical applications. Densification of electrodes to values above 1.1 g/cm³ can be achieved by physical methods such as the application of pressure, however the resulting electrode with organic redox active electrode material alone leads to poor cell cycling performance due to limited porosity and mechanical strength.

The addition of inorganic additive to organic redox material of the disclosure allows formation of hybrid organic-inorganic redox active materials that can be used to provide dense electrodes up to 1.5 g/cm³ or up to 2.0 g/cm³ to be achieved while retaining excellent electrochemical performance.

In a hybrid organic-inorganic redox active material herein described, an organic redox active material comprising at least one sulfurized carbon matrix, is combined with an inorganic additive to form a “organic-inorganic” composite cathode material.

The term “inorganic” as used herein refers to materials that do not contain carbon-hydrogen bonds. More specifically inorganic materials in the sense of the disclosure encompass materials such as metals, metal oxides, metal phosphates, and more preferably inorganic materials are selected based on their ability to provide specific electrochemical properties such as energy density, cycle life, safety, and cost-effectiveness.

The addition of inorganic material as an additive to the organic redox active material here described enhances the electrochemical and mechanical properties of the electrodes.

The term “additive” as used herein indicates an additional component added to the organic redox active material. In particular, as used herein, an “additive” indicates any component other than the organic redox active material which enhances the mechanical, physical, electrical and/or electrochemical properties of the electrode material. Exemplary additive includes binder and conductive additives.

In the hybrid organic-inorganic redox active composite material, the inorganic additive material is chemically inert with respect to the organic redox active material.

The wording “chemically inert” as described herein indicates refers to a substance's lack of reactivity with other substances under specific conditions. When a substance is described as chemically inert with respect to another, it means that the substance does not readily engage in chemical reactions with that other substance. This property is often due to the stability of the inert substance's electron configuration, which makes it energetically unfavorable for it to participate in chemical changes as will be understood by a skilled person.

In particular, the wording “chemically inert” when used with respect to the inorganic material of the disclosure, indicates inorganic material which do not react chemically or electrochemically and are thus chemically and electrochemically orthogonal to any components of hybrid electrode material, any solvents or other materials introduced during mixing or coating processes, or with the electrolyte or other components of the electrochemical cell as will be understood by a skilled person upon reading of the disclosure.

In the hybrid organic-inorganic redox active composite material, the inorganic additive material is chemically inert with respect to the organic redox active material is also chemically inert with respect to the electrolyte used in the corresponding electrochemical cells and batters as will be understood by a skilled person.

In the hybrid organic-inorganic redox active composite material, the inorganic additive is an inorganic material which has an inorganic material density higher than the redox active material density.

The term “density” as used herein in connection with additive material and in particular, inorganic material indicates the “true density” of the material, defined as the mass of the solid of that inorganic material divided by its actual volume, excluding any pores, voids, or interparticle spaces. A true density is a fundamental property of a material as will be understood by a skilled person. True density values of exemplary inorganic additives in the sense of the disclosure are reported in the following Table 1A.

TABLE 1A
True density of exemplary Inorganic Additive

| | | Exemplary |
|---|---|---|
| | Chemical | True Density |
| Inorganic Additive | Formula | (g/cm³) |
| Lithium Iron Phosphate (LFP) | LiFePO₄ | ~3.6-3.7 |
| Lithium Titanate (LTO) | Li₄Ti₅O₁₂ | ~3.4-3.5 |
| Titanium Disulfide (TiS₂) | TiS₂ | ~3.22 |
| Aluminum Oxide (Al₂O₃) | Al₂O₃ | ~3.9-4.0 |
| Lithium Manganese Iron Phosphate | LiMnₓFe₁₋ₓPO₄ | ~3.5-3.6 |
| (LMFP) | | |
| Lithium Manganese Phosphate | LiMnPO₄ | ~3.47-3.50 |
| (LMP) | | |
| Lithium Cobalt Phosphate (LCP) | LiCoPO₄ | ~3.6 |
| Lithium Cobalt Oxide (LCO) | LiCoO₂ | ~5.05 |
| Lithium Nickel-Manganese-Cobalt | LiNi_{0.5}Mn_{0.3}Co_{0.2}O₂ | ~4.7-4.8 |
| Oxide (NMC532) | | |
| Lithium Nickel-Manganese-Cobalt | LiNi_{0.6}Mn_{0.2}Co_{0.2}O₂ | ~4.75-4.80 |
| Oxide (NMC622) | | |
| Lithium Nickel-Manganese-Cobalt | LiNi_{0.8}Mn_{0.1}Co_{0.1}O₂ | ~4.75-4.80 |
| Oxide (NMC811) | | |
| Molybdenum Disulfide (MoS₂) | MoS₂ | ~5.06 |
| Electronically Conductive | TiO₂ | ~3.5-3.6 |
| Titanium Dioxide (ccLTO) | | |
| Iron Disulfide | FeS₂ | ~4.9-5.0 |
| Y-type Zeolites | Aluminosilicate | ~1.9-2.3 |
| Lithium Vanadium Phosphate | Li₃V₂(PO₄)₃ | ~3.55-3.60 |
| (LVP) | | |

In some embodiments, the inorganic additive material has a density ≥1 g/cm³

In some embodiments, the inorganic additive material has a density up to 2 g/cm³ or higher, preferred >3 g/cm³, or >3.5 g/cm³, up to 4.0 g/cm³ and more preferably up to 5 g/cm³ and up to 6.2 g/cm³.

In some preferred embodiments, the inorganic additive material has a density ranging from 2.0-6.0 g/cm³ looks fine, more preferably from 3.0 to 5.0 g/cm³.

in some embodiments, the inorganic additive can comprise one or more: solid inorganic materials comprising at least one metal ion or atom in combination with one or more non-metal ions or atoms. Non-metal atoms can be 0 (to make metal oxide), S (sulfide), N (nitride), C (carbide) or combinations of these, also including complex oxoanions such as phosphate, nitrate, sulfate and similar.

In some embodiments, the inorganic additive can be carbon coated.

In preferred embodiments, the inorganic additive can comprise, LiFePO₄ or carbon coated LiFePO₄ (herein also termed as LFP), and Li₄Ti₅O₁₂ or carbon coated Li₄Ti₅O₁₂ (herein also termed as LTO, and ccLTO respectively), TiS₂, various forms of aluminum oxide Al₂O₃ possibly carbon coated (herein also termed Al₂O₃), Lithium Manganese Iron Phosphate, LiMn_{0.6}Fe_{0.4}PO₄ possibly carbon coated LMFP (herein also termed as LMFP), Lithium Manganese Phosphate LiMnPO₄, possibly carbon coated (herein also termed LMP), Lithium Cobalt Phosphate LiCoPO₄ possibly carbon coated (herein also termed LCP), Lithium Cobalt Oxide, LiCoO₂ possibly carbon coated (herein also termed as LCO), Lithium Nickel-Manganese-Cobalt Oxide (LiNi_{0.5}Mn_{0.3}Co_{0.2}O₂) possibly carbon coated (herein also termed as NMC532), Lithium Nickel-Manganese-Cobalt Oxide (LiNi_{0.6}Mn_{0.2}Co_{0.2}O₂) possibly carbon coated (herein also NMC622), Lithium Nickel-Manganese-Cobalt Oxide (LiNi_{0.8}Mn_{0.1}Co_{0.1}O₂) possibly carbon coated (herein also termed as NMC811), MoS₂, possibly carbon coated (herein also MoS), electronically conductive TiO₂, Iron disulfide MoS (herein also termed as FeS₂), Lithium Vanadium Phosphate (LVP) and microporous aluminosilicate zeolite materials such as Zeolite X, Zeolite Y and Cu—Y zeolites, inclusive of their carbon coated versions.

In the hybrid organic-inorganic redox active material, the inorganic additive material is in the form of inorganic particles.

The term “particle” as used herein indicates a discrete localized object with approximately homogeneous chemical and physical composition. A “particle” in the sense of the disclosure refers to a small, discrete unit of material that typically has a three-dimensional shape and can vary widely in size, from nanometers to millimeters. Particles are often contrasted with other material formations such as sheets, films, or fibers, which have distinct structural characteristics.

Particles in the sense of the disclosure are characterized by a size and shape in particular particle sin the sense of the disclosure can range from nanoparticles (less than 100 nanometers) to larger granules or powders. Their shape can be spherical, irregular, rod-like, or any other geometric form as will be understood by a skilled person.

Particles in the sense of the disclosure are characterized by a surface area: In particular, particles in the sense of the disclosure generally have a high surface area-to-volume ratio compared to bulk materials. This property is significant for applications involving reactions or interactions at the surface, such as catalysis or adsorption.

In the hybrid organic-inorganic redox active material, a population of inorganic particles has an average inorganic particle size and an inorganic particle surface area.

In preferred embodiments the hybrid organic-inorganic redox active material, the inorganic particle size can have an average size ranging from 100 um up to 200 um, up to 1 nm up to 100 nm or up to 200 nm, as will be understood by a skilled person. For example in some embodiments, the inorganic particle size can have an average size ranging from 100 μm to 200 μm, 10 μm to 100 μm, 1 nm to 10 μm, or from 100 μm to 100 nm as will be understood by a skilled person upon reading of the present disclosure.

For example, in some embodiments of the hybrid organic-inorganic redox active material, the inorganic particle size can be 100 μm or lower, 50 μm or lower, 25 μm or lower, 10 μm or lower, 5 μm or lower. In particular, in some embodiments the inorganic particle size can be 3.5 um or lower, 1.5 or lower, 1.0 or lower, or 0.50 um or lower. In some embodiment the inorganic particle size can range from 0.25 to 0.45 um, from. 0.9 to 1.8 um or from 0.2 to 0.6 um.

In certain preferred embodiments, the inorganic additive combines multiple physical properties. For example, the inorganic additive can have a density greater than 3.0 g/cm³, an average particle size of less than 15 μm, and a surface area greater than 5 m²/g. In a specific embodiment, the inorganic additive is LFP having a density of about 3.6 g/cm³, a particle size of about 1.5 μm to 15 μm, and a surface area of about 10-15 m²/g.

In another embodiment, the inorganic additive is LTO having a density of about 3.4-3.5 g/cm³, a particle size of about 1.3 μm to 3 μm, and a surface area of about 16 m²/g. In a further embodiment, the inorganic additive is TiS₂ having a density of about 3.22 g/cm³ and a particle size of about 40 μm to 70 μm. In yet another embodiment, the inorganic additive is Al₂O₃ having a density of about 3.9-4.0 g/cm³, a particle size of less than 500 nm, and a surface area of about 5-120 m²/g.

In some embodiments the inorganic particle size can be lower than 0.25 um or. lower than 0.9 um, and sizes of 100 nm or lower are expected to be possibly used.

In some exemplary embodiments, the inorganic additive can have an average particle size ranging from 1.5-15 um (see e.g. LFP in Examples 20, 22 and 23 with metallic lithium as anode. Example 42 with in situ lithiated graphite as anode).

In some exemplary embodiments, the inorganic additive can have an average particle size ranging from 1.3-3 um (see e.g. LTO, and ccLTO Examples 25 and 26 with metallic lithium as anode. Examples 43 and 45 with in situ lithiated graphite as anode).

In some exemplary embodiments, the inorganic additive can have an average particle size ranging from 40-70 um (see e.g. TiS₂ Examples 27 and 28 with metallic lithium as anode. Example 44 with in situ lithiated graphite as anode).

In some exemplary embodiments, the inorganic additive can have an average particle size less than 500 nm (see e.g. Al₂O₃, Example 29).

In some preferred embodiments of hybrid organic-inorganic redox active material, the inorganic particle surface area can be 100 m²/g or lower, 50 m²/g or lower, possibly 25 m²/g or lower 12 m²/g or lower, 10 m²/g or lower, 7 m²/g or lower 6 m²/g, 5 m²/g or lower.

In some exemplary embodiments, the inorganic additive can have an average surface area ranging from 10-15 m²/g (see e.g. LFP Examples 20, 22 and 23 with metallic lithium as anode. Example 42 with in situ lithiated graphite as anode).

In some exemplary embodiments, the inorganic additive can have an average surface area of 16 m²/g (see e.g. LTO, Examples 25, and 26 with metallic lithium as anode. Example 43 with in situ lithiated graphite as anode).

In some exemplary embodiments, the inorganic additive can have an average surface area ranging from 5-120 m²/g (see e.g. Al₂O₃ Example 29).

In some embodiments, where the inorganic additive material is LFP the inorganic particle size can be 15 μm or lower. In particular, in some embodiments the inorganic particle size can be 3.5 um or lower, 1.5 or lower, 1.0 or lower, or 0.50 um or lower, and the inorganic particle surface area can be: 12 m²/g.

In some embodiments, where the inorganic additive material is Al₂O₃ the inorganic particle size can be lower than 0.25 um and sizes of 100 nm or lower where the inorganic additive material is Al₂O₃ the inorganic particle surface are can be 100-1 m²/g.

In some embodiments, where the inorganic additive material is LTO the inorganic particle size can be <10 um, possibly 0.9 to 1.8 um or, 0.2-0.6 um and the surface area: can be <6.0 m²/g. In some embodiments, where the inorganic additive material is TiS₂ the inorganic particle size can be 0.1 um-75 μm and the surface are can be 100-5 m²/g.

In most preferred embodiments the inorganic additive material is preferably conductive.

The wording “conductive” and “conductivity” as used herein indicates the property of the material to pass electrical current at room temperature, with a bulk conductivity in the range described comprising both ionic and electronic conductivities Accordingly, the wording “electronic conductivity” as used herein refers to the movement of electrons through a material in view of their inherent structural features, which is characteristic of materials such as metals, semiconductors, and conductive polymers as will be understood by a skilled person. The wording “ionic conductivity” as used herein refers to the movement of ions within a solid or a medium, which is typical in electrolytes, typically in batteries. In ionic conductors, the current is carried as charged ions moving through the material in solid-state electrolytes or medium in liquid electrolytes as will be understood by a skilled person. The conductivity values of embodiments herein described are bulk conductivities values which correspond to the sum of all types of electrical conductivity mechanisms of a referenced material and in particular of a hybrid inorganic-organic redox active material of the disclosure or a component thereof as will be understood by a skilled person upon reading of the disclosure.

In most preferred embodiments, an inorganic additive material used as a component of hybrid inorganic-organic redox active material of the disclosure have a conductivity ranging from 10⁻⁹ to 10⁻² S·cm⁻¹, or 10⁻⁸ to 10⁻³ S·cm⁻¹ or 10⁻⁸ to 10⁻³ S·cm⁻¹, preferred ranges are 108 to 10⁻³ and 10⁻⁷ to 10⁻⁴ S·cm⁻¹, or 10⁻⁹ to 10⁻⁷ S·cm⁻¹ (e.g. for inorganic additive such as LFP) and 10⁻⁴ to 10⁻³ S·cm-1 (e.g. for inorganic additive such as LCO).

In some of those embodiments, one or more inorganic additive materials used in hybrid inorganic-organic redox active material of the disclosure have a conductivity ranging from 10⁻⁹ to 10⁻³ S·cm⁻¹ (e.g. LFP, inclusive of carbon coated LFP, carbon coated LTO, TiS₂ and LMO) 10⁻⁸ to 10⁻⁴ S·cm⁻¹ or 10⁻⁷ to 10⁻⁵ S·cm⁻¹ (e.g. LMO).

In some most preferred embodiments, contains Li⁺. In those embodiments Li⁺ containing inorganic material are preferred due to extra-capacity which can minimize the lithium loss during the 1^{st} or subsequent cycles, as will be understood by a skilled person.

In some embodiments, the Li⁺ containing inorganic material can provide 0.1-3 Li per formula unit of active material, preferably 0.5-1.5.

For example, LFP has one lithium per formula unit LiFePO₄ and may contribute up to one Li⁺ per mole additive used for electrochemical cycling, if cycled in the appropriate voltage range.

Similarly, LCO has one lithium per formula unit LiCoO₂ but can contribute only 0.5 Li⁺ per mole additive used for electrochemical cycling if cycled in the appropriate voltage range, as LiCoO₂ and similar metal oxides only exhibit stable cycling down to a composition Li_{0.5}CoO₂ as will be understood by a skilled person.

In a hybrid organic-inorganic redox active material herein described, an organic redox active material comprising at least one sulfurized carbon matrix, is combined with an inorganic additive to form a composite redox active material.

The term “composite” as used herein indicates the material is made from two or more different substances such as the organic redox active material and an inorganic material.

In hybrid organic-inorganic redox active composite material herein described the inorganic additive material increases the electrode packing density of an electrode material comprising the organic redox active material.

The term “electrode packing density” or “density” as used herein in connection with electrode materials, refer a measure of how much electrode material is packed within a given volume, typically expressed in units of g/cm³¹. The packing density can be calculated by dividing the mass of the electrode material (m) by the volume of the electrode (V)³. The volume of the electrode is determined by multiplying its thickness, length, and width. Usually, an electrode material comprises the active material, conductive additives, and optionally binder and/or further additives identifiable by a skilled person.

Electrode packing density is a parameter for determining the performance of a battery, as it directly impacts the specific energy (Wh/kg) and volumetric energy density (Wh/L) as will be understood by a skilled person. An increased electrode packing density allows for more active material to be included per unit volume, resulting in higher specific energy.

In several embodiments of the present disclosure, the addition of an inorganic additive allows for the creation of a dense cathode material with a packing density greater than 1.2 g/cm³, and up to 1.5 g/cm³ or 2.0 g/cm³, while retaining excellent electrochemical performance as will also be understood by a skilled person upon reading of the present disclosure.

In particular, it has been found that addition of inorganic additives material with the feature of the present disclosure allow to obtain a hybrid organic-inorganic redox active composite which can be used in electrodes having a packing density greater than 1.0 g/cm³, which is greater than the density of sulfurized carbon matrix (e.g. SPoly alone) thus allowing a skilled person to increase the overall electrode packing density of hybrid organic-inorganic electrode material comprising the hybrid organic-inorganic redox active composite of the disclosure.

The “electrode packing density of an electrode is a measure of how much electrode material (e.g. the active material, conductive additives, and binder) is packed within a given volume (g/cm³). The packing density can be calculated by dividing mass of the electrode over the volume of the of the electrode, such as m/V, where m is the mass of the electrode material in grams, and V is the volume of the electrode in cm³. The volume of the electrode can be calculated by multiplying the thickness of the electrode (cm) and length (cm) & width (cm) of the electrode, as will be understood by a skilled person.

In some embodiments, the hybrid organic-inorganic redox active composite can provide electrode material having an electrode packing density of ≤1.3 g/cm³ to 1.5 g/cm³ or to 2.0 g/cm³ or higher increased from the density of the active material of <1.1 g/cm³ to >1.2 g/cm³, as will be understood by a skilled person.

The increased electrode density results in higher specific energy in the electrochemical cells as more active material per unit volume is available for electrochemical reaction as will be understood by a skilled person.

In hybrid organic-inorganic redox active composite material herein described the inorganic additive material with the features of the present disclosure, also creates a cohesive composite where gaps between aggregates of active material are filled by the inorganic material also improving the performance of the redox-active composite as will be understood by a skilled person.

In particular, formation of a cohesive dense composite allows the use of a reduced volume of electrolyte as fewer void spaces exist in the electrode to pool electrolyte that is not in contact with active material. In contrast non cohesive, less dense, highly porous organic cathode (e.g. SPoly alone) needs more electrolyte to occupy the gaps in the electrode structure which reduces the battery performance, lower the specific energy density (Wh/kg) and volumetric energy density (Wh/L) due to increase mass of cell due to extra electrolyte. Using a highly dense inorganic additive (e.g. LFP) in combination with the sulfurized carbon matrix (e.g. SPoly) creates a hybrid redox active material that closes the gaps and distributes the electrolyte to the redox active aggregates in the composite more effectively will be understood by a skilled person.

In embodiments of the disclosure the inorganic additive material and the organic redox active material are chemically compatible with each other and with at least one solvent for their preparation as will be understood by a skilled person upon reading of the disclosure.

In some embodiments herein described hybrid inorganic-organic redox material of the disclosures comprise, the sulfurized polymer materials (e.g. SPoly), S-linked polymer (Gen1, PAQS), COFs together with different inorganic fillers such as, (LFP, LTO, TiS₂, Al₂O₃, LMFP, LCO, NMC532, NMC622, NMC811, MoS₂, FeS₂, TiO₂ to name a few) can be incorporated into functional electrodes by mixing with suitable binder and conductive additive. In some embodiments, the composition of electrodes may vary from 50-95 wt % active material of sulfurized carbon matrices (e.g. SPoly), 2-20 wt % conductive additive, 2-20 wt % electrode high density inorganic materials (e. g. LFP), and 1-20 wt % binder can be present with the total wt % of all species summing to 100%.

In some embodiments, the selection of a specific weight ratio of the organic redox active material (e.g., SPoly) to the inorganic additive is performed to optimize battery performance by balancing two competing factors: maximizing the gravimetric capacity contributed by the high-capacity organic material and maximizing the electrode packing density contributed by the high-density inorganic additive. The organic SPoly matrix, while possessing a high theoretical capacity of approximately 720-770 mAh/g, also has a low intrinsic density of less than 1.0 g/cm³. By incorporating a small weight fraction of a high-density inorganic material according to the present disclosure, the overall electrode packing density can be increased to values greater than 1.2 g/cm³ while maintaining a composite material capacity of greater than 600 mAh/g.

In some embodiments, preferred weight ratios of sulfurized carbon matrix to inorganic additives, ranging from 75:25 to 98:2 and from 90:10 to 92:8 such as 93:7, 91:9, and 9:1, can provide an optimized balance wherein the inorganic additive is present in a sufficient quantity to achieve the desired densification without excessively diluting the high-capacity sulfurized carbon matrix component. For instance, in a 91:9 weight ratio of SPoly to LFP, the theoretical capacity of the hybrid material is approximately 701 mAh/g, retaining over 90% of the SPoly's original capacity while benefiting from the significant density of LFP (3.6 g/cm³). This increase in density is achieved through two mechanisms: first, by raising the average mass per unit volume of the composite, and second, by having the inorganic particles fill the interstitial voids within the amorphous SPoly matrix, which further increases density beyond a simple rule of mixtures and improves structural integrity.

In some embodiments, the choice of inorganic additive can be tailored to achieve different synergistic effects. For example, in some embodiments, an electrochemically inactive additive, such as LFP within the operational voltage range of 0.7V to 3.2V, is preferred. In this configuration, the inorganic material's primary function is to serve as a high-density structural filler, ensuring that the high capacity of the electrode is almost exclusively derived from the SPoly component. In other embodiments, an electrochemically active additive, such as LTO (175 mAh/g) or TiS₂ (239 mAh/g), is selected. In these cases, the inorganic additive not only increases the electrode packing density but also contributes to the overall capacity of the hybrid material, leading to a composite with a higher theoretical capacity than an equivalent ratio using an inactive filler. For example, a 91:9 SPoly:LTO mixture has a theoretical capacity of approximately 717 mAh/g, as both components are active within the cycling voltage window. This strategic selection allows for the precise tuning of the final electrode's properties to meet the demands of specific applications.

In some embodiments, in a hybrid organic-inorganic redox active composite material herein described, the increased electrode packing density and cohesive composite can be obtained with a combination of organic redox active material and an inorganic additive in a ratio that can range from 3:1 to 49:1, possibly from 3:1 to 30:1, or from 4:1 to 35:1, or possibly from 4:1 to 19:1 in which the redox active aggregate size and the inorganic particles size are in a ratio from 20:1 to 5:1, and the inorganic particle surface is >10 X, the redox aggregate surface area. Exemplary subranges for the weight ratio of the organic redox active material to the inorganic additive include from 5:1 to 30:1, from 7:1 to 20:1, and from 8:1 to 15:1. In other embodiments, the weight ratio can be expressed as a percentage, with exemplary subranges including organic-to-inorganic ratios of from 90:10 to 98:2, or from 91:9 to 95:5. Specific preferred ratios derived from experimental data include 9:1, 91:9 or 93:7 as will be understood by a skilled person upon reading of the present disclosure.

In some embodiments herein described, the sulfurized carbon matrices (e.g. SPoly), S-linked polymer (e.g. Gen1, PAQS), COFs together with different inorganic additive such as, LFP, LTO, ccLTO, TiS₂, Al₂O₃, LMFP, LCO, NMC532, NMC622, NMC811, MoS₂, conductive TiO₂, FeS₂ can be incorporated into functional electrodes by mixing with suitable binder and conductive additive. In some embodiments, the composition of electrodes may vary from 50-95 wt % active material of sulfurized carbon matrices (e.g. SPoly), 2-20 wt % conductive additive, 2-20 wt % electrode high density inorganic material (e.g. LFP), and 1-20 wt % binder can be present with the total wt % of all species summing to 100%.

In some embodiments, the organic-inorganic hybrid mixture of sulfurized carbon matrices (e.g. SPoly) to LFP with the weight ratio of 9:1 is preferred. In some embodiments, the organic-inorganic hybrid mixture of sulfurized carbon matrices (e.g. SPoly) to LTO with the weight ratio of 9:1 is preferred. In some embodiments, the organic-inorganic hybrid mixture of sulfurized carbon matrices (e.g. SPoly) to TiS₂ with the weight ratio of 9:1 is preferred. In some embodiments, the organic-inorganic hybrid mixture of sulfurized carbon matrices (e.g. SPoly) to MoS₂ with the weight ratio of 9:1 is preferred. In some embodiments, the organic-inorganic hybrid mixture of sulfurized carbon matrices (e.g. SPoly) to LMFP with the weight ratio of 9:1 is preferred.

In some embodiments, the organic-inorganic hybrid mixture of SPoly to LFP with weight ratio of 9:1 is preferred. The theoretical capacity of the 9:1 weight ratios of SPoly to LFP is ~693 mAh/g, which is 90% of the SPoly capacity (770 mAh/g) since LFP does not contribute to the overall capacity of the electrode within the voltage range of 0.7V to 3.2V. When the low density SPoly (<1.0 g/cm³) mixed with high-density LFP (3.6 g/cm³), the average mass per unit volume of the composite increases, therefore increases the density of such composite since the density is roughly a weighted average mass of the components per unit volume. Furthermore, the inorganic particles—in this case LFP—fill the voids of the free volume of the SPoly reducing its porosity, which causes further increasing the density of the hybrid composite beyond simple rule of mixtures.

In some embodiments, the organic-inorganic hybrid mixture of SPoly to LTO with weight ratio of 9:1 is preferred. The theoretical capacity of the 9:1 weight ratios of SPoly to LTO is ~711 mAh/g, which is 90% of the SPoly capacity plus LTO capacity (175 mAh/g within the 0.7V-3.2V range) and does contribute to the overall capacity of the electrode within the voltage range of 0.7V to 3.2V. When the low density SPoly (<1.0 g/cm³) mixed with high-density LTO (3.43 g/cm³), the average mass per unit volume of the composite increases, therefore increases the density of such composite since the density is roughly a weighted average mass of the components per unit volume. Furthermore, the inorganic particles—in this embodiment LTO—fill the voids of the free volume of the SPoly reducing its porosity, which causes further increasing the density of the hybrid composite beyond simple rule of mixtures.

In some embodiments, the organic-inorganic hybrid mixture of SPoly to TiS₂ with weight ratio of 9:1 is preferred. The theoretical capacity of the 9:1 weight ratios of SPoly to TiS₂ is ~717 mAh/g, which is 90% of the SPoly capacity plus TiS₂ capacity since TiS₂ has a capacity of 239 mAh/g (0.7V-3.2V range) and does contribute to the overall capacity of the electrode within the voltage range of 0.7V to 3.2V. When the low density SPoly (<1.0 g/cm³) mixed with high-density TiS₂ (3.22 g/cm³), the average mass per unit volume of the composite increases, therefore increases the density of such composite since the density is roughly a weighted average mass of the components per unit volume. Furthermore, inorganic particles such as the exemplified TiS₂, fill the voids of the free volume of the SPoly reducing its porosity, which causes further increasing the density of the hybrid composite beyond simple rule of mixtures.

In some embodiments, the organic-inorganic hybrid mixture of sulfurized carbon matrices (e.g. SPoly) to LFP with the weight ratio of 91:9 is preferred. In some embodiments, the organic-inorganic hybrid mixture of sulfurized carbon matrices (e.g. SPoly) to LTO with the weight ratio of 91:9 is preferred. In some embodiments, the organic-inorganic hybrid mixture of sulfurized carbon matrices (e.g. SPoly) to TiS₂ with the weight ratio of 91:9 is preferred. In some embodiments, the organic-inorganic hybrid mixture of sulfurized carbon matrices (e.g. SPoly) to MoS₂ with the weight ratio of 91:9 is preferred. In some embodiments, the organic-inorganic hybrid mixture of sulfurized carbon matrices (e.g. SPoly) to LMFP with the weight ratio of 91:9 is preferred. In some embodiments, the organic-inorganic hybrid mixture of sulfurized carbon matrices (e.g. SPoly) to Al₂O₃ with the weight ratio of 91:9 is preferred.

In some embodiments, the organic-inorganic hybrid mixture of sulfurized carbon matrices (e.g. SPoly) to LFP with the weight ratio of 93:7 is preferred. In some embodiments, the organic-inorganic hybrid mixture of sulfurized carbon matrices (e.g. SPoly) to LTO with the weight ratio of 93:7 is preferred. In some embodiments, the organic-inorganic hybrid mixture of sulfurized carbon matrices (e.g. SPoly) to TiS₂ with the weight ratio of 93:7 is preferred. In some embodiments, the organic-inorganic hybrid mixture of sulfurized carbon matrices (e.g. SPoly) to MoS₂ with the weight ratio of 93:7 is preferred. In some embodiments, the organic-inorganic hybrid mixture of sulfurized carbon matrices (e.g. SPoly) to LMFP with the weight ratio of 93:7 is preferred. In some embodiments, the organic-inorganic hybrid mixture of sulfurized carbon matrices (e.g. SPoly) to Al₂O₃ with the weight ratio of 93:7 is preferred.

In some embodiments, the organic-inorganic hybrid mixture of sulfurized carbon matrices (e.g. SPoly) to LFP to LTO with the weight ratio of 91:4.5:4.5 is preferred. In some embodiments, the organic-inorganic hybrid mixture of sulfurized carbon matrices (e.g. SPoly) to LTO to TiS₂ with the weight ratio of 91:4.5:4.5 is preferred. In some embodiments, the organic-inorganic hybrid mixture of sulfurized carbon matrices (e.g. SPoly) to LFP to TiS₂ with the weight ratio of 91:4.5:4.5 is preferred. In some embodiments, the organic-inorganic hybrid mixture of sulfurized carbon matrices (e.g. SPoly) to TiS₂ to LTO with the weight ratio of 91:4.5:4.5 is preferred. In some embodiments, the organic-inorganic hybrid mixture of sulfurized carbon matrices (e.g. SPoly) to LFP to MoS₂ with the weight ratio of 91:4.5:4.5 is preferred. In some embodiments, the organic-inorganic hybrid mixture of sulfurized carbon matrices (e.g. SPoly) to LFP to LMFP with the weight ratio of 91:4.5:4.5 is preferred. In some embodiments, the organic-inorganic hybrid mixture of sulfurized carbon matrices (e.g. SPoly) to LFP to Al₂O₃ with the weight ratio of 91:4.5:4.5 is preferred.

In some most preferred embodiments, the hybrid organic-inorganic redox active materials of the disclosure demonstrate notable performance when utilized as a cathode material in an electrochemical cell, particularly when paired with an anode such as lithium metal or in situ lithiated graphite and a non-aqueous electrolyte, such as one comprising 180+FEC20. These hybrid materials are preferably formed from a sulfurized carbon matrix, for which SPoly is a representative example, combined with an inorganic additive in weight ratios ranging from 3:1 to 49:1, with specific preferred ratios including 91:9, 90:10, and 9:1. In other preferred embodiments, the organic component itself is a composite of SPoly and Gen1, which is then combined with an inorganic additive in weight ratios of SPoly:Gen1:inorganic additive ranging from 80:10:10 to 90:5:5, with a particularly preferred ratio being 88:6:6. A skilled person will understand that the ratios, concentrations, and proportions described herein for SPoly are expected to be applicable to other sulfurized carbon matrices in accordance with the indications of the instant disclosure.

In some most preferred embodiments, the organic-inorganic hybrid mixture of sulfurized carbon matrices is formed by or comprises SPoly which is considered representative example of sulfurized carbon matrices. A skilled person will understand that that the ratios concentrations and proportions indicated herein for SPoly are expected to be applicable to other sulfurized carbon matrices in accordance with the indications of the instant disclosure.

In some preferred embodiments the hybrid inorganic-organic redox active material of the disclosure comprise SPoly and inorganic additive in weight ratios SPoly:inorganic additive ranging from 3:1 to 49:1, preferably 91:9, 90:10 by weight or from 3:1 to 30:1, preferably 9:1 by weight.

In some preferred embodiments the hybrid inorganic-organic redox active material of the disclosure comprise SPoly:Gen1 and inorganic additive in weight ratios SPoly:Gen1:inorganic additive ranging from 80:10:10 to 90:5:5 preferably in a weight ratios 88:6:6.

In some preferred embodiments the hybrid inorganic-organic redox active material of the disclosure comprise SPoly:COF and inorganic additive in weight ratios SPoly:COF:inorganic additive ranging from 80:10:10 to 90:5:5 preferably in a weight ratio 88:6:6.

In embodiments herein describe the redox active aggregate size of the and the inorganic particles size are in a ratio from 20:1 to 5:1. In some embodiments, the redox active aggregate size of the and the inorganic particles size are in a ratio from 2:1 to 10:1.

In some exemplary embodiments the redox active aggregate size of the and the inorganic particles size are in a ratio from 10:1 (see e.g. Examples 20, 22, 23, 25, 26 and 29).

In some exemplary embodiments the redox active aggregate size and the inorganic particles size are in a ratio of 2:1 (see e.g. Examples 27 and 28).

In embodiments herein described the inorganic particle surface is >10 X, the redox aggregate surface area.

In some embodiments expected inorganic:organic size ratios are between 2:1 and 10:1; surface areas are from 5:1 to 20:1.

In preferred embodiments the inorganic additive particles are selected to have a smaller size and a larger surface area compared to the organic redox active aggregate, which provides better packing in the electrode and better performance as will be understood by a skilled person upon reading of the present disclosure.

In particular in preferred embodiments the inorganic additive particles have a size 1-10× e.g. 2 to 5× smaller and have a surface area 1-20× e.g. 2 to 10× greater than the organic redox aggregate as will also be understood by a skilled person upon reading of the present disclosure.

In one embodiment, the ratio of the organic redox active aggregate size to the inorganic particle size ranges from 5:1 to 15:1, while the ratio of the organic redox active aggregate surface area to the inorganic particle surface area ranges from 1:5 to 1:20. In a more specific embodiment, the organic:inorganic size ratio is about 10:1 and the surface area ratio is about 1:15.

In some preferred embodiments organic:inorganic size ratios are 10:1 and the organic:inorganic surface area ratios are 1:10. In some preferred embodiments organic:inorganic size ratios are 10:1 and the organic:inorganic surface area ratios are 1:15; In some preferred embodiments organic:inorganic size ratios are 2:1 and the organic:inorganic surface area ratios are 1:5. In some preferred embodiments organic:inorganic size ratios are 10:1 and the organic:inorganic surface area ratios are 1; 20 Any organic:inorganic size ratios and organic:inorganic surface area ratios encompassed between the stated ratios are also expected to be preferred as will be understood by a skilled person upon reading of the present disclosure.

In some embodiments expected organic: inorganic size ratios are between 2:1 and 10:1; surface areas are from 1:5 to 1:20. In some of those embodiments organic:inorganic surface areas can be in a ratio 1:10 (see e.g. Examples 20, 22 and 23), or 1:15 (see e.g. Examples 25 and 26) or 1:5 (see e.g. Examples 27 and 28) or 1:20 (see e.g. Example 29).

In one example, the organic redox active material is SPoly having an average aggregate size of 50 μm and the inorganic additive is LFP particles having an average size of 5 um.

In another example, the organic redox active material is SPoly having an average aggregate size of 10 μm and the inorganic additive is LFP particles having an average size of 1 um.

In a further example, the organic redox active material can comprise SPoly optionally including an S-linked Quinone and/or a COF, the organic redox active material having an average aggregate size from 50 μm to 10 μm and the inorganic additive is LFP having a particle size from 1.5-15 um, and a surface area from 10-15 m²/g (see Examples 20, 22 and 23).

In another example, the organic redox active material can comprise SPoly optionally including an S-linked Quinone and/or a COF, the organic redox active material having an average aggregate size from 50 μm to 10 μm and the inorganic additive is LTO having a particle size from 1.3-3 um, and a surface area 16 m²/g (see Examples 25 and 26).

In an additional example, the organic redox active material can comprise SPoly optionally including an S-linked Quinone and/or a COF, the organic redox active material having an average aggregate size from 50 μm to 10 μm and the inorganic additive is TiS₂ having a particle size from 40-70 um (see Examples 27 and 28).

In further example, the organic redox active material can comprise SPoly optionally including an S-linked Quinone and/or a COF, the organic redox active material having an average aggregate size from 50 μm to 10 μm and the inorganic additive is Al₂O₃ having a particle size from 1 less than 500 nm, and a surface area from 5-120 m²/g (see Example 29).

The method comprises mixing an organic redox active material of the disclosure and an inorganic additive material of the disclosure in a solvent for a time and under conditions to provide a redox active composite material and the organic redox active material and the inorganic additive material.

In particular, the sulfurized carbon polymer matrices (SPoly), S-linked polymer (Gen1, PAQS), COFs together with different inorganic materials such as, lithium iron phosphate (LFP), lithium titanate (LTO), titanium sulfide (TiS₂), aluminum oxide (Al₂O₃), LMFP, LCO, NMC532, NMC622, NMC811, MoS₂, conductive TiO₂, FeS₂ can be incorporated into functional redox electrodes by mixing with suitable binder and conductive additive in coating solvent such as H₂O.

In embodiments herein described mixing methods include planetary mixing and high shear mixing. Electrode coating methods include drop casting, doctor blade casting, spin coating, comma-roll coating, dry process and extrusion. In some embodiments, the composition of electrodes may vary from 50-95 wt % active material, 2-20 wt % conductive additive, 2-20 wt % electrode filler, and 1-20 wt % binder can be present with the total wt % of all species summing to 100%.

In a particularly advantageous embodiment, a cathode material comprises: 70-95 wt % possibly 70-95 wt % of a hybrid organic-inorganic active material, wherein the hybrid material itself consists of SPoly and LTO in a 91:9 weight ratio; 3-25 wt % of a conductive additive such as SPC65 carbon; and 2-5 wt % of a binder system such as CMC and SBR. This cathode composition, when processed to an electrode packing density of 1.3 g/cm³, yields a specific energy of 1350 Wh/kg (see Table 2).

In a particularly advantageous embodiment, a cathode material comprises 70-95 wt % of a hybrid organic-inorganic active material, wherein the hybrid material itself consists of SPoly and LFP in a 91:9 weight ratio; 3-25 wt % of a conductive additive such as SPC65 carbon; 2-5 wt % of a binder system such as CMC and SBR. This cathode composition, when processed to an electrode packing density of 1.4 g/cm³, yields a specific energy of 1272 Wh/kg (see Table 2).

In a particularly advantageous embodiment, a cathode material comprises 70-95 wt % of a hybrid organic-inorganic active material, wherein the hybrid material itself consists of SPoly and TiS₂ in a 91:9 weight ratio; 3-25 wt % of a conductive additive such as SPC65 carbon; 2-5 wt % of a binder system such as CMC and SBR. This cathode composition, when processed to an electrode packing density of 1.4 g/cm³, yields a specific energy of 1375 Wh/kg (see Table 2).

In preferred embodiments, the organic redox active material of the hybrid organic-inorganic redox active composite of the disclosure comprises a sulfurized carbon matrix as the sole organic redox active material.

In some embodiments the organic redox active material can further comprise additional organic redox active compounds in ratio 49:1 wt ratio to 4:1 wt ratio possibly from 19:1 wt ratio to 4:1 wt ratio.

In particular in some embodiments the organic redox active material can comprise one or more S-linked quinone polymers in a ratio a sulfurized carbon matrix S-linked quinone from 19:1 wt ratio to 4:1 wt ratio corresponding to a ratio from 95 wt % sulfurized carbon matrices:5 wt % S-linked quinone to 80 wt % sulfurized carbon matrices:20 wt % S-linked quinone.

The term a “S-linked quinone polymer” as used herein indicates sulfur containing quinone polymers, where monomeric units are linked via a sulfide (—S—) bond. Accordingly, the S-linked quinone polymer are sulfur containing polymer comprising one or more redox active quinone moieties as will be understood by a skilled person.

The term “polymer” as used herein indicates any of a class of natural or synthetic substances composed of very large organic molecules, called macromolecules, which comprises many repeating same and/or different chemical units called monomers. In particular, the word “polymer” comprises any products arising from the linkage of organic repeating units by covalent chemical bonds comprising for example aromatic moieties such as benzene, naphthalene, anthracene and moieties derivable therefrom such as quinones, and aliphatic monomeric unit such as ethylene, propylene, cyclooctadiene, diene, olefin, acrylonitrile, methyl methacrylate, vinyl acetate, dichlorodimethylsilane, tetrafluoroethylene and additional monomers identifiable by a skilled person. Monomers as described herein can include substituent selected from F, Cl, Br, I, CF₃, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms or any suitable substituent identifiable by a skilled person.

Accordingly, S-linked quinone polymers as described herein comprise a polymer in the sense of the disclosure which in turn comprises a redox active quinone monomeric moiety.

In some embodiments, where the S-linked quinone polymers herein described the redox active moiety is provided by the quinone moiety of the polymer.

The term “quinones” and related moieties as used herein indicates a class of organic compounds that are formally “derived from aromatic compounds [such as benzene or naphthalene] by conversion of an even number of —CH═ groups into —C(═O)— groups with any necessary rearrangement of double bonds, resulting in “a fully conjugated cyclic dione structure [1] [2] [3] [4] [5]. Exemplary quinones comprises moieties such as 1,4-benzoquinone or cyclohexadienedione, often called simply “quinone” (thus the name of the class). Other examples are 1,2-benzoquinone (ortho-quinone), 1,4-naphthoquinone and 9,10-anthraquinone [5]. Other quinones include 2,5-dichloroanthraquinone, 3,6-dibromo-phenanthrequinone, 2,7-dibromo-phenanthrequinone, and 1,2,5,6-anthracenetetraone as described herein, as well as additional quinones as will be understood by a skilled person.

In some embodiments herein described, S-link quinone polymers comprise homopolymers of 2,5-S-linked-anthraquinone (PAQS), 3,6-S-linked-phenanthrequinone (36PPAQS), 2,7-S-linked-phenanthrequinone (27PPAQS), and 9,10-S-linked-1,2,5,6-anthracenetetraone (PAQT) as described herein, as well co-polymers in a configuration such as alternating copolymer, random copolymer, block copolymer and graft copolymer, as will be understood by a skilled person. An exemplary random copolymer as described herein is poly-anthraquinone-benzoquinone sulfide (PAQS-BQ). Additional quinone copolymers in the sense of the disclosure are identifiable by a skilled person.

In some examples, S-linked polymer is obtained via the reaction between chlorinated or brominated quinone monomer and Na₂S at 120-150° C.

In some embodiments, a S-linked quinone polymer of the present disclosure can be S-linked homopolymers represented by Formula (I)

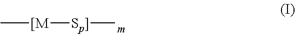

in which
M is a redox active a monomeric quinone moiety comprising a redox potential of 0.5 V to 3.5 V with reference to Li/Li+ electrode potential under standard conditions,
p refers to the number of sulfur atom linking the redox active monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1,000 Dalton and a solubility in tetrahydrofuran (THF) of equal or less than 1.0 microgram per mL at room temperature (i.e. 21° C.) at 1 atm, preferably a solubility in tetrahydrofuran (THF) of equal or less than 0.1 microgram per mL at room temperature at 1 atm, more preferably a solubility in tetrahydrofuran (THF) of equal or less than 0.01 microgram per mL at room temperature at 1 atm.

In some embodiments, at least one redox active monomeric moiety M of Formula (I) can be represented by Formula (III):

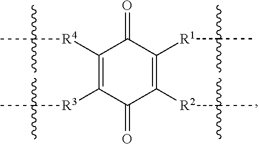

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line ----- represents null or a single bond to quinone ring carbon when associated R¹, R², R³, or R⁴ is null.

In some embodiments, the at least one redox active monomeric moiety M of Formula (I) represented by Formula (III) can be any one of S-linked monomeric moiety —S-M of Formula (IIIA) and Formula (IIIB)

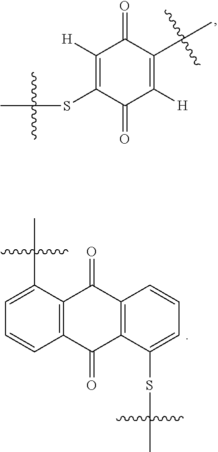 [SMILES: *SC1=CC(=O)C(*)=CC1=O ; *Sc1cccc2c1C(=O)c1cccc(*)c1C2=O]

In some embodiments, the at least one redox active monomeric moiety M of Formula (I) can be represented by Formula (IV):

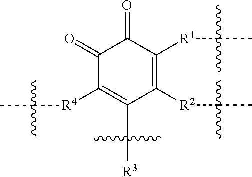

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms, wherein heteroatoms are selected from O, N, and S, R¹ and R² together and/or R³, and R⁴ together are part of an aromatic or aliphatic cyclic structure, and wherein dash line ----- represents null or a single bond to quinone ring carbon when associated R¹, R², R³, or R⁴ is null.

In some embodiments, the at least one redox active monomeric moiety M of Formula (I) represented by Formula (IV) can be any one of S-linked monomeric moiety as shown in Formula (IVA), Formula (IVB), Formula (IVC)

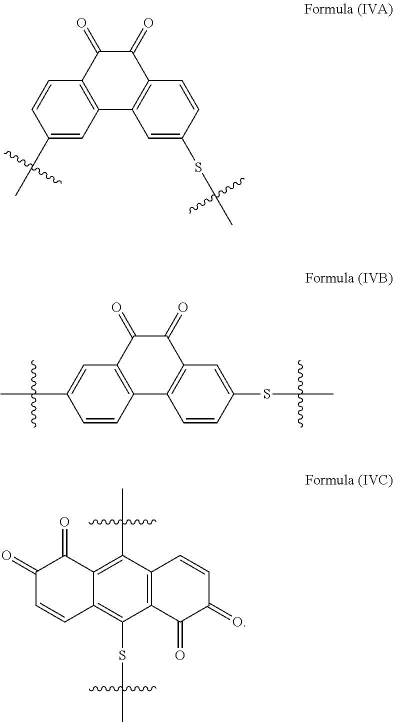 [SMILES: *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

In some embodiments, the source of sulfide Sp includes but is not limited to elemental sulfur S8, Na₂S, Li₂S, K₂S any other sulfur containing compound known to a skilled person.

In some embodiments, the S-linked quinone polymer can be provided by a method comprising
providing a redox active monomeric quinone monomer X₁-M-X₂, wherein X₁ and X₂ presents a leaving group,
providing a source of sulfide Sp,
contacting the redox active monomeric quinone monomer X₁-M-X₂ with the source of sulfide Sp under suitable conditions and for sufficient period of time to provide the S-linked quinone polymer represented by Formula (I)

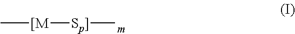

in which
M is a redox active monomeric quinone moiety having a redox potential of 0.5 V to 3.5 V with reference to Li/Li+ electrode potential under standard conditions,
p refers to the number of sulfur atom linking the redox active a monomeric quinone moiety M, p ranges from 1 to 5,
Sₚ is a sulfide when p is 1 or polysulfide when p is from 2 to 5,
m ranges from 5 to 10,000,
wherein the S-linked quinone polymer has a weight average molecular weight of at least 1500 Dalton or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

In some embodiments, the leaving group X1 and X2 can be independently selected from Cl⁻, Br⁻, I⁻, ⁻OTs, ⁻OMs, ⁻OTf or any other leaving groups known to a skilled person.

In some embodiments, the source of sulfide Sp includes but is not limited to elemental sulfur S8, Na₂S, K₂S, Li₂S any other sulfur containing compound known to a skilled person.

The specific chemical moiety, groups and substituents can be selected to provide the desired redox activity as will be understood by a skilled person.

In some embodiments, an organic redox active material of the hybrid organic-inorganic redox active composite of the disclosure can comprise an S-linked copolymer represented Formula (II)

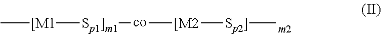

in which
M1 and M2 are each a redox active monomeric quinone moiety comprising a redox potential of 0.5 V to 3.5 V with reference to Li/Li⁺ electrode potential under standard conditions,
p1 and p2 each independently refer to the number of sulfur atom linking the redox active a monomeric quinone moiety M1 and M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
wherein the S-linked quinone copolymer of Formula (II) has a weight average molecular weight of at least 1,000 Dalton and a solubility in tetrahydrofuran (THF) of equal or less than 1.0 microgram per mL at room temperature at 1 atm, preferably a solubility in tetrahydrofuran (THF) of equal or less than 0.1 microgram per mL at room temperature at 1 atm, more preferably a solubility in tetrahydrofuran (THF) of equal or less than 0.01 microgram per mL at room temperature at 1 atm.

Formula (II) represents any arrangements of M1 and M2 moieties in the S-linked copolymer including random copolymer, block copolymer and alternate copolymer.

In particular, some embodiments, of the organic redox active material of the disclosure can comprise redox active monomer M1, redox active monomer M2, in a S-linked co-polymer can be a statistical random copolymer in which redox active monomer M1, redox active monomer M2, are statistically randomly present in the network polymer. Exemplary statistically random copolymer of M1 and M2 can be represented as

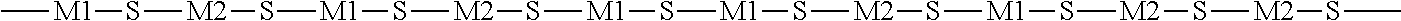

In some embodiments, redox active monomer M1, redox active monomer M2, in a S-linked co-polymer can be an alternating copolymer in which redox active monomer M1, redox active monomer M2, present alternately in a S-linked co-polymer. Exemplary alternating S-linked copolymer of M1 and M2 can be represented as

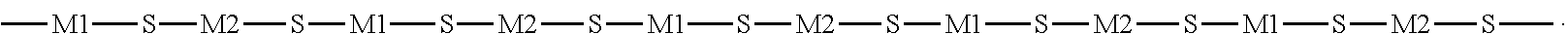

In some embodiments, redox active monomer M1, redox active monomer M2 in a S-linked co-polymer can be an M1M2 di-block copolymer in which redox active monomer M1, redox active monomer M2, present only in a sequence of at least 5 moieties in the S-linked co-polymer. Exemplary M1M2 di-block S-linked copolymer of M1 and M2 can be represented as

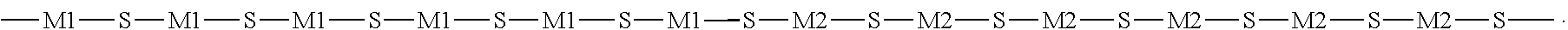

In some embodiments, redox active monomer M1, redox active monomer M2 in a S-linked co-polymer represent an M1M2M1 tri-block copolymer in which one of redox active monomer M1 and redox active monomer M2 present in at least two sequences of at least 5 moieties separated by a sequence of different moiety in the network polymer. Exemplary M1M2 tri-block copolymer of M1 and M2 can be represented as

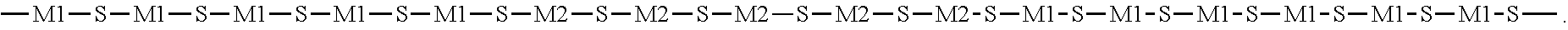

In some embodiments, the redox active monomeric quinone moiety M1 and redox active monomeric quinone moiety M2 of Formula (II) can be independently represented by any one of Formula (III) and Formula (IIV):

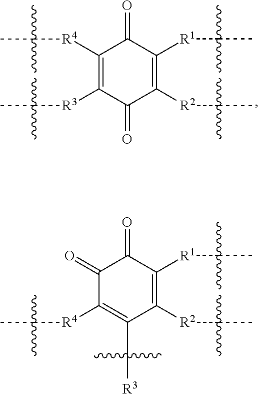

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line ----- represents null or a single bond to quinone ring carbon when associated R¹, R², R³, or R⁴ is null.

In some embodiments, S-linked redox active monomeric quinone moiety —S-M1 and S-linked redox active monomeric quinone moiety —S-M2 of Formula (II) can be independently any one of S-linked monomeric moiety —S-M of Formula (IIIA), Formula (IIIB), Formula (IVA), Formula (IVB), and Formula (IVC)

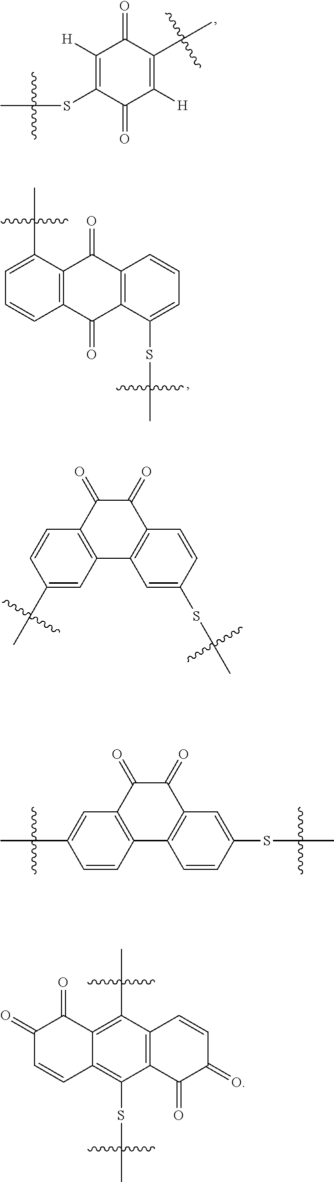 [SMILES: *SC1=CC(=O)C(*)=CC1=O ; *Sc1cccc2c1C(=O)c1cccc(*)c1C2=O ; *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

In some embodiments, the organic redox active material of the hybrid organic-inorganic redox active composite of the disclosure can include an S-linked copolymer comprising S-linked redox active monomeric quinone moiety —S-M1 S-linked monomeric moiety —S-M of Formula (IIIA),

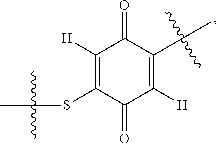 [SMILES: *SC1=CC(=O)C(*)=CC1=O]

and S-linked redox active monomeric quinone moiety —S-M2 of Formula (II) any one of S-linked monomeric moiety —S-M of Formula (IIIB), Formula (IVA), Formula (IVB), and Formula (IVC),

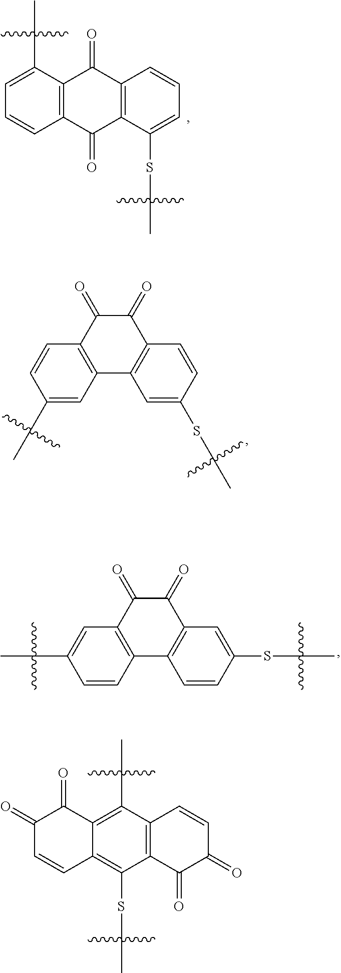 [SMILES: *Sc1cccc2c1C(=O)c1cccc(*)c1C2=O ; *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

wherein a molar ratio of S-linked monomeric moiety —S-M1 of Formula (IIIA) to S-linked monomeric moiety —S-M2 of Formula (IIIB), Formula (IVA), Formula (IVB), or Formula (IVC) ranges from 1:50 to 1:1, 1:20 to 1:2, 1:6 to 1:3, or 1:5 to 1:4, or
wherein a molar ratio of S-linked monomeric moiety —S-M1 of Formula (IIIA) to S-linked monomeric moiety —S-M2 of Formula (IIIB), Formula (IVA), Formula (IVB), or Formula (IVC) can be 1:4.

In some embodiments, a S-linked copolymer as described comprises the redox active monomeric quinone moiety M1 and redox active monomeric quinone moiety M2 of Formula (II) can be independently represented by Formula (III):

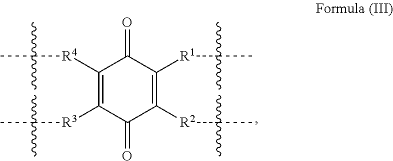

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line ----- represents null or a single bond to quinone ring carbon when associated R¹, R², R³, or R⁴ is null.

In some embodiments, S-linked redox active monomeric quinone moiety —S-M1 and S-linked redox active monomeric quinone moiety —S-M2 of Formula (II) can be S-linked monomeric moiety —S-M of Formula (IIIA) and Formula (IIIB)

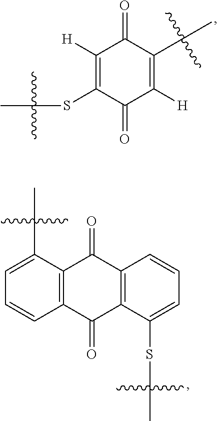 [SMILES: *SC1=CC(=O)C(*)=CC1=O ; *Sc1cccc2c1C(=O)c1cccc(*)c1C2=O]

wherein a molar ratio of S-linked monomeric moiety —S-M1 of Formula (IIIA) to S-linked monomeric moiety —S-M2 of Formula (IIIB) ranges from 1:50 to 1:1, 1:20 to 1:2, 1:6 to 1:3, or 1:5 to 1:4.

In some embodiments, a redox active S-linked copolymer PAQS_{0.8}BQ_{0.2} is described wherein S-linked redox active monomeric quinone moiety —S-M1 and S-linked redox active monomeric quinone moiety —S-M2 of Formula (II) can be independently any one of S-linked monomeric moiety —S-M of Formula (IIIA) and Formula (IIIB)

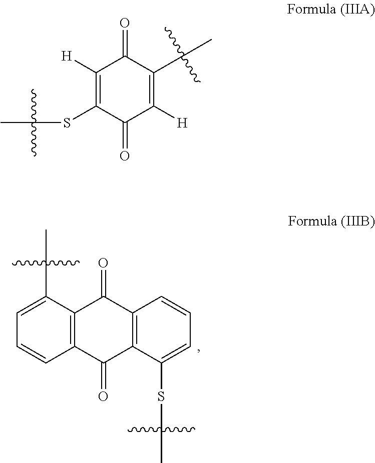 [SMILES: *SC1=CC(=O)C(*)=CC1=O ; *Sc1cccc2c1C(=O)c1cccc(*)c1C2=O]

wherein a molar ratio of S-linked monomeric moiety —S-M of Formula (IIIA) to Formula (IIIB) can be 1:4.

In some embodiments, the redox active monomeric quinone moiety M1 and redox active monomeric quinone moiety M2 of Formula (II) can be represented by Formula (IV):

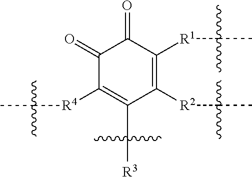

wherein R¹, R², R³, and R⁴ are each independently null, H, Sₚ wherein p ranges from 1 to 5, F, Cl, Br, I, CF3, a linear or branched, substituted or unsubstituted C1-C4 aliphatic group, an aromatic, heteroaromatic, non-aromatic cycle, or non-aromatic heterocycle containing substituent containing 4-12 carbon atoms and 0-4 heteroatoms,
wherein heteroatoms are selected from O, N, and S, R¹ and R² together and/or R³, and R⁴ together are part of an aromatic or aliphatic cyclic structure, and
wherein dash line ----- represents null or a single bond to quinone ring carbon when associated R¹, R², R³, or R⁴ is null.

In some embodiments, S-linked redox active monomeric quinone moiety —S-M1 and S-linked redox active monomeric quinone moiety —S-M2 of Formula (II) represented by Formula (IV) can be any one of S-linked monomeric moiety as shown in Formula (IVA), Formula (IVB), Formula (IVC)

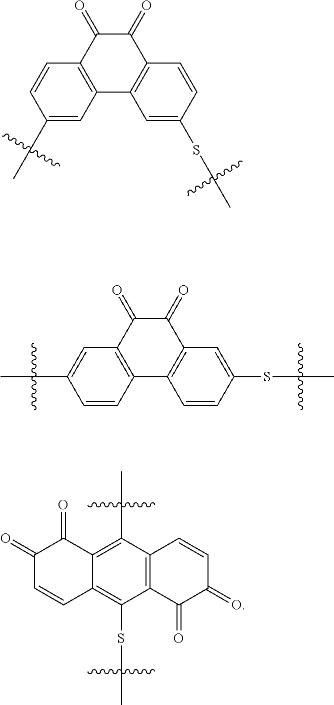 [SMILES: *Sc1ccc2c(c1)-c1cc(*)ccc1C(=O)C2=O ; *Sc1ccc2c(c1)C(=O)C(=O)c1cc(*)ccc1-2 ; *Sc1c2ccc(=O)c(=O)c2c(*)c2ccc(=O)c(=O)c12]

In some embodiments, an S-linked quinone copolymer which can be comprised within an organic redox active material of the disclosure can be provided by a method comprising
providing a redox active monomeric quinone monomer X₁-M1-X₂, and a redox active monomeric quinone monomer X₁-M2-X₂ wherein X₁ and X₂ presents a leaving group,
providing a source of sulfide Sₚ₁ and Sₚ₂,
contacting the redox active monomeric quinone monomer X₁-M1-X₂ and redox active monomeric quinone monomer X₁-M2-X₂ with the source of sulfide Sₚ₁ and Sₚ₂ under suitable conditions and for sufficient period of time to provide the S-linked quinone copolymer represented by Formula (II)

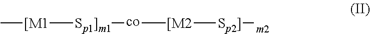

in which
M1 and M2 are each a redox active monomeric quinone moiety comprising a redox potential of 0.5 V to 3.5 V with reference to Li/Li+ electrode potential under standard conditions,
p1 and p2 each independently refer to a number of sulfur atom linking the redox active monomeric quinone moiety M1 and monomeric quinone moiety M2 respectively, p1 and p2 each independently range from 1 to 5,
Sₚ₁ is a sulfide when p1 is 1 or polysulfide when p1 is from 2 to 5,
Sₚ₂ is a sulfide when p2 is 1 or polysulfide when p2 is from 2 to 5,
m1 and m2 each independently range from 5 to 5,000, optionally a ratio of m1 to m2 ranges from 1:50 to 1:1, 1:20 to 1:2, 1:6 to 1:3, or 1:5 to 1:4,
   wherein the S-linked quinone copolymer of Formula (II) has a weight average molecular weight ranging from 1,000 Dalton to 2,000,000 Dalton, or a weight averaged MW ranging from 2000 to 2,000,000 Daltons, from 10,000 to 1,500,000 Daltons, from 100,000 to 1,000,000 Daltons, and a solubility in tetrahydrofuran (THF) of equal or less than 1.0 microgram per mL at 21° C. at 1 atm.

In some embodiments, the leaving group X1 and X 2 can be independently selected from Cl⁻, Br⁻, I⁻, ⁻OTs, ⁻OMs, ⁻OTf or any other leaving groups known to a skilled person.

In some embodiments, the source of sulfide Sₚ₁ and Sₚ2 includes but is not limited to elemental sulfur S₈, Na₂S, Li₂S, K₂S any other sulfur containing compound known to a skilled person.

The specific chemical moiety, groups and substituents can be selected to provide the desired redox activity as will be understood by a skilled person.

In some embodiments the organic redox active material of the hybrid organic-inorganic redox active composite of the disclosure can comprise one or more Covalent Organic Frameworks (COFs) in a ratio a sulfurized carbon matrix COF from 19:1 wt ratio to 4:1 wt ratio corresponding to a ratio from 95 wt % sulfurized carbon matrices:5 wt % S COF to 80 wt % sulfurized carbon matrices:20 wt % COF.

The wording “Covalent Organic Frameworks (COFs)” as used herein indicates are a class of crystalline porous materials constructed from organic molecules linked together by strong covalent bonds. COFs have are known for their highly tunable structures, low density, and exceptional thermal and chemical stability. These materials are characterized by their long-range order, high surface area, and customizable pore sizes, which make them highly versatile for various applications as will be understood by a skilled person.

The unique feature of COFs lies in their designability. By selecting appropriate organic building blocks, scientists can precisely tailor the geometry, pore dimensions, and functionality of the framework. This flexibility in design allows COFs to be engineered for a wide range of uses, including gas storage and separation, catalysis, energy storage, and environmental remediation. Their ordered pore structure also facilitates fast molecular transport, making them ideal for applications such as drug delivery and sensing.

Furthermore, COFs have been explored in fields like energy conversion, where their well-defined structures can be functionalized to enhance the performance of electrochemical devices such as batteries, supercapacitors, and fuel cells. Their lightweight, organic composition also makes COFs an attractive alternative to traditional inorganic porous materials like zeolites and metal organic frameworks (MOFs).

Covalent Organic Frameworks (COFs) are characterized by their porous polymer structures, which offer several advantages for energy storage applications.

COF offer high energy density, improved cycling stability, and increased capacity retention. This is largely due to their well-defined pore structures and the presence of redox-active sites that facilitate efficient ion transport and storage.

Additionally, the modular nature of COFs allows for precise control over their chemical structure, enabling the design of materials with tailored properties. This includes the ability to incorporate various functional groups that can enhance battery performance by providing additional redox activity or improving structural stability.

COFs also exhibit excellent thermal and chemical stability, which contributes to the overall safety and longevity of batteries. Their robust framework helps in maintaining structural integrity during charge-discharge cycles, reducing the risk of degradation over time.

COFs can be synthesized from organic materials that are potentially biodegradable, offering a more environmentally friendly alternative to traditional inorganic battery materials.

In particular COFs can be formed by condensation reactions between multifunctional small organic molecules, as will be understood by the skilled person, commonly between boronic acid molecules to form boroxines, or between nitriles to form triazines, or between amines and carbonyls to form imines, hydrazones, azines, squaraines, phenazines and/or imides as will be understood by a skilled person.

Exemplary COFs comprise

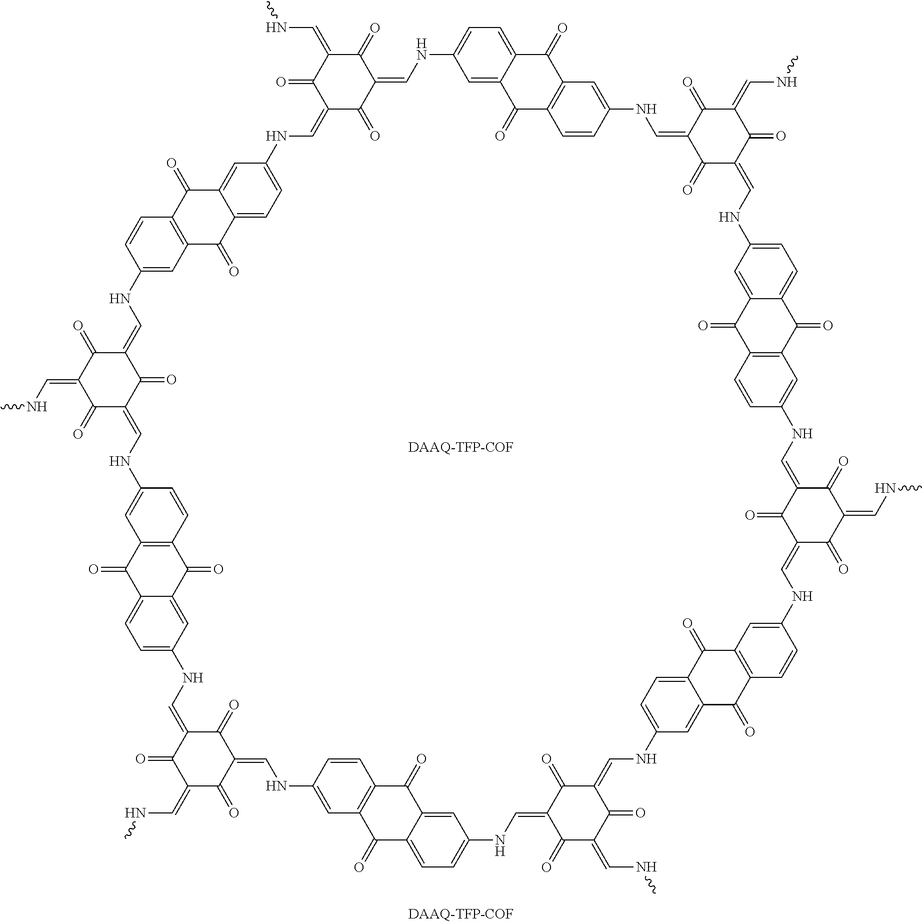

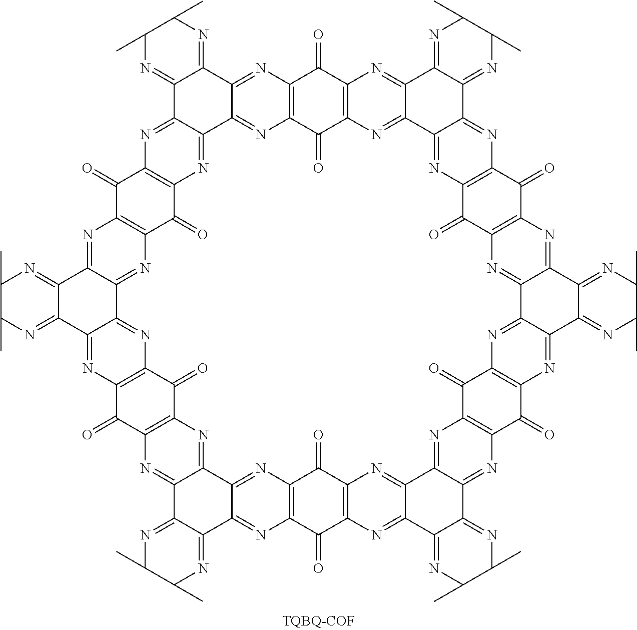 [SMILES: CC1N=c2c(c3nc4c(=O)c5nc6c7c(c8nc9c(=O)c%10nc%11c%12c(c%13nc%14c(=O)c%15nc%16c%17c(c%18nc%19c(=O)c%20nc%21c%22c(c%23nc%24c(=O)c%25nc%26c%27c(c%28nc%29c(=O)c%30nc2c2nc%30c(=O)c%29nc%28c%26nc%25c(=O)c%24nc%23c%21nc%20c(=O)c%19nc%18c%16nc%15c(=O)c%14nc%13c%11nc%10c(=O)c9nc8c6nc5c(=O)c4nc32)=NC(C)C(C)N=%27)=NC(C)C(C)N=%22)=NC(C)C(C)N=%17)=NC(C)C(C)N=%12)=NC(C)C(C)N=7)=NC1C]

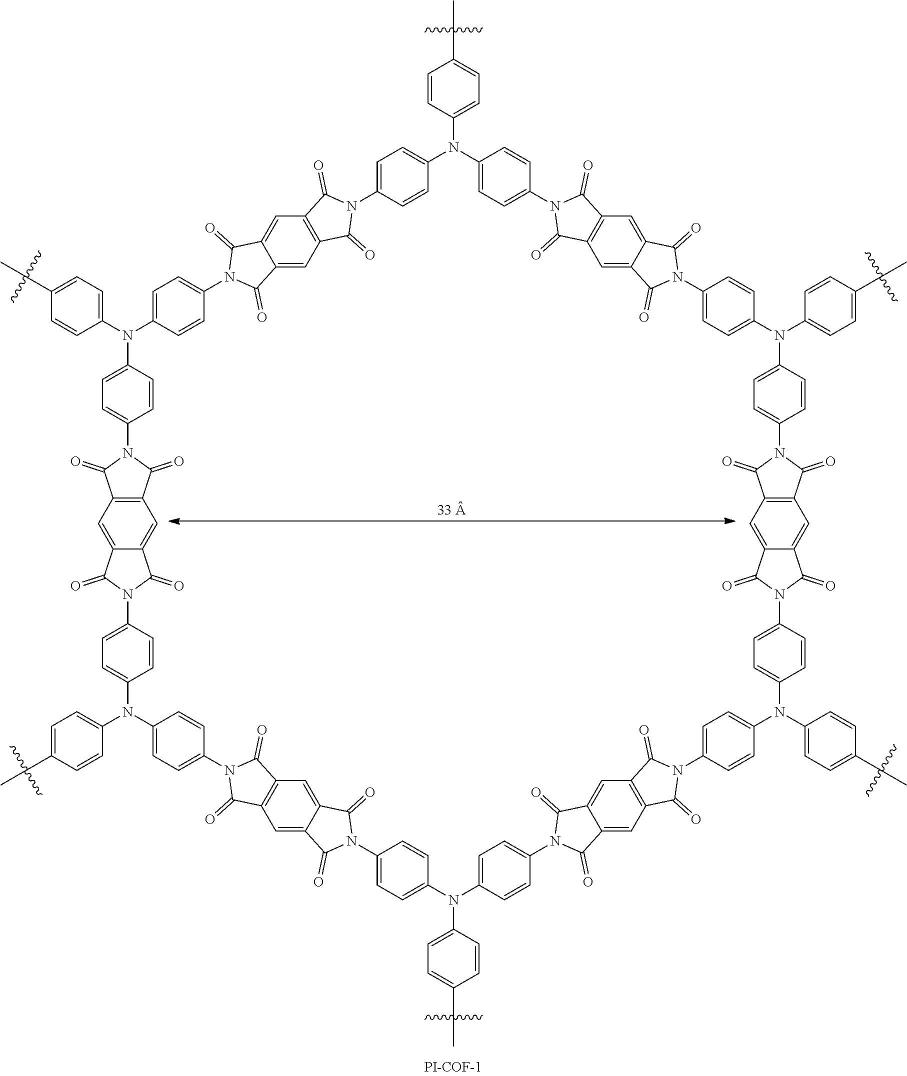 [SMILES: *c1ccc(-n2c3ccc(cc3)n3c(=O)c4cc5c(=O)n(c(=O)c5cc4c3=O)c3ccc(cc3)n(-c3ccc(*)cc3)c3ccc(cc3)n3c(=O)c4cc5c(=O)n(c(=O)c5cc4c3=O)c3ccc(cc3)n(-c3ccc(*)cc3)c3ccc(cc3)n3c(=O)c4cc5c(=O)n(c(=O)c5cc4c3=O)c3ccc(cc3)n(-c3ccc(*)cc3)c3ccc(cc3)n3c(=O)c4cc5c(=O)n(c(=O)c5cc4c3=O)c3ccc(cc3)n(-c3ccc(*)cc3)c3ccc(cc3)n3c(=O)c4cc5c(=O)n(c(=O)c5cc4c3=O)c3ccc(cc3)n(-c3ccc(*)cc3)c3ccc(cc3)n3c(=O)c4cc5c(=O)n(c(=O)c5cc4c3=O)c3ccc2cc3)cc1]

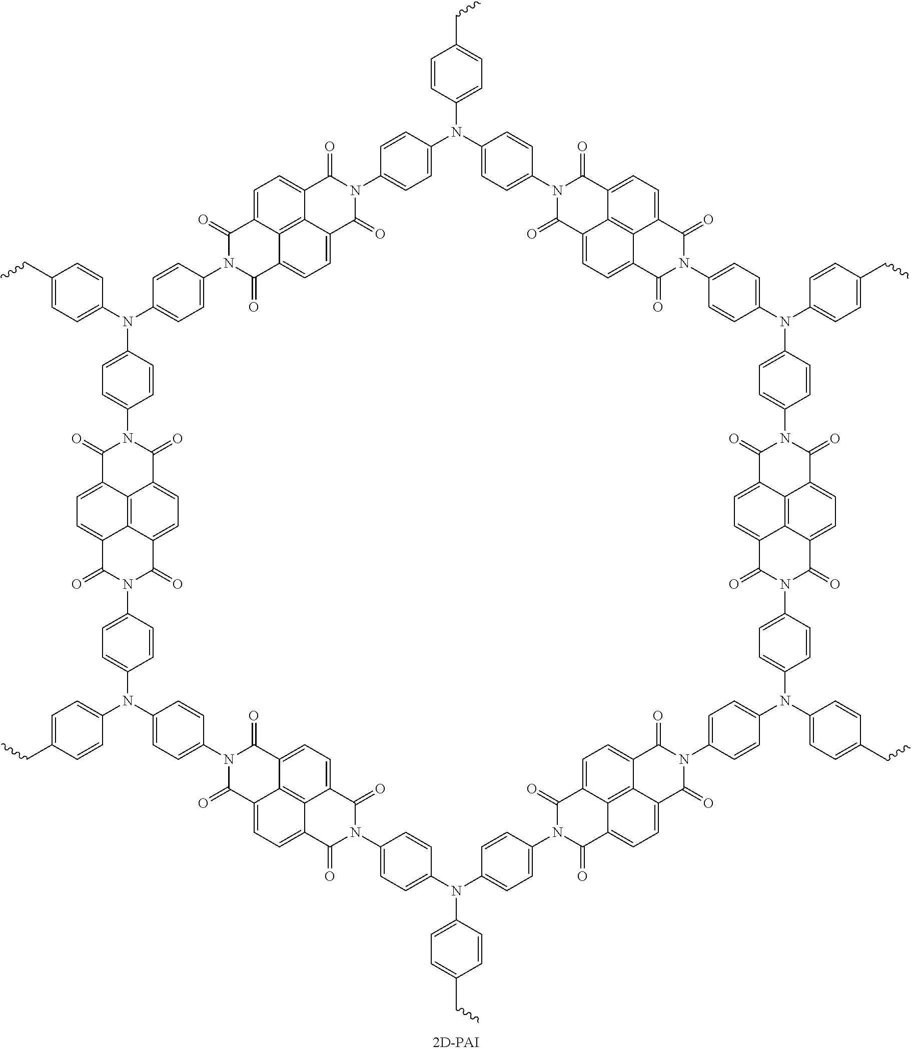

In some embodiments the hybrid organic-inorganic redox active composite of the disclosure can be comprised in composition in combination with one or more additional compounds.

In some embodiments the hybrid organic-inorganic redox active composite of the disclosure can be included in redox active composition further comprising one or more additives herein.

In some embodiment, the redox active material as described herein further comprises a binder, and a conductive additive, wherein the binder is selected from one of poly(vinylidene-fluoride), poly(tetrafluoroethylene), sodium carboxymethylcellulose, lithium carboxymethylcellulose, potassium carboxymethylcellulose styrene-butadiene rubber, polyacrylic acid (PAA), polyvinyl alcohol (PVA), polyethylene glycol (PEG), polyethylene oxide (PEO), polyamide imide (PAT), or any combination thereof, wherein the conductive additive is selected from one of graphite, carbon black, acetylene black, Super-P carbon, graphite, carbon nanotubes, vapor grown carbon fiber, graphene, nickel powder, KB and SP65 or any combination thereof.

As used herein, a “conductive additive” indicates a solid material which when present in the electrode composition enhances the electrical conductivity of the resulting electrode composition.

The term “binder” as used herein indicates an additive used to hold together the active material within an electrode material and make them adhere to the current collector. Binders play a significant role in maintaining the structural integrity of the electrode during battery operation, which involves repeated charge and discharge cycles, as will be understood by a skilled person. In particular, binders can be selected to provide mechanical cohesion to the electrode by binding the active material particles together. This minimizes the likelihood that they from detaching or crumbling during cycling, which is essential for maintaining consistent performance and prolonging battery life. Binders can also be selected to provide attachment of the electrode material to a current collector (such as copper for anode material or aluminum foil for cathode material) to promote efficient electron transfer between the active materials and the external circuit. Binders can also be selected to provide the electrode material with flexibility, allowing the electrode to accommodate volume changes that occur during lithium-ion intercalation and de-intercalation, thus reducing mechanical stress and potential cracking.

Exemplary binders in the sense of the disclosure comprise Polyvinylidene Fluoride (PVDF) one of the most commonly used binders in lithium-ion batteries, selected favored for its chemical stability, good adhesion properties, and ability to dissolve in organic solvents like N-methyl-2-pyrrolidone (NMP). Exemplary binders in the sense of the disclosure further comprise water based binders such as Carboxymethyl Cellulose (CMC) which is often used in combination with styrene-butadiene rubber (SBR) for anodes, particularly those based on graphite. CMC is water-soluble, making it environmentally friendly and safer to handle. Another water based binders is Styrene-Butadiene Rubber (SBR) which provides flexibility and elasticity, helping to accommodate volume changes in the electrode material. Some advanced binders incorporate conductive polymers or additives to enhance electrical conductivity within the electrode, potentially improving overall battery performance as will be understood by a skilled person.

In embodiments herein described a skilled person can select binders based on their i) chemical compatibility since the binder must be chemically compatible with both the electrolyte and active materials to prevent degradation or unwanted reactions. ii) environmental impact considering that water-based binders are generally preferred due to their lower environmental impact compared to solvent-based systems like PVDF/NMP; as well as iii) cost and processability, since the cost-effectiveness of the binder and its ease of processing during electrode fabrication can be important considerations for large-scale battery production.

In some embodiment, in the hybrid organic-inorganic redox active composite material as described herein the binder is present in 1 to 20% by weight of the total electrode composition, and the conductive additive is present in 5 to 70% by weight of the total electrode composition.

In particular in some preferred embodiments the cathode material can include one or more hybrid inorganic-organic redox active materials and further includes a binder (such as CMC, SBR) and optionally conductive additive also, which is then coated—(see Examples 20-31).

In some embodiments the cathode material can also include one or more fillers in addition to one or more hybrid inorganic-organic redox active materials herein described.

The term“filler” as used herein indicates a substance added to the electrode formulation to enhance certain properties without actively participating in the electrochemical reactions. Fillers are generally used to improve mechanical properties, thermal stability, and sometimes electrical conductivity, depending on the specific requirements of the electrode as will be understood by a skilled person.

In particular, fillers are used for i) mechanical reinforcement, as they provide additional structural support to the electrode, helping to maintain its integrity during the expansion and contraction cycles that occur during battery operation, to minimize cracking and degradation of the electrode material; ii) thermal stability, since some fillers are used to enhance the thermal stability of the electrode and an help dissipate heat generated during charging and discharging, reducing the risk of overheating and improving safety; as well as iii) electrical conductivity, since certain conductive fillers can improve the overall electrical conductivity of the electrode, ensuring efficient electron transport throughout the material. This can enhance battery performance by reducing internal resistance.

Common types of fillers comprise carbon-based filler such as i) carbon black, often used as a conductive filler to improve the electrical conductivity of electrodes. It is commonly added to both cathodes and anodes and ii) graphite which can serve as a filler to provide conductivity and structural support.

Common types of fillers further comprise inorganic fillers such as Silica (SiO₂) and Alumina (Al₂O₃ typically used to enhance mechanical strength and thermal stability, in particular in applications where high-temperature stability is required.

Common types of fillers further comprise polymer-based fillers such as polyethylene or polypropylene Particles which can be used to improve mechanical flexibility and impact resistance.

Selection of fillers for a particular electrode material can be performed in view of i) compatibility, since fillers must be compatible with other components of the electrode, including binders and active materials, to ensure they do not adversely affect the electrochemical performance; and ii) cost-effectiveness and availability which are also important considerations, especially for large-scale battery manufacturing. The proportions and amount of filler used is typically carefully controlled as excessive filler content can dilute the active material concentration, potentially reducing the overall energy density of the battery.

In some embodiments herein described, the sulfurized carbon polymer matrices (SPoly), S-linked polymer (Gen1, PAQS), COFs together with different inorganic fillers such as (LFP, or LTO, or TiS₂, or Al₂O₃) can be incorporated into functional electrodes by mixing with suitable binder and conductive additive. Mixing methods include planetary mixing and high shear mixing. Electrode coating methods include drop casting, doctor blade casting, spin coating, comma-roll coating, dry process and extrusion. In some embodiments, the composition of electrodes may vary from 50-95 wt % active material, 2-20 wt % conductive additive, 2-20 wt % electrode filler, and 1-20 wt % binder can be present with the total wt % of all species summing to 100%.

In some embodiments the hybrid redox active composite as described herein and related composite and compositions can be comprised in a cathode material, and in particular, in a cathode material configured to enable contact with a non-aqueous electrolyte of an electrochemical cells.

In some embodiments herein described, the hybrid redox active composite as described herein can be mixed with one or more binder, fillers and conductive and then coated with a support to form a cathode electrode.

The term “support” as used herein indicates the support refers to the substrate or current collector onto which an active material is applied. The support provides mechanical stability to the electrode, ensuring that the active materials remain intact and well-adhered during battery operation. The support also acts as a conductor, facilitating the flow of electrons between the external circuit and the active materials. This is functional to an efficient charge and discharge cycles. The support can also aid in dissipating heat generated during battery operation, helping to maintain optimal temperature conditions and prevent overheating.

In embodiments herein described the support is selected among materials having i) high electrical conductivity to ensure efficient electron transfer; ii) chemical stability; and in particular resistance to corrosion and chemical reactions with electrolyte or active materials; iii) mechanical strength: Should to withstand mechanical stresses during battery assembly and operation without deforming, and iv) weight to contribute minimally to the overall weight of the battery, which is important for applications like electric vehicles.

Common materials that can be used as a substrate for support comprise metal foils such as copper foils used for as the support for anodes, especially in lithium-ion batteries with graphite or silicon-based anodes, aluminum foils used as the support for cathodes due to its good conductivity, low cost, and ability to form a strong bond with cathode materials like lithium cobalt oxide or nickel manganese cobalt oxide, Stainless Steel Sometimes used for specific applications where additional strength or corrosion resistance is desired and others identifiable by a skilled person.

In embodiments herein described support material are chosen in view of desired the battery's performance, durability, and safety. Manufacturers select materials based on specific application requirements, balancing factors like cost, weight, conductivity, and chemical compatibility as will be understood by a skilled person.

In some embodiments a substrate that can be used in electrodes herein described can comprise a metal foil such as aluminum foil, which serves as the current collector (see Examples 20-31).

In some embodiments, a cathode electrode comprising one or more inorganic-organic redox active materials herein described can be comprised within an electrochemical cell(s) comprising an anode, a cathode, and a separator.

In particular in some embodiments, the electrochemical cell comprises an anode, a cathode, and a non-aqueous electrolyte, wherein the cathode electrode comprises a cathode material described herein.

The term “cathode material” as used herein indicates the substance within the cathode electrode that comprises the redox active components. It is the material that accepts electrons from the external circuit and undergoes reduction during the discharge of an electrochemical cell. In embodiments herein described, the cathode material comprises the composite of the instant disclosure.

The wording, “anode active material” as used herein indicates the component within the anode electrode that actively participates in the electrochemical reactions of a battery. It is the substance that undergoes reversible oxidation during discharge, releasing electrons to the external circuit and ions into the electrolyte. This material is distinct from the inactive components of the electrode, such as binders, conductive additives, and the current collector, which provide structural support and facilitate electron transport but do not store energy themselves. Exemplary anode active materials can include a variety of substances, such as alkali metals like lithium, sodium, and potassium; carbon-based materials such as graphite and hard carbon; and other materials like silicon and phosphorus.

In embodiments, herein described the anode material is an alkali ion anode material, which is the redox active substance within the negative electrode of a rechargeable battery that is capable of storing and releasing alkali metal ions, such as lithium, sodium, or potassium ions, during the charge and discharge cycles of the cell. This material functions as a host structure that allows for the reversible insertion of alkali ions during charging, a process known as intercalation, and the subsequent extraction of those ions during discharging. The choice of anode material is to battery performance and varies depending on the specific alkali ion. For lithium-ion batteries, graphite is a commonly used anode material, while silicon and silicon-graphite composites are employed for higher energy density applications. For sodium-ion and potassium-ion batteries, which utilize larger ions, hard carbon is often a preferred anode material due to its more accommodating disordered structure. In certain configurations, the anode active material can also consist of a pure alkali metal, such as a lithium or sodium metal foil, which offers the highest theoretical energy density.

In preferred embodiments, the anode comprises lithium anode material, or potassium anode material, or sodium anode material or hard carbon or silicon, or silicon-graphite, or a combination thereof as will be understood by a skilled person.

In some embodiments, the alkali ion anode material comprise material in their lithiated or sodiated forms. For instance, the anode can be an in situ lithiated graphite electrode, where graphite is pre-loaded with lithium to create a safer and more stable anode with enhanced cycling stability. The wording “lithiated graphite (LiC₆)” is defined as the material when graphite electrode was pre-lithiated with lithium ions either in solution phase or in solid phase via in situ insertion of thin lithium foil on top of the graphite electrode. Lithiated graphite provides a safer and more stable lithium source and cycling stability over many thousands of cycles.

In some embodiments, the anode can be an in situ sodiated hard carbon electrode, where hard carbon is pre-loaded with sodium to create a safer and more stable anode with enhanced cycling stability. The wording “sodiated hard carbon” refers to a hard carbon anode material that has been pre-loaded with sodium ions (Na+) before the battery's first use. This pre-sodiation process can be performed in several ways, such as by soaking the electrode in a sodium-containing solution (solution phase) or by placing a thin sodium metal foil directly onto the hard carbon electrode within the cell, allowing the sodium to insert itself in situ (solid phase). Accordingly, as the sodiated hard carbon encompass material when hard carbon electrode was pre-sodiated with sodium ions either in solution phase or in solid phase via in situ insertion of thin sodium foil on top of the hard carbon electrode. Sodiated hard carbon provides a safer and more stable sodium source and cycling stability over many thousands of cycles as will be understood by a skilled person.

In some embodiments, silicon, or silicon-graphite, or in situ lithiated silicon or in situ lithiated silicon-graphite was used an anode active material. Lithiated silicon or silicon-graphite is defined as when silicon or silicon-graphite electrode was pre-lithiated with lithium ions either in solution phase or in solid phase via in situ insertion of thin lithium foil on top of the silicon electrode, or silicon-graphite. Lithiated silicon or silicon-graphite provides a safer and more stable lithium source and cycling stability over many thousands of cycles.

In some embodiments of electrochemical cells of the disclosure, the cell further include an anode comprising as redox active materials. Exemplary redox active material for anodes of electrochemical cells herein described comprise metallic lithium in the form of lithium foil, powdered lithium, lithium deposited onto a conducting or non-conducting substrate, such copper foil, lithium alloys such as, lithium-aluminum alloys, lithium-tin alloys, lithium-magnesium-copper alloys, graphite, hard carbon, lithiated graphite, in situ lithiated graphite, lithium deposited on to graphite layer, and other carbon composite, carbon nano tubes, carbon nano fibers, sodium metal, potassium metal and additional anode materials identifiable by a skilled person In some embodiments, anodes can be coated with non-redox active polymers to prevent dendrite formation during cycling.

In some embodiments, the cathode material as described comprises lithium and sodium in a molar ratio of Li to Na ranging from 1:10 to 10:1, 4:6 to 6:4, or being 1:1.

In some embodiments, the cathode material as described comprises lithium and potassium in a molar ratio of Li to K ranging from 1:10 to 10:1, 4:6 to 6:4, or being 1:1.

In some embodiments, the cathode material as described comprises sodium and potassium in a molar ratio of Na to K ranging from 1:10 to 10:1, 4:6 to 6:4, or being 1:1.

In some embodiments, combinations of one or more inorganic additives with one or more organic redox active material in accordance with the disclosure can be screened according to screening method to select a hybrid organic-inorganic redox active material of the disclosure to be used in cathodes having a set discharge capacity and/or cyclability.

In those embodiments, given a set organic redox active material the method comprises providing a testing cathode material in which the set organic redox active material is combined with a candidate inorganic additive in accordance with the present disclosure. The method further comprises detecting at least one of discharge capacity specific energy volumetric energy density and cyclability of the testing cathode material and selecting the candidate inorganic additive when the testing cathode material has at least one of a detected discharge capacity higher than a set threshold, a detected specific energy volumetric higher than a set threshold, a detected energy density higher than a set threshold and a detected cyclability higher than a set threshold.

The term “discharge capacity” as used herein refers to the capability of a battery to deliver electrical energy in ampere-hours (Ah) or milliampere-hours (mAh) over a specified time per unit mass of active material. The discharge capacity also referred as “specific capacity”, is typically denoted as mAh/g. It is one of the key metrics used to evaluate the performance of a battery material, indicating how much energy can be delivered by each gram of active material. A higher discharge capacity indicates a more efficient energy storage material.

The term “cycle life” of a battery as used herein refers to the number of complete charge-discharge cycles a battery can undergo before its capacity falls below certain percentage of its original value, typically 80%. It is an important measure of the battery's longevity and durability. The ‘80% capacity retention’ means that the battery retains 80% of its original energy (mAh/g) after certain number of discharge-charge cycles. It is commonly used as a benchmark to determine the end of a battery's useful life. An 80% capacity retention up to 200 cycles means that the battery retains 80% of its original capacity after repeated charge and discharge up to 200 times.

The term “specific energy” as used herein refers as gravimetric energy density. It is a measure of the amount of energy a battery can store per unit mass of that battery. It is typically expressed as watt-hours per kilogram (Wh/kg). Specific energy is one of the key factors in determining the overall energy of a battery. Higher specific energy battery means that, that battery can store more energy per unit mass, making it more efficient for energy-intensive applications where weight is critical such as electric vehicles, and portable electronics, and additional applications identifiable by a skilled person.

The wording “volumetric energy density” a used herein indicates: the amount of energy stored in a battery per unit volume. It is typically measured in watt-hours per liter (Wh/L). Volumetric energy density is one of the key factors in determining the overall energy of a battery compared to its physical size (volume) as will be understood by a skilled person. A higher volumetric energy density battery means that, more energy can be stored in a smaller space of that battery. It is an important factor for applications where space is limited, such as portable electronics and electric vehicles as will be understood by a skilled person.

The screening method can be used to select optimized combination of organic-inorganic material, (e. g. different inorganic material, or same inorganic material, having same or different shapes, sizes and surfaces areas) with one or more organic redox active material (e.g. SPoly or other matrices alone or in combination with redox active polymers).

The screening method can also be used to select optimized ratios, inorganic-organic material, optimized sizes and surface area of the inorganic additive as well as other feature of the hybrid organic-inorganic redox active material of the disclosure, in connection with cathode having one or more desired properties.

In preferred embodiments, the method can be made more time and/or cost effective by including one or more additional screening step directed to exclude candidate inorganic additive which react with a set organic redox active material and/or electrolyte thus affecting the structural integrity of resulting in a cathode material.

The one or more screening step can be performed testing the viscosity of a hybrid composite obtained by mixing the candidate inorganic additive with the organic redox active material, and detecting any viscosity increase, making materials thicker and more resistant to flow to exclude candidate inorganic additive that result in a viscosity increase impacting the material capability to form a functional electrode.

In some of those embodiments, a set threshold of viscosity can be identified and the testing step of the hybrid composite comprising the candidate inorganic additive can be performed to select candidates that are above the set threshold of viscosity (to be established based on the feature of the electrode) and discard the inorganic additive that are below or above the set threshold. [6] The one or more screening steps can be performed by detecting stability of the resulting material, since the reactivity of an inorganic additive can result in aggregation which in turn can destabilize materials, leading to phase separation or sedimentation.

In other preferred embodiments, the method can also be made more time/cost effective by including a further screening step in asserting the electrode packing density and eliminate candidates that does not fall within a range of set values. This is expected to make the screening more effective by testing cyclability of a more restricted set of candidates.

In embodiments of the disclosure where additional screening steps are comprised to preselect the cathode material comprising the combination of inorganic additive and organic redox active material which can provide a desired discharge capacity specific energy volumetric energy density and/or cyclability of the testing cathode material.

In embodiments herein described the hybrid organic-inorganic redox active composite material herein described and/or related compositions and/or composite material of the disclosure can be comprised within an electrochemical cell.

As used herein, an “electrochemical cell” refers to a device capable of generating electrical energy by chemical reaction, or a device capable of using electrical energy to drive a chemical reaction, or both.

The electrochemical cells which generate an electric current are called voltaic cells or galvanic cells and those that generate chemical reactions, via electrolysis for example, are called electrolytic cells.

In particular voltaic cell (galvanic cell) is an electrochemical cell that generates electrical energy through redox (reduction-oxidation) reactions in the cell. An electrochemical cell can also use externally applied electrical energy to drive a redox reaction within the cell, referred to as an electrolytic cell. A fuel cell is an electrochemical cell that generates electrical energy from a fuel through electrochemical reaction of hydrogen with an oxidizing agent.

A voltaic cell or a redox generating electrochemical cell can include a permeable barrier between the two electrodes that allow anions and/or cations to pass from the electrolyte in contact with one electrode to the electrolyte in contact with the other electrode.

As used herein, “electrode” refers to an electrically conductive material that makes contact with a non-conductive element. In the case of an electrochemical cell, the non-conductive element is an electrolyte where the chemical reactions occur. The two types of electrodes in cell are the anode and cathode. The anode is the electrode where electrons leave the electrochemical cell and where oxidation occurs. The cathode is the electrode where electrons enter the cell and where reduction occurs. By convention, anodes are considered “negative” and cathodes are considered “positive” when producing electrical energy. When the cell is using electrical energy to drive a reaction (e.g., when a rechargeable battery is charging), then the cathode is negative with respect to the anode's polarity and the convention is usually (but not always) reversed. A cell can change between energy producing (voltaic) and redox producing (electrolytic) by changing the externally applied voltage between the electrodes (changing the direction of the current through the cell).

An “electric current” or “electrical current” by the sense of the description can be described as a flow of positive charges or as an equal flow of negative charges in the opposite direction. Electrical current, by convention, goes from cathode to anode (the opposite of the flow of electrons) outside the cell, regardless of method of operation (voltaic vs. electrolytic).

The electrochemical cell as described herein can contain a cathode on a metal substrate with current collector and an anode on a metal substrate with current collector which are separated by a semipermeable insulative membrane. The cell contains a non-aqueous salt solution that conducts ions. These components are placed within a container.

Any of the cathode or anode can comprise the redox active composition as described herein.

In particular in some embodiments, an electrochemical cell is described comprising an anode, a cathode and a non-aqueous electrolyte, wherein the anode electrode comprises the hybrid organic-inorganic redox active composite material herein described related composites and/or compositions.

As used herein, “electrolyte” refers to a liquid or mixture of liquid and solid that contains at least a cation and a counterion for conducting ions during an electrochemical reaction in an electrochemical cell. In some embodiments as described herein, the cation of the electrolyte can be lithium ion.

The electrolyte as described herein can have a mixture of a cyclic carbonate of ethylene carbonate (EC) or mono-fluoroethylene carbonate (FEC) co-solvent, ethyl methyl carbonate (EMC), a flame-retardant additive, a lithium salt, and an electrolyte additive that improves compatibility and performance of the lithium-ion battery.

The lithium salt of the electrolyte as described herein can be selected from the group consisting of lithium hexafluorophosphate (LiPF₆), lithium tetrafluoroborate (LiBF₄), lithium bis(oxalato)borate (LiBOB), lithium hexafluoroarsenate (LiAsF₆), lithium perchlorate (LiClO₄), lithium trifluoromethanesulfonate (LiCF₃SO₃), lithium bistrifluoromethanesulfonate sulfonyl imide (LiN(SO₂CF₃)₂), LiFSI and mixtures thereof.

The electrolyte additive as described herein can include lithiumbis(oxalato)borate (LiBOB), lithium difluoro(oxalato)borate (LiODFB), lithium tetrafluorooxalatophosphate (LiPF₄(C₂O₄)), and mixtures thereof.

The flame-retardant additive of the electrolyte as described herein can selected from the group consisting of triphenyl phosphate (TPhPh/TPP/TPPa), tributyl phosphate (TBP/TBuPh), triethyl phosphate (TEP/TEtPh), bis(2,2,2-trifluoroethyl)methyl phosphonate (BTFEMP/TFMPo), tris(2,2,2-trifluoroethyl) phosphate, diethyl ethylphosphonate, diethyl phenylphosphonate, and mixtures thereof.

In some embodiments of an electrochemical cell of the disclosure, redox active monomeric moiety contains thiophene or anthraquinone and the electrolyte was 1.0 M LiPF₆ in EC:DEC (50:50 v/v). EC and DEC refer to ethylene carbonate and diethyl carbonate respectively.

In an alternative embodiment, these electrochemical cells can feature non-aqueous electrolytes including organic solvents such as propylene carbonate, ethylene carbonate, dialkyl carbonate, DME, Dioxolanes, ethers, fluorinated ethers, glymes, acetonitrile, alongside one or more salts of lithium, sodium and/or potassium such as lithium hexafluorophosphate (LiPF₆), lithium hexafluoroarsenate (LiAsF₆), lithium perchlorate (LiClO₄), lithium tetrafluoroborate (LiBF₄), lithium trifluoromethanesulfonate (LiCF₃SO₃), lithium trifluoroacetate (LiCF₃CO₂), lithium tetrachloroaluminate (LiAlCl₄), lithium bis(trifluoromethanesulfonyl)imide (Li[CF₃SO₂]₂N, LiTFSI), lithium bis(fluorosulfonyl)imide (Li[FSO₂]₂N, LiFSI), lithium bis(oxalato)borate (Li[C₂O₄]₂B, LiBOB), lithium iodide (LiI), lithium bromide (LiBr), lithium chloride (LiCl) and lithium fluoride (LiF) at concentrations from 0.01-1 M, for example. In particular, the electrodes as described in this disclosure may function as the cathode in such non-aqueous cells, and low-potential metallic or alloy species such as lithium metal, lithiated graphite, lithium-silicon alloy, magnesium or sodium or potassium as the anode.

In such non-aqueous cell embodiments as described above where Li metal features as the anode, the open circuit voltage of the cell (and, hence, the relative potential of the cathode vs. Li⁺/Li) can be 2.0-3.5 V.

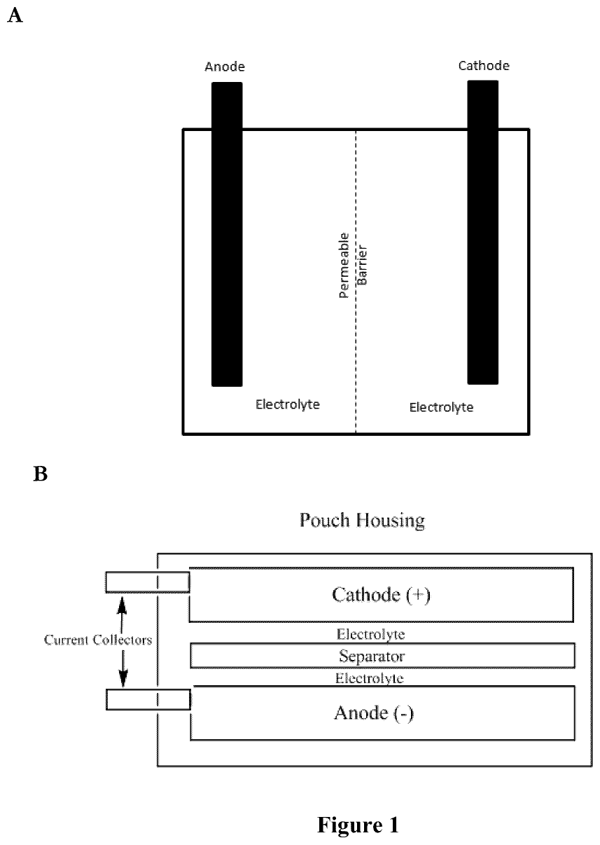

Schematic illustration of possible configuration of electrochemical cells are illustrated in FIG. 1.

In particular FIG. 1 top panel shows an exemplary electrochemical cell including an anode, a cathode and an electrolyte disposed between the anode and cathode with an optional permeable barrier dividing the electrolyte into two ionically communicative portions. FIG. 1 bottom panel shows an exemplary electrochemical cell in a pouch housing including an anode, a cathode and their respective current collectors and an electrolyte disposed between the anode and cathode with an optional separator dividing the electrolyte into two ionically communicative portions. In some embodiments, of the present disclosure one or more electrochemical cells can be comprised within a battery.

As used herein, a “battery” is a device consisting of one or more electrical energy generating electrochemical cells arranged in parallel (for increased capacity) or serial (for increased voltage). Battery types include redox active polymer-metal, zinc-carbon, alkaline, nickel-oxyhydroxide, lithium, mercury oxide, zinc-air, Zamboni pile, silver-oxide, magnesium, nickel-cadmium, lead-acid, nickel-metal hydride, nickel-zinc, silver-zinc, lithium-iron-phosphate, lithium ion, and others as could be understood by a skilled person.

In particular, a battery according to this disclosure can include one or more electrochemical cells as described herein and may additionally include a first electrode coupled to an anode of the one or more electrochemical cells, a second electrode coupled to a cathode of the one or more electrochemical cells, and a casing or housing encasing the one or more electrochemical cells.

In some embodiments a battery in the sense of disclosure consists of one or more electrochemical cells, connected either in parallel, series or series-and-parallel pattern. In some embodiments, the battery can include a plurality of electrochemical cells can be linked in series or parallel based on performance demands including voltage requirement, capacity requirement.

In some embodiments, electrochemical cell as described can be electrically connected in series to increase voltage of the battery thereof.

In some embodiments, electrochemical cell as described can be electrically connected in parallel to increase charge capacity of the battery thereof.

In some embodiments, the battery as described herein can take a shape of a pouch, prismatic, cylindrical, coin.

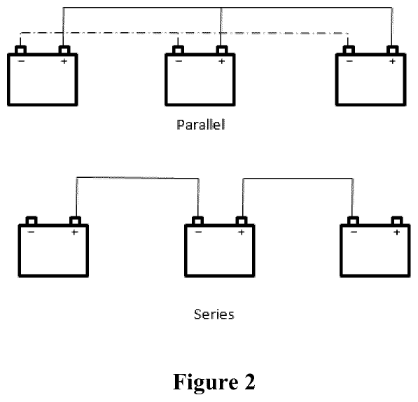

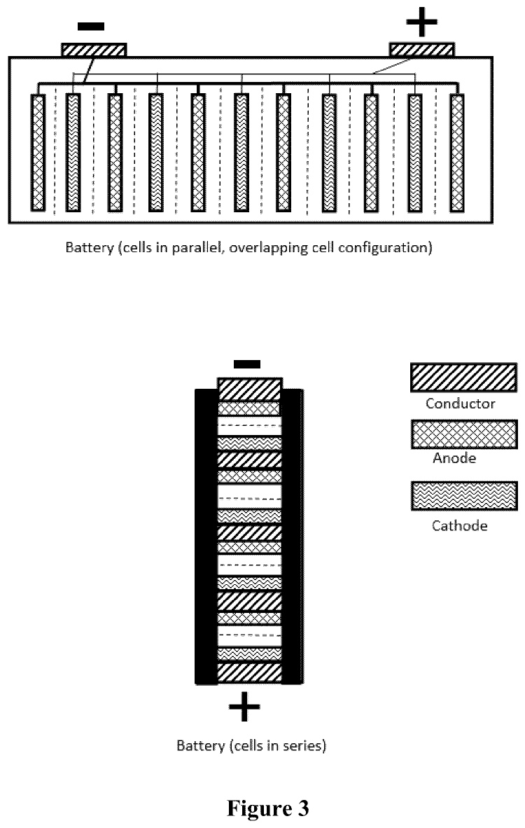

A schematic illustration of the arrangement of the electrochemical cells in a batter of the disclosure is illustrated in FIGS. 2 and 3.

FIG. 2 shows exemplary arrangement of a plurality of electrochemical cells in a battery. The top panel of FIG. 2 shows a plurality of electrically connected electrochemical cells that electrically connected in parallel, whereas the bottom panel of FIG. 2 shows a plurality of electrically connected electrochemical cells that electrically connected in series. A battery of three cells connected in parallel has a capacity of three times that of the individual cell. A battery of three cells connected in series has a voltage of three times that of the individual cell.

The top panel of FIG. 3 shows a plurality of electrically connected electrochemical cells that electrically connected in parallel in an overlapping configuration, whereas the bottom panel of FIG. 3 shows a plurality of electrically connected electrochemical cells that electrically connected in series.

The battery can be configured as a primary battery, wherein the electrochemical reaction between the anode and cathode is substantially irreversible or as a secondary battery, wherein the electrochemical reactions between the anode and cathode are substantially reversible.

Battery comprising S-linked quinone polymers, electrode materials, electrode and electrochemical cells of the disclosure are long life battery. A used herein, a long life for a battery indicates a battery that can charge/discharge for over 1,000 cycles, while retaining 70% of charge capacity. In some embodiments, a battery as described herein can have a lifetime of at least four years. In some embodiments, a battery as described herein can have charge/discharge for over 1,200 cycles, while retaining 70% or 80% of the initial discharge capacity.

S-linked polymers herein described sulfurized matrices herein described and related composites electrode materials and/or electrodes to be included in electrochemical cells and batteries in accordance with the present disclosure can be provided according to methods identifiable by a skilled person upon reading of the present disclosure.

The hybrid organic-inorganic redox active composite material redox compositions, redox composites, and related components, electrode material, electrodes and electrochemical cells can be comprised in systems in which the inorganic additive, the organic redox active material, additional compounds such as solvents, additives such as binders and fillers, related compositions composites electrode material, electrodes and/or electrochemical cells are comprised in various combinations wherein they are interconnected in configurations in which they work together as parts of mechanism and/or interconnecting network according to methods herein described.

In some embodiments, systems for making an a cathode material here described comprises at least one hybrid organic-inorganic redox active composite material herein described optionally together with an additive such as a binder, conductive additive or filler, for combined use to provide a cathode material according to the seventh aspect herein described.

In some embodiments, systems for making an cathode comprises at least one hybrid organic-inorganic redox active composite material herein described and a conductive additive according to the eighth aspect of herein described.

In some embodiments, systems for making a cathode comprises at least one hybrid organic-inorganic redox active composite material, one or more conductive additive and a binder to provide a robust cathode according to the 9th aspect of herein described.

In some embodiments, systems for making a cathode comprises at least one hybrid organic-inorganic redox active composite material herein described and a current collector optionally together with an additive for combined use to provide a cathode material according to the fourth aspect herein described.

In some embodiments, systems for making an electrochemical cell comprise at least one cathode of the present disclosure in combination with an anode a separator and an electrolyte as will be understood by a skilled person upon reading of the present disclosure.

In summary, electrode materials including the hybrid organic-inorganic redox active composite materials are described here, alongside functional electrodes incorporating such species and electrochemical cells and batteries including such electrodes. In certain embodiments, the electrode material described herein exhibits high mechanical strength and excellent processability into a functional electrode due to its unique composition. Advantageously, in certain embodiments the electrode supports battery charging and recharging for hundreds of cycles without material loss, due to the insoluble nature and, stability of these organosulfur polymer in the non-aqueous electrolytes used.

In particular, the hybrid organic-inorganic redox active composite material, and related compositions, composites, electrode materials, electrodes, electrochemical cells as well as related methods and systems can be used in connection with applications wherein the demand for high energy, high performance, safe and long-lasting batteries is growing rapidly due for example to environmental concerns among other things.

The hybrid organic-inorganic redox active composite material and related compositions, composites, electrode materials, electrodes, electrochemical cells as well as related methods and systems can be used in connection with lithium-ion battery technology with various cathodes such as NMC, LFP, LMO, NCA which are currently widely applied in the electric vehicular applications.

In this connection in some embodiments the hybrid organic-inorganic redox active composite material, and related compositions, composites, electrode materials, electrodes, electrochemical cells as well as related methods and systems can be used in connection with Li anode in place of inorganic cathodes which can be preferred for example in view of the price of Li-ion battery technologies which has dropped consistently over the past 30 years due to the adoption of improved processing and manufacturing practices, In particular, in those embodiments S-linked quinone polymers herein described such as PAQT and 36PPAQS, 27PPAQS are expected improve the overall capacity and performance of the battery, and composite cathodes of hybrid mixtures of various proportions of PAQS, PAQT, 36PPAQS, 27PPAQS, PBQS, COFs and various sulfurized carbon matrix polymers such as SPoly.

In some embodiments, the mixing, wetting, and coating of organic-inorganic materials are superior than organic active materials alone in terms of ease of processibility. The organic-inorganic hybrid materials can provide better electrodes properties. The electrochemical cells with organic-inorganic hybrid redox active cathode materials can provide a batteries having longer cycle life than sulfurized carbon matrices alone. In some embodiments, the inorganic materials with redox activity can provide additional capacities when the cells were cycled within certain voltage ranges.

For example a cathode with sulfurized carbon matrix (e.g. SPoly) with density 1.3 g/cm³ gave the discharge capacity of 600 mAh/g at C/10. The same material when mixed with an inorganic additive with a 9:1 (or 91:9), weight ratio, the discharge capacity increased to 740 mAh/g (SPoly:LTO, 9:1 or 91:9, weight ratio ratio). Therefore, the representative examples here described demonstrate that in certain aspects the hybrid material of the present disclosure can increase the practical discharge capacity by 20% or more. The above results support the conclusion that improved properties are expected for an electrode material comprising sulfurized carbon matrix (in particular SPoly) and an inorganic additive in a weight ratio ranging from 75:25 to 98:2 and from 90:10 to 92:8 as will be understood by a skilled person upon reading of the present disclosure

Further details concerning the hybrid organic-inorganic redox active composite material and related composition electrochemical cells, batteries methods and systems including generally manufacturing and packaging of the organosulfur polymer compositions, electrochemical cells and/or the battery, can be identified by the person skilled in the art upon reading of the present disclosure.

### EXAMPLES

The hybrid organic-inorganic redox active material and related composites, compositions, electrode material, electrodes electrochemical cells, batteries, as well as related methods and systems herein described are further illustrated in the following examples, which are provided by way of illustration and are not intended to be limiting.

A skilled person will be able to identify additional the hybrid organic-inorganic redox active material and related composites, compositions, electrode material, electrodes electrochemical cells, batteries, methods and systems herein described in view of the content of the present disclosure. The following specific examples are given to illustrate the practice of the invention, but are not to be considered as limiting the invention in any way.

In particular, exemplary inorganic material, organic redox active material, composites, metals and related electrode material, electrodes, devices, compositions, methods and systems, are described in connection with specific experimental tests and procedures. A skilled person will be able to understand and identify the modifications required to adapt the results illustrated in the exemplary embodiments of this sections to additional embodiments of organosulfur polymer, and related electrodes, devices, compositions, methods and systems in accordance with the present disclosure.

As will be appreciated from the Examples herein described, the features and performance of these organosulfur polymer, herein described support their use as organic electrode materials suitable for a wide range of primary or rechargeable applications, such as batteries for electric vehicles, stationary batteries for emergency power, local energy storage, starter or ignition, remote relay stations, communication base stations, uninterruptible power supplies (UPS), spinning reserve, peak shaving, or load leveling, or other electric grid electric storage or optimization applications. Small format or miniature battery applications including watch batteries, implanted medical device batteries, or sensing and monitoring system batteries (including gas or electric metering) are contemplated, as are other portable applications such as flashlights, toys, power tools, portable radio and television, mobile phones, camcorders, lap-top, tablet or hand-held computers, portable instruments, cordless devices, wireless peripherals, or emergency beacons. Military or extreme environment applications, including use in satellites, munitions, robots, unmanned aerial vehicles, or for military emergency power or communications are also possible.

The following materials and methods were used for all compounds and their precursors exemplified herein.

The various molecular weights of polyacrylonitriles (MW=50,000, 80,000, 120,000, 150,000, 200,000, 250,000) were purchased from Sigma-Aldrich, Scientific Polymer Products Inc, Polymer Science, Inc. The co-polymers of various molecular weights such as poly(acrylonitrile-co-methacrylate), poly(acrylonitrile-co-vinyl acid) were purchased from Polymer Science, Inc.

All the polymers used in the reaction as received. Lithium iron phosphate (LFP) and Lithium titanate (LTO) were purchased from MTI corporation. Titanium sulfide was purchased from Sigma-Aldrich. Al₂O₃ was purchased from Fisher Scientific. Elemental sulfur was purchased from Sigma-Aldrich.

In particular, the LFP had an average size of 6 um (D90 value); an average surface area of 10 m²/g; and an average density of 3.6 g/cm³, the LTO particles had an average size of 3 um (D90 value); an average surface area 16 m²/g; and an average density 3.4 g/cm³, the TiS₂ particles had an average size of 60 um (D90 value); an average surface area 1 m²/g; and an average density 3.2 g/cm³ the Al₂O₃ particles had an average size of 1 um (D90 value); an average surface area 40 m²/g; and an average density 4.0 g/cm³.

### Example 1: Use of Inorganic Material to Increase Gravimetric Energy Volumetric Energy and Life Cycle of Electrode Material Comprising Sulfurized Carbon Matrices

Sulfurized carbon matrix polymer (SPoly) representative example of sulfurized carbon matrices here described. SPoly is an organic polymer composed of carbon, hydrogen, nitrogen and sulfur. Without wanting to be bound by theory, SPoly has a low bulk density due to its large irregular chain-like structure. Unlike small, rigid inorganic materials that can align closely and pack tightly, SPoly is a long-chain flexible polymer that leads to a less orderly packing and increased void spaces between moieties in the solid state. The amorphous nature of SPoly further reduces its overall packing density. Due to the low density of the SPoly, it remains a challenge to fabricate an SPoly electrode having high electrode packing density (>1.0 g/cm³). Therefore, it is a great challenge to assemble SPoly batteries having a high specific energy (Wh/kg), high energy density (Wh/L) and long cycle life for practical applications. The main parameters of an SPoly electrode that determine the gravimetric (Wh/kg) and volumetric energies (Wh/L) are the electrode packing density (g/cm³) and areal capacity loading (mAh/cm²).

The inventors have surprisingly found that inorganic material can be used to increase gravimetric (Wh/kg) and volumetric energies (Wh/L) while also increasing the life cycle of electrodes comprising sulfurized carbon matrices.

Inorganic materials often have high densities due to their rigid, non-porous, crystalline structures and the inherent density of the elements they contain. The crystal lattice structure of inorganic materials is highly stable, which allows atoms to be closely packed together resulting high density materials.

The inventors have found that a inorganic material with a selected density can be added in selected ratios as additives to SPoly powder to fabricate an ‘organic-inorganic hybrid cathode active material which can increase the overall packing density of the electrode and achieve high areal capacity loading for assembling high energy practical rechargeable batteries.

The following examples illustrate the features and properties of exemplary hybrid organic-inorganic material of the disclosure where the sulfurized carbon matrix is SPoly and the related components are exemplary inorganic materials.

### Example 2 Inorganic Material Improves the Packing Density of the Electrode

SPoly is a low-density (<1.0 g/cm³) porous polymeric material which contains carbon, hydrogen, nitrogen and sulfur. When compressed using high pressure to improve the packing density of the electrode greater than 1.2 g/cm³, the porosity of the cathode decreases catastrophically under such high pressure due to fact that the pores in the electrode structure are physically compressed or eliminated.

The porous nature of the structure of the cathode plays an important role providing pathways for electrolyte ions to transport between anode and cathode as will be understood by a skilled person.

A zero- or low-porosity cathode leads to limited electrolyte access throughout the electrode, which leads to a significant reduction in surface area available for electrochemical reactions, which in turn severely limits the active material utilization.

These are factors that result in the significant reduction in overall performance of a high-density SPoly organic cathode such as the low observed discharge capacity (mAh/g), poor ion transport and consequent poor cyclability.

The inventors have obtained data which support the conclusion that a hybrid organic-inorganic material obtained by adding SPoly to an inorganic material having a density higher than SPoly, in ratios sulfurized carbon matrix: inorganic additive ranging from 3:1 to 49:1 in accordance to the present disclosure is be able to address and improve the performance of SPoly.

The inorganic additive particles dispersed throughout SPoly material during the mixing and coating process. Even when compressed at high applied pressure to densify the electrode greater than 1.2 g/cm³, in view of the data obtained the inorganic particles are expected to impart a spatial microporous structure within the electrode without collapsing the overall cathode structure, unlike when SPoly electrode is treated on its own.

High density electrodes featuring organic-inorganic hybrid material in accordance with the disclosure are known or expected to have the following improved features compared to electrodes comprising SPoly alone.

Higher Discharge capacity (mAh/g): Without wishing to be bound by theory, the organic-inorganic hybrid electrode described with high packing density (>1.2 g/cm³) is expected to have a microporous structure throughout the electrode, which creates a percolation network for the electrolyte to move freely and wet the electrode sufficiently. This improved electrolyte wetting is expected to create a high effective surface area for electrochemical reaction to occur, resulting in better kinetics during the discharge process, which leads to higher overall specific capacity (mAh/g). Moreover, such hybrid cathode delivers superior active material utilization with electrode packing density up to 2.0 g/cm³ compared to a cathode with SPoly alone.

Higher Energy Metrics: Higher cathode density directly impacts the volumetric energy density (Wh/L) of the battery, which is crucial for applications where space is limited, such as electric vehicles and portable electronics. The high density electrode comprising our organic-inorganic hybrid material contains more active material in a given volume, resulting in a higher capacity per unit volume. Similarly, this high density cathode correlates to more active material in a smaller space (volume), which results a small amount of electrolyte necessary for performance; we refer to this scenario as a ‘lean electrolyte’ (<2 g/Ah) condition which is sufficient to wet the whole electrode. The weight of electrolyte used is almost directly proportional to the specific energy (Wh/kg) of the battery. As a result, a highly-dense electrode comprising our organic-inorganic hybrid material leads to a higher specific energy (Wh/kg) battery.

Higher Cycle Life: The high density of electrodes comprising our organic-inorganic hybrid material helps to maintain the structural integrity of the electrode during the cycling, which leads to higher capacity retention at a high cycle number. In particular hybrid material of the present disclosure are known or expected to have a higher life cycle compared to the life cycle of the sulfurized carbon matrix without those additives with a cyclability higher than 105 cycles. In most preferred embodiments where he inorganic additive of the disclosure is added in particles having set sizes and/or surface areas (most preferably both), the expected improvement of the cyclability of SPoly is twofold or more, with electrode material having a cyclability of 200 cycles or higher, and up to 500 cycles or higher.

### Example 3: Exemplary Inorganic Material Increasing Density and Areal Capacity with Organic Redox Active Material

The employment of ultra-thin lithium metal anode (low n/p ratio) with high loading cathode (>3 mAh/cm²) is the key to realizing high energy density rechargeable lithium metal batteries.

In the approach of the disclosure exemplified in the present section, high areal loading and density is achieved by adding inorganic material to organic redox active material to increase the specific energy (Wh/kg) and volumetric energy density (Wh/L) of a battery employe the redox active material following the addition of the inorganic material.

Inorganic materials that can be used to obtain this result comprise lithium iron phosphate (LFP), lithium titanate (LTO), TiS₂, various forms of aluminum oxide Al₂O₃, Lithium Manganese Iron Phosphate, LiMn_{0.6}Fe_{0.4}PO₄ (herein also termed as LMFP), Lithium Manganese Phosphate LiMnPO₄ (LMP), Lithium Cobalt Phosphate LiCoPO₄ (LCP), Lithium Cobalt Oxide, LiCoO₂ (herein also termed as LCO), Lithium Nickel-Manganese-Cobalt Oxide (LiNi_{0.5}Mn_{0.3}Co_{0.2}O₂) (herein also termed as NMC532), Lithium Nickel-Manganese-Cobalt Oxide (LiNi_{0.6}Mn_{0.2}Co_{0.2}O₂) (herein also NMC622), Lithium Nickel-Manganese-Cobalt Oxide (LiNi_{0.8}Mn_{0.1}Co_{0.1}O₂) (herein also termed as NMC811), MoS₂, electronically conductive TiO₂, Iron Sulfide (herein also termed as FeS₂), Lithium Vanadium Phosphate (LVP), y-type zeolites, were combined with the sulfurized carbon matrix (SPoly) to create hybrid organic-inorganic cathode materials.

In particular resulting hybrid material obtained by mixing the above inorganic material with SPoly in accordance with the present disclosure, are known or expected to have a dense (electrode packing density >1.2 g/cm³) and high areal capacity loading (3 mAh/cm² or higher) cathode.

In the following examples representative organic-inorganic hybrid material are provided which were obtained by mixing LFP, LTO, TiS₂, DAAQ-TFA-COF with exemplary SPoly sulfurized carbon matrices herein also identified as SPoly alone or in combination with high density inorganic additives.

### Example 4: Exemplary SPAN-Sulfurized Carbon Matrix Representative Sulfurized Carbon Matrices of the Organic Redox Active Material

In sulfurized carbon matrices such as SPAN (sulfurized poly[acrylonitrile] herein also identified as SPoly, exhibit high capacity (>200 mAh/g from 3.0 to 0.50 V) with better cycling stability compared to standard sulfur cathodes in electrochemical cells with a lithium anode; however, the majority of the capacity is accessed at lower potentials than conventional Li/S cells so is less preferred in comparison to Li/S compositions. The overall S content in SPoly is ~25 to 50% and its capacity can vary from 400-800 mAh/g of total mass of SPoly sulfurized carbon matrix polymer typically has same features with an S content of ~25 to 50 w/w % with respect to total weight of sulfurized carbon matrix polymer and its capacity can vary from 400-800 mAh/g of total mass of polymer as will be understood by a skilled person.

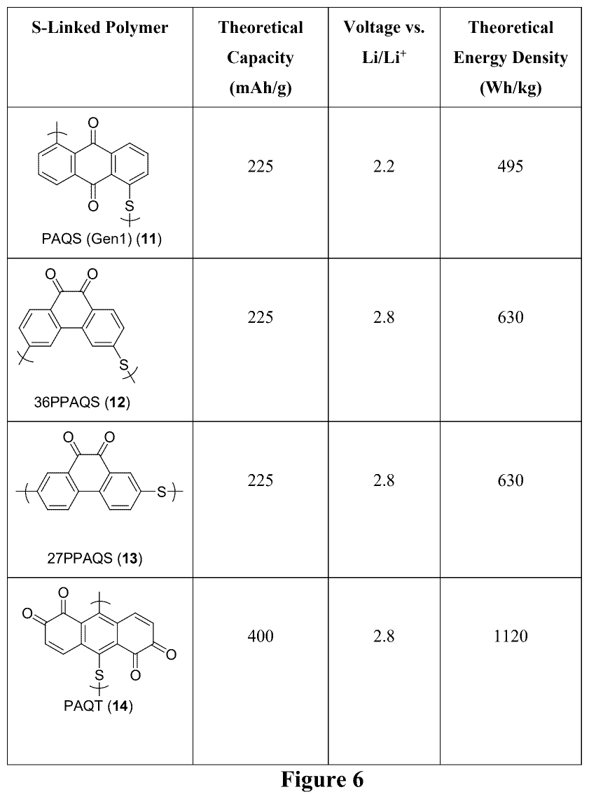

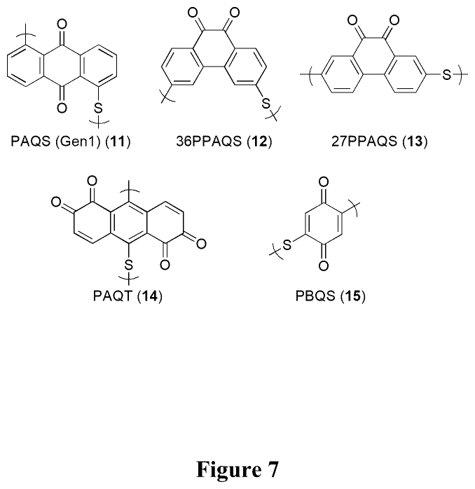

In particular, embodiments of the disclosure typically use either high sulfur content polymer or sulfurized carbon matrices (as shown in FIG. 4) as one of the components to S-linked quinone polymer (FIGS. 6 and 7). The redox potential properties of these sulfurized carbon matrices are slightly below but are in close proximity to the quinone based sulfide (—S—) polymers. The high sulfur content of the sulfurized carbon matrices described in this disclosure are n-type and possessed the redox potential range from 1.0 V to 2.5V or 1.0 V to 3.5 V with reference to Li/Li⁺ electrode potential under standard conditions.

FIG. 4 shows structures of sulfurized carbon matrices used as one of the components in —S-linked organic quinone polymers. The following description of the properties of the sulfurized carbon matrices of the instant disclosure will be made with reference to the representative Sulfurized carbon matrices (SPoly). The related features apply to other sulfurized carbon matrices as will be understood by a skilled person upon reading of the present disclosure.

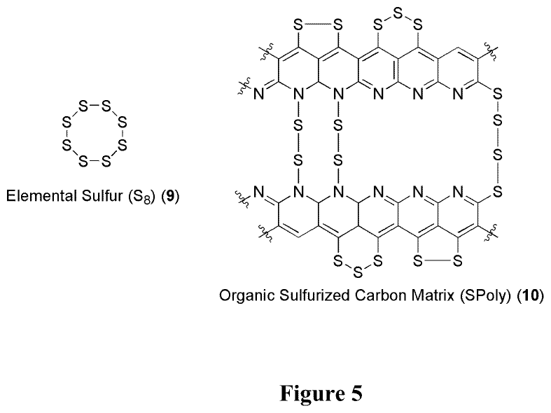

Sulfurized polyacrylonitrile (SPAN) is one such material first reported by Wang et. al. in 2002. [7] [8] [9] [10] [11] SPAN is chemically and electrochemically different than elemental sulfur and any elemental sulfur based composite cathodes. Elemental sulfur is an insulating material with an eight membered cyclic structure, whereas SPAN is a conductive material in which active sulfur is chemically embedded into the conductive matrix of the carbonized PAN polymer, as shown in FIG. 5.

FIG. 5 shows a comparison of the structures of elemental S and sulfurized polyacrylonitrile (SPAN).

Additionally, sulfur content in elemental sulfur is 100%, whereas sulfur content in SPoly varies from 30-60% depending on the synthesis. Higher the temperature for synthesis, lower the sulfur content in the polymer matrix. The synthetic procedure for the SPoly used in this disclosure is described in Example 5 The sulfur content is found to be 40-45% based on TGA and elemental analysis.

Many examples of modified SPAN and SPAN-like material are known in the literature, summarized in FIG. 4.

### Example 5: Preparation of Sulfurized Carbon Matrices Used as Organic Redox Active Material Comprising Sulfurized Carbon Matrix Polymer (SPoly)

Exemplary sulfurized carbon matrices (herein indicated as SPoly) were prepared.

Various sulfurized carbon matrices were synthesized by first mixing the powder of polyacrylonitrile polymer or copolymer of various molecular weights with elemental sulfur at mass ratios of 90:10 wt % to 10:90 wt % polymer:sulfur in a 500 mL ball-mill container. Different sizes of zirconia balls were added to the polymer:sulfur mixture. The mixture was then ball-milled at various rpm (30 rpm to 600 rpm) for 10 min to 3 hours. In some embodiments, 1 to 5 wt % of different carbon additives, carbon nanofibers, graphene, graphene oxide was added to the polymer:sulfur mixture. The mixed powers were heated under the constant flow of argon gas in a tube furnace at various isothermal temperatures ranging from 300° C. to 600° C. for various time spans ranging from 2 hours to 5 hours. A 10° C./min ramp rate was used to reach the isothermal temperature, then heated at specified temperature for isothermal heating for specified time. The reaction mixture was then cooled down to room temperature. The sulfur loading in the SPoly was found to be 10 wt % to 60 wt % depending on polymer to sulfur ratio and reaction condition applied. The sulfurized carbon matrices (SPoly) are characterized by elemental analysis and TGA analysis.

### Example 6: SPoly-PAQS Composite Material Representative of Organic Redox Active Material Comprising Sulfurized Carbon Matrix Polymer

Sulfur-linked quinone polymers such as PAQS (poly[anthraquinonyl-sulfide]) (Gen1) has a theoretical capacity of 225 mAh/g but only delivers ~160 mAh/g in usable practical cell with lithium anode at material loadings >60% active cathode (necessary for a cell with an energy density for significant commercial application), although with good cycling stability (>1000 cycles possible). Discharge potentials are typically ~2.5-2.0V vs. Li+/Li.

The combination of organosulfur polymer and sulfurized polymeric materials such as Gen1 and SPoly in a hybrid cathode material combination in accordance with the feature of the present disclosure is expected to afford an active material that exhibits both the good cycling stability of constituent Gen1 and SPoly and the combined discharge capacity of both materials. In particular mixture can offer a capacity of >250 mAh/g from 3.2-1.0V vs Li⁺/Li with cycling stability >100 cycles, for example.

In particular, exemplary organosulfur polymers known or expected to be included in the composite of the disclosure comprise are redox active polymers capable of undergoing reversible redox processes at high potential vs Li⁺/Li, increasing the overall energy density of the battery. Exemplary polymers having the above referenced properties comprise S-linked quinone polymers including 36PPAQS, 27PPAQS and PAQT. Both 36PPAQS and 27PPAQS have the capacities of 225 mAh/g, respectively, however they give a 2.8V battery when coupled with metallic lithium as anode in nonaqueous electrolytes, compared to PAQS at 2.2.V PAQT is a new polymer with theoretical capacity of 400 mAh/g, and redox potential of 2.8V vs. Li/Li⁺. Overall, the energy density of these new polymers is higher than PAQS alone, as shown in the Table of FIG. 6.

Additional exemplary organosulfur polymers usable in the composite of the disclosure comprise S-linked copolymers of two quinone moieties as cathode active materials for the use in nonaqueous rechargeable batteries. PAQS is chosen as the major component, and poly-1,4-benzoquinone sulfide (PBQS) is chosen as the minor component of the copolymers. Further exemplary organosulfur polymers comprise —S-linked copolymers such as PAQS_{0.8}BQ_{0.2} configured to increases the capacity of PAQS by 20%.

Further encompassed in the present disclosure are hybrid mixtures of S-linked quinone polymers, comprising PAQS (Gen1), and sulfurized carbon matrices, such as, SPoly. Even though nonaqueous batteries with Gen1 as cathode active material show excellent cyclability, the energy density is limited due to two carbonyl redox active centers which yield only 225 mAh/g of theoretical capacity. In this disclosure, we envisaged to add high-capacity sulfur containing polymers into Gen1 to make a hybrid mixture of cathode materials which provide higher overall capacity, and thus higher energy density batteries. In some embodiments, the energy density can be increased from 20-60% by combining 10-60 wt % sulfurized carbon matrices such as SPoly with organosulfur polymer such as Gen1 (PAQS) material. In some embodiments the energy density can be increased from 20-250% by combining 10-90 wt % of SPoly or other sulfurized carbon matrix polymers with organosulfur —S— polymer such as Gen1 (PAQS) material.

In particular, S-linked quinone polymers described in this disclosure comprise S-linked condensation polymers based on anthraquinone (AQ), phenanthrenequinone (PAQ), anthracenetetraone (AQT) and 1,4-benzoquinone (BQ), and possess a redox potential range from 1.0 V to 3.5 V with reference to Li/Li⁺ electrode potential under standard conditions. FIG. 7 shows exemplary structures of S-linked quinone polymers.

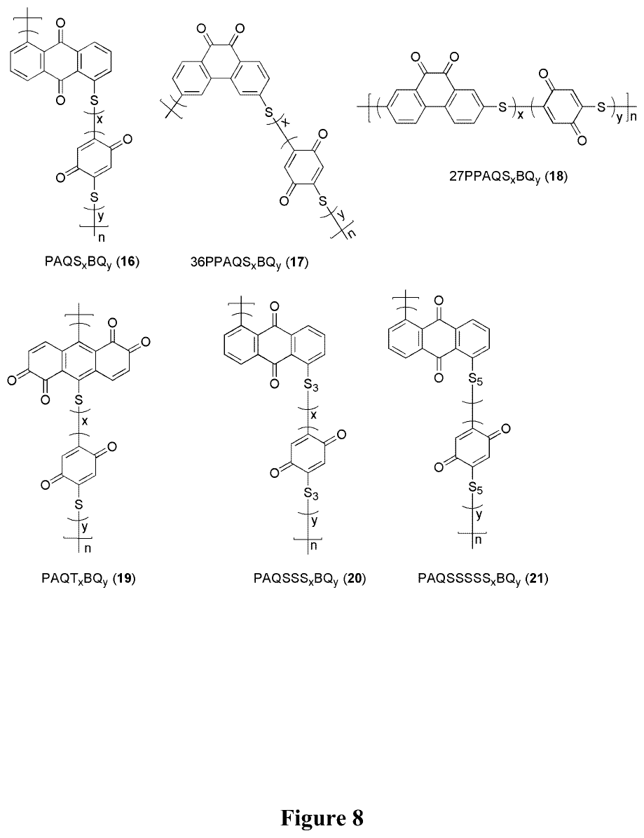

Furthermore, copolymers of sulfur-linked quinone polymers are useful and can be formed by condensation of suitable monomers with sulfur materials under typical conditions described below. For example, co-polymers of PAQS (Gen1) or PAQT and PBQS can be formed. PAQS (Gen1) is a robust polymer, which offers 1000 cycles with >80% active material but delivers only 160 mAh/g capacity at low rates. This can be improved in a series of PAQS-PBQS or copolymers (e.g. random co-polymers) by varying the ratio of monomers. We have achieved 20% improvement of capacity from PAQS by incorporating up to 20 mol % PBQS into the co-polymers (FIG. 8). Similar results can be achieved using PAQT monomer with PBQS.

FIG. 8 shows structures of the copolymers of PAQS or PAQT and PBQS covered in this disclosure.

Exemplary polymers including PAQT, 36PPAQS, and random copolymer of PAQS-PBQS are described. PAQT has higher the voltage and capacity than PAQS. PAQT has a redox voltage and a capacity of 2.80V and 400 mAh/g, respectively compared to 2.20V and 225 mAh/g in PAQS. Similarly, 36PPAQS has an improved redox voltage of 2.70V and capacity 225 mAh/g, respectively.

In the experimental data presented, found that SPAN works as co-active material with PAQS. Both SPAN and PAQS have their signature voltage profiles in the discharge-charge curves. Whereas S or S—C doesn't work as co-active material in the same electrolyte, and the signature voltage profile of PAQS is no evident during the discharge-charge profile when the battery was assembled and cycled under same conditions.

### Example 7: Preparation of SPoly-Gen1 Composite Representative of Organic Redox Active Material Comprising Sulfurized Carbon Matrix Polymer

S-linked quinone polymer (PAQS, herein also identified as Gen1) were synthesized according to scheme 1 below

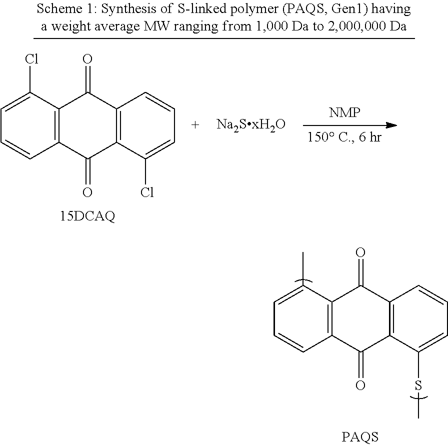

In particular, to a solution of 2,5-dichloroanthraquinone (25.00 g, 90.22 mmol) in NMP (200 mL) under argon atmosphere in a 1 L round-bottomed flask, was slowly added Na₂S·xH₂O (60%, 11.73 g, 90.22 mmol). The mixture was stirred at room temperature under argon atmosphere for 15 min, and then heated to 150° C. for 6 hours. Heating was stopped and them mixture allowed to cool to room temperature. The precipitate was then filtered off, washed with NMP, then water and then acetone.

The brown solid product of S-linked polymer, PAQS (Gen1) (22.0 g) was dried at 120° C. for overnight. The formation of S-linked polymer, PAQS (Gen1), and its purity were verified by elemental analysis and TGA analysis.

The data shows that the measured values of C, H, and S in PAQS (Gen1) is found to be 67.08%, 2.55%, and 12.95%, respectively, which corresponds to an empirical formula of C₁₄H₆S. The approximate calculated value of C, H, S is 70.57%, 2.54% and 13.43%, respectively. The measured value and calculated value are within close agreement. The TGA data of Gen1 polymer shows no mass loss up to 420° C.

### Example 8: Preparation of COF as a Component of Exemplary Organic Redox Active Material Comprising Sulfurized Carbon Matrix Polymer

Covalent Organic Frameworks (COFs) are an emerging class of crystalline porous materials constructed from organic molecules linked together by strong covalent bonds. These materials are characterized by their long-range order, high surface area, and customizable pore sizes, which make them highly versatile for various applications including batteries, energy conversion, where their well-defined structures can be functionalized to enhance the performance of electrochemical devices such as batteries, supercapacitors, and fuel cells. Due to their afore-mentioned properties, these class materials were selected to increase its density and cyclability of the SPoly cathode. A series of COF were synthesized as discussed and evaluated them as battery additive to SPoly battery materials.

Exemplary COF were prepared according to the procedure reported in Schemes 2, 3 and 4 reported below In particular, synthesis of COF-1 (DAAQ-TFP-COF):was performed with Scheme 2 below

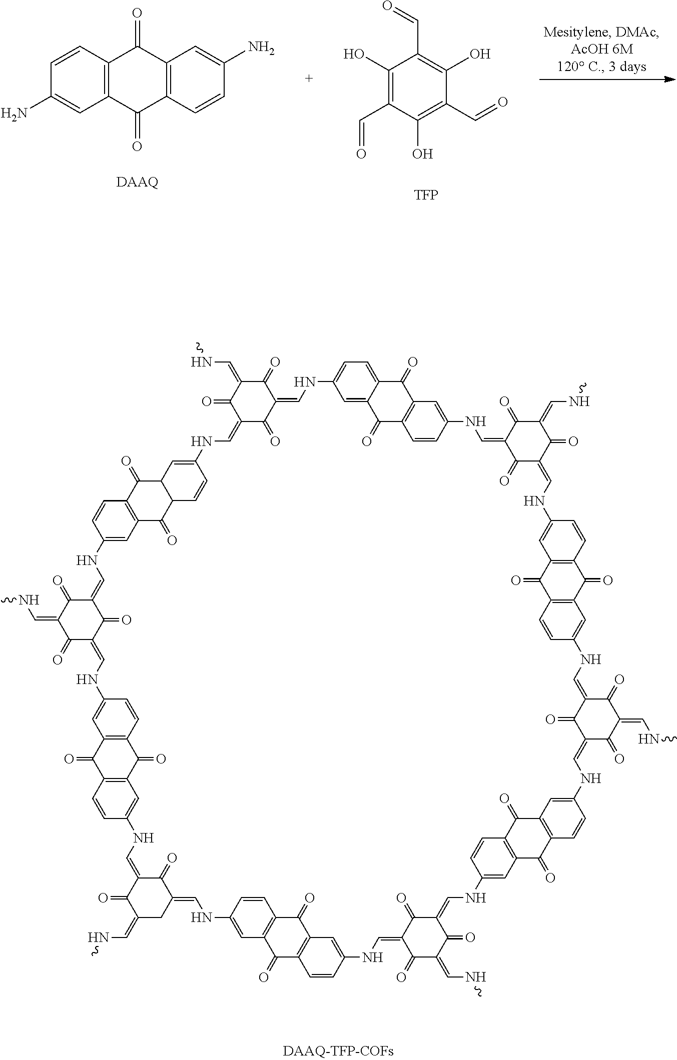

In particular, 1,3,5-triformylphloroglucinol (TFP) (4.20 g, 20 mmol), and 2,6-diaminoanthraquinone (DAAQ) (7.14 mg, 30 mmol), dimethylacetamide (180 ml) and mesitylene (60 mL) were added into a 500 mL round bottom flask and the suspension was sonicated at room temperature for 20 minutes. Aqueous acetic acid (6 M, 10 mL) was added to the flask and the suspension was sonicated again for 5 minutes. The suspension was freeze-vacuum-thawed for 3 repeated cycles to remove the oxygen. Then, the suspension was heated at 120° C. for 3 days. Afterwards, the reaction mixture was cooled to room temperature and the precipitate was filtrated and exhaustively washed with N,N-dimethylformamide (DMF) and acetone. The material was then dried at 80° C. overnight resulting in a dark red powder (9.539 g; 92% yield).

In a further exemplary procedure COF-2 (2D-PAI-COF) was prepared with the processes shown in Scheme 3.

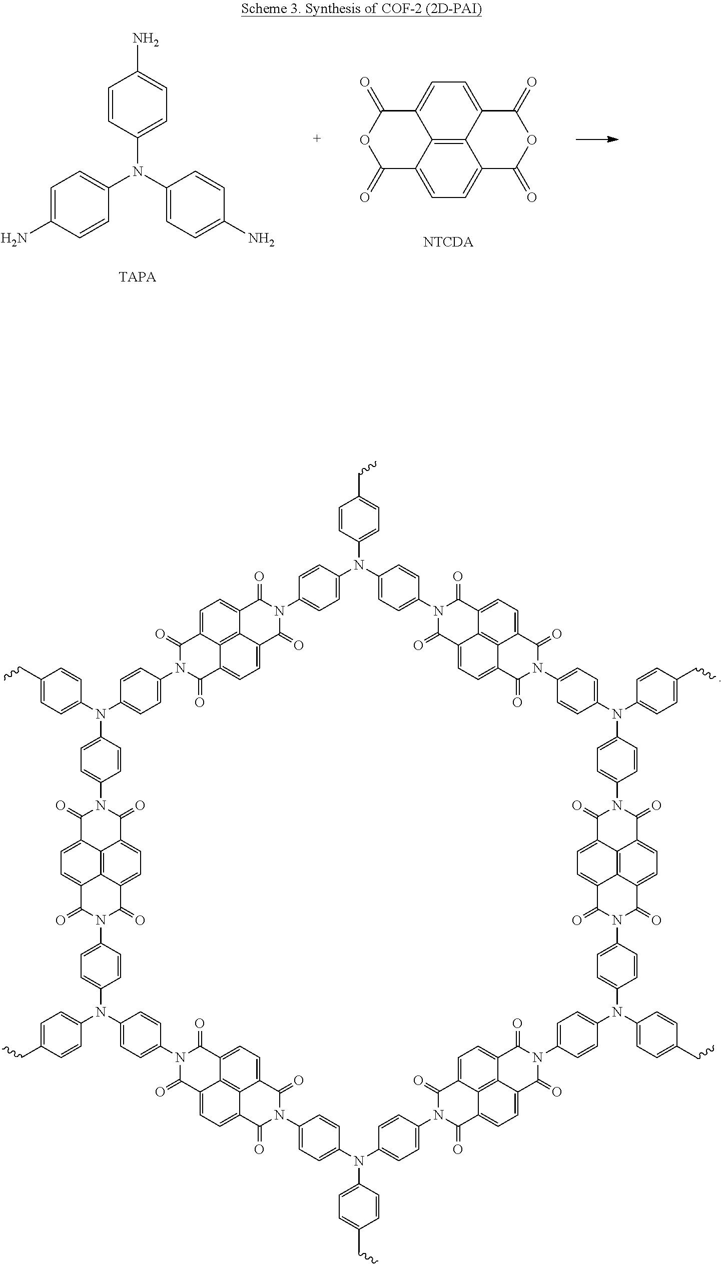

In particular, in a 35 mL glass pressure tube, tris(4-aminophenyl)amine (TAPA) (80.0 mg, 0.276 mmol, 1.0 eq.) and 1,4,5,8-naphthalene-tetracarboxylic acid dianhydride (NTCDA) (111.0 mg, 0.414 mmol, 1.5 eq.), a mixture of N-methyl-2-pyrrolidone (NMP, 2.0 ml)/mesitylene (2.0 ml)/iso-quinoline (0.2 ml) was added and homogenized in a ultrasonic bath for 10 min. The glass pressure tube was subjected to 3 freeze-pump-thaw cycles to remove the oxygen. The suspension was then heated at 200° C. for 5 days in a thermal oven.

Afterwards, the black precipitate observed at the bottom of the tube was isolated and washed with tetrahydrofuran (THF) and acetone. The residue was dried at 80° C. under reduced pressure overnight to obtain the targeted 2D-PAI-COFs (160 mg) as a black shiny solid material in 84% isolated yield.

In a further exemplary procedure COF-3 (TQBQ-COF) was synthesized as outlined in Scheme 4.

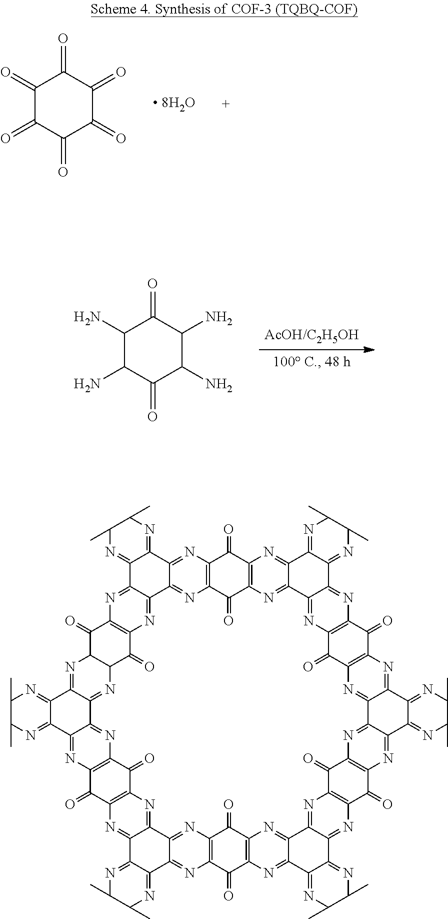 [SMILES: O=C1C(=O)C(=O)C(=O)C(=O)C1=O ; NC1C(=O)C(N)C(N)C(=O)C1N ; CC1N=c2c3c4c5nc6c(=O)c7nc8c(nc7c(=O)c6nc5c2=NC1C)c1c(c2nc5c(=O)c6nc7c9c(c%10nc%11c(=O)c%12nc%13c%14c(c%15nc%16c(=O)c%17nc%18c%19c(c%20nc%21c(=O)c%22nc%23c%24c(c%25nc%26c(nc%25c%23nc%22c(=O)c%21nc%20c%18nc%17c(=O)c%16nc%15c%13nc%12c(=O)c%11nc%10c7nc6c(=O)c5nc28)C(=O)C(N=4)C(N=3)C%26=O)=NC(C)C(C)N=%24)=NC(C)C(C)N=%19)=NC(C)C(C)N=%14)=NC(C)C(C)N=9)=NC(C)C(C)N=1]

In particular, Hexaketocyclohexane Octahydrate (CHHO) (0.049 g, 1.59 mmol) and 2,3,5,6-Tetraaminocyclohexa-2,5-diene-1,4-dione (TABQ) (0.400 g, 2.38 mmol) were 35 mL glass pressure tube, and 15 mL mixture of acetic acid/ethanol (v/v 1:1) was slowly added. The suspension was sonicated for 10 min and subject to freeze/vacuum/thaw for 3 repeated cycles to remove oxygen. Then the suspension was stirred at room temperature for 20 min and was heated at 100° C. for 48 h. A dark-red powder was achieved after rinsing by massive water, ethanol, and acetone, respectively.

The powder was vacuum dried at 75° C. overnight obtain the targeted TQBQ-COF (0.467 g) as a black shiny solid material in 52% isolated yield.

### Example 9: Procedure for Preparation of Hybrid Electrode Material

The hybrid material of the disclosure was prepared by a hybrid approach of mixing redox active organic materials of the disclosure with high density inorganic materials

The inorganic additive was first mixed with the SPoly in various ratios from 3:1 wt % (SPoly:Inorgnic additive) up to 30:1 wt %. and up to 49:1 (any amounts in between can be used e.g. SPoly:Inorgnic additive 4:1 wt % up to 9:1 wt % and up to 35:1 wt %) from The mixed organic-inorganic hybrid material was then mixed with conductive carbon and binder (CMC-Na/H₂O). The hybrid slurry was coated on to carbon coated aluminum foil. Aqueous solution of CMC-Na: styrene butadiene rubber (CMC-SBR) was introduced to coat thick electrode with good adhesion and cohesion, but without any obvious crack.

The following are some representative examples, of procedure for coating redox active material exemplified herein (Examples 10-19), following by examples of organic-inorganic hybrid cathodes comprising hybrid material obtained and coated with the procedure herein exemplified, and coupled with thin lithium anode in lean electrolyte conditions (Example 20-30) The related performance is discussed in Example 31.

### Example 10: Coating of SPoly Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 2.52 g of sieved SPoly was dry mixed with 0.36 g of SPC65 in another jar with another stainless-steel ball. The mixture was then rolled onto a tumbler for overnight for the power to form a homogenous mixture. Added 6.17 g of 2.5 wt % of CMC (Du2000BA 0.7-0.9 DS) solution in H₂O, 0.25 g of 8.5 wt % H₃PO₄ into a Thinky cup, and mixed them well in a Thinky mixture for 30 sec at 2000 rpm.

The homogeneous mixture of SPoly and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:SPC65:CMC:SBR electrode came out to be 84:12:3.5:0.5 wt %.

### Example 11: Coating of SPoly:LFP Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. A 2.31 g of sieved SPoly was dry mixed with 0.21 g of LFP and 0.36 g of SPC65 in another jar with another stainless-steel ball. The mixture was then rolled onto a tumbler for overnight for the power to form a homogenous mixture. Added 6.17 g of 2.5 wt % of CMC (Du2000BA 0.7-0.9 DS) solution in H₂O, 0.25 g of 8.5 wt % H₃PO₄ into a Thinky cup, and mixed them well in a Thinky mixture for 30 sec at 2000 rpm.

The homogeneous mixture of SPoly, LFP and SPC65 was then added to the Thinky cup having the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. A 0.03 g of 50 wt % SBR solution in H₂O was added to the homogeneous mixture of SPoly:LFP:SPC65:CMC-H₃PO₄. The overall mixture was then centrifuged for 3 min at 2000 rpm for the SBR to blend well with the rest of the ingredients. If Thinky cup got heated, then it was cooled down to room temperature by placing it into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:LFP:SPC65:CMC:SBR electrode came out to be 77:7:12:3.5:0.5 wt %.

### Example 12 Coating of SPoly:LTO Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 2.31 g of sieved SPoly was dry mixed with 0.21 g of LTO and 0.36 g of SPC65 in another jar with another stainless-steel ball. The mixture was then rolled onto a tumbler for overnight for the power to form a homogenous mixture. Added 6.17 g of 2.5 wt % of CMC (Du2000BA 0.7-0.9 DS) solution in H₂O, 0.25 g of 8.5 wt % H₃PO₄ into a Thinky cup, and mixed them well in a Thinky mixture for 30 sec at 2000 rpm.

The homogeneous mixture of SPoly, LTO and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:LTO:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:LTO:SPC65:CMC:SBR electrode came out to be 77:7:12:3.5:0.5 wt %.

### Example 13: Coating of SPoly:TiS₂ Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 2.31 g of sieved SPoly was dry mixed with 0.21 g of TiS₂ and 0.36 g of SPC65 in another jar with another stainless-steel ball. The mixture was then rolled onto a tumbler for overnight for the power to form a homogenous mixture. Added 6.17 g of 2.5 wt % of CMC (Du2000BA 0.7-0.9 DS) solution in H₂O, 0.25 g of 8.5 wt % H₃PO₄ into a Thinky cup, and mixed them well in a Thinky mixture for 30 sec at 2000 rpm.

The homogeneous mixture of SPoly, TiS₂ and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:TiS₂:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:TiS₂:SPC65:CMC:SBR electrode came out to be 77:7:12:3.5:0.5 wt %.

### Example 14 Coating of SPoly:Al₂O₃ Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 2.31 g of sieved SPoly was dry mixed with 0.21 g of Al₂O₃ and 0.36 g of SPC65 in another jar with another stainless-steel ball. The mixture was then rolled onto a tumbler for overnight for the power to form a homogenous mixture. Added 6.17 g of 2.5 wt % of CMC (Du2000BA 0.7-0.9 DS) solution in H₂O, 0.25 g of 8.5 wt % H₃PO₄ into a Thinky cup, and mixed them well in a Thinky mixture for 30 sec at 2000 rpm.

The homogeneous mixture of SPoly, Al₂O₃ and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:Al₂O₃:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:Al₂O₃:SPC65:CMC:SBR electrode came out to be 77:7:12:3.5:0.5 wt %.

### Example 15 Coating of SPoly:COF-1 Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 2.31 g of sieved SPoly was dry mixed with 0.21 g of COF-1 (DAAQ-TFP-COF) and 0.36 g of SPC65 in another jar with another stainless-steel ball. The mixture was then rolled onto a tumbler for overnight for the power to form a homogenous mixture. Added 6.17 g of 2.5 wt % of CMC (Du2000BA 0.7-0.9 DS) solution in H₂O, 0.25 g of 8.5 wt % H₃PO₄ into a Thinky cup, and mixed them well in a Thinky mixture for 30 sec at 2000 rpm.

The homogeneous mixture of SPoly, COF-1 and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:COF-1:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:COF-1:SPC65:CMC:SBR electrode came out to be 77:7:12:3.5:0.5 wt %.

### Example 16 Coating of SPoly:Gen1:LFP Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 1.48 g of sieved SPoly was dry mixed with 0.10 g of LFP, 0.10 g of Gen1 (PAQS) and 0.24 g of SPC65 in another jar with another stainless-steel ball. The mixture was then rolled onto a tumbler for overnight for the power to form a homogenous mixture. Added 5.33 g of 1.5 wt % of CMC (Du2000BA 0.7-0.9 DS) solution in H₂O, 0.15 g of 8.5 wt % H₃PO₄ into a Thinky cup, and mixed them well in a Thinky mixture for 30 sec at 2000 rpm.

The homogeneous mixture of SPoly, LFP, Gen1 and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:LFP:Gen1:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:LFP:Gen1:SPC65:CMC:SBR electrode came out to be 74:5:5:12:3.5:0.5 wt %. Example 17 Coating of SPoly:Gen1:LTO Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 1.48 g of sieved SPoly was dry mixed with 0.10 g of LTO, 0.10 g of Gen1 (PAQS) and 0.24 g of SPC65 in another jar with another stainless-steel ball. The mixture was then rolled onto a tumbler for overnight for the power to form a homogenous mixture. Added 5.33 g of 1.5 wt % of CMC (Du2000BA 0.7-0.9 DS) solution in H₂O, 0.15 g of 8.5 wt % H₃PO₄ into a Thinky cup, and mixed them well in a Thinky mixture for 30 sec at 2000 rpm.

The homogeneous mixture of SPoly, LTO, Gen1 and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly:LTO:Gen1:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:LTO:Gen1:SPC65:CMC:SBR electrode came out to be 74:5:5:12:3.5:0.5 wt %.

### Example 18 Coating of SPoly: Gen1:TiS₂ Electrode

In a sealed glass jar was taken the synthesized sulfurized carbon matrix (SPoly). A large stainless-steel ball (16 g) was added to the jar. The large particle of SPoly was broken up into smaller particles by rolling the jar onto a tumbler for overnight. The powder was then sieved to no greater than 150 μm particle size. 1.48 g of sieved SPoly was dry mixed with 0.10 g of TiS₂, 0.10 g of Gen1 (PAQS) and 0.24 g of SPC65 in another jar with another stainless-steel ball. The mixture was then rolled onto a tumbler for overnight for the power to form a homogenous mixture. Added 5.33 g of 1.5 wt % of CMC (Du2000BA 0.7-0.9 DS) solution in H₂O, 0.15 g of 8.5 wt % H₃PO₄ into a Thinky cup, and mixed them well in a Thinky mixture for 30 sec at 2000 rpm.

The homogeneous mixture of SPoly, TiS₂, Gen1 and SPC65 was then added to the Thinky cup with the CMC solution and H₃PO₄ mixture. The overall mixture was then centrifuged for 5 min at 500 rpm, then 2000 rpm for 3 min, then 500 rpm for 30 sec. The mixing procedure was repeated until all the dry ingredients become wet and form a homogenous slurry. 0.03 g of 50 wt % SBR solution was added to the homogeneous mixture of SPoly TiS₂:Gen1:SPC65:CMC-H₃PO₄. The overall mixture was then centrifuged for 3 min at 2000 rpm for the SBR to blend well with the rest of the ingredients. If Thinky cup got heated, then cooled it down to room temperature by placing the Thinky cup into an ice bath.

The homogeneous slurry was then coated onto a carbon coated aluminum foil (thickness ~15 μm) using a doctor blade. The coated material was dried at 40° C. by using the coater fan for 2 hours. The final composition of the SPoly:TiS₂:Gen1:SPC65:CMC:SBR electrode came out to be 74:5:5:12:3.5:0.5 wt %.

### Example 19 Densification of the Electrodes

After coating the electrodes with various compositions of active materials and fillers, the electrodes were subjected to calendar at high pressure to densify the electrodes. The calendaring was done using a heated at/or above 40° C. or unheated roller depending on the materials in the coated electrode.

The density of the cathodes were adjusted to be >1.3 g/cm³ for all the cathode electrodes and the density of the were adjusted to be >1.5 g/cm³ for the graphite or silicon, or silicon-graphite anode electrodes.

### Example 20: First Representative Example: Li-Lithium Iron Phosphate (LFP) Cathode Battery

LFP is a well-known cathode material for lithium-ion batteries. It has a true density of 3.6 g/cm³, the surface is of 10⁻¹⁵ m²/g. LFP is also widely known for its safety and environmental friendliness.

LFP was used as one of the inorganic additives to the organic sulfurized carbon matrix (SPoly) to develop a hybrid organic-inorganic redox active cathode material. Before it was mixed with SPoly, LFP was first tested alone to evaluate its chemical and electrochemical behavior in the mixing, coating and cell cycling conditions.

LFP was mixed then coated in H₂O with the composition of LFP:SPC65:CMC:SBR (84:12:3.5:0.5 wt %) on carbon coated aluminum foil. The coated material was dried at 100° C. overnight. The areal loading of the coating had come out to be 3.0 mAh/cm². The electrode was densified to 1.4 g/cm³ using a high-pressure hydraulic roller at 40° C. A CR2032-type coin cells were assembled in an argon-filled glovebox (H₂O <1 ppm, O₂<1 ppm) with a 50 μm lithium metal as anode, microporous polypropylene membrane (Celgard 2400) as separator, 180+FEC20vol/LiFSI as non-aqueous electrolyte, and the above-mentioned LFP as the cathode active material. The cell was cycled at C/10 in a Neware Battery Tester (BTS-4000).

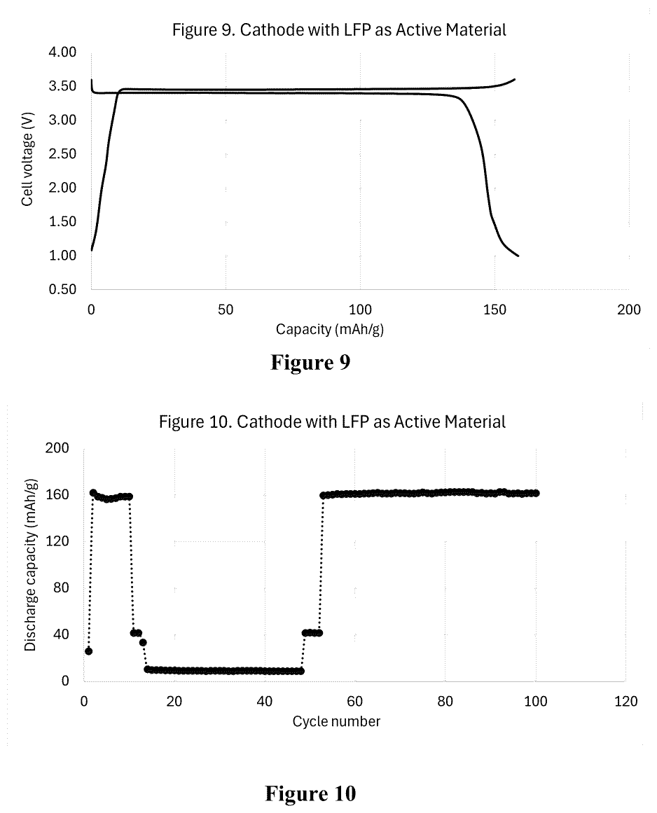

The data is presented in FIGS. 9 and 10 which show a stable voltage profile and capacities were observed when the cell was cycled within the voltage range of 1.0-3.6V (FIG. 9). The discharged capacity was to be 162 mAh/g at C/10 (FIG. 9). The cell was cycled from 1.0-3.6V voltage range for 15 cycles to 1.0-3.2V voltage range for 40 cycles and then switched to 1.0-3.6V voltage range for 45 cycles (FIG. 10).

A stable capacity of 162 mAh/g was observed and maintained throughout 1.0-3.6V voltage range cycling (FIG. 10). But when the cell was cycled 1.0-3.2V voltage range, a <10 mAh/g capacity was observed as expected since LiFePO₄ has no redox processes within this voltage range. This data confirmed that the Fe(II) in LiFePO₄ is stable even when it cycled up to 1.0V. This piece of data supported our expectation that LFP can be one of the suitable inorganic additive materials to develop a high loading, high density SPoly:LFP cathode material.

### Example 21: Second Representative Example: Li-Sulfurized Carbon Matrix (SPoly) Cathode Battery

The organic sulfurized carbon matrix (SPoly) synthesized as exemplified in Example 5, was first mixed with SPC65, then coated using CMC-Na/H₂O:SBR on to a carbon coated aluminum foil according to the procedure exemplified in Example 10. The final composition of the dry electrode came out to be SPoly:SPC65:CMC:SBR (84:12:3.5:0.5 wt %). The dry electrode was densified to 1.3 g/cm³ using a high-pressure hydraulic roller at 40° C. with a procedure exemplified in Example 19.

The areal loading of the cathode was 3.0 mAh/cm². A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the above-mentioned SPoly as the cathode active material. The cell was cycled at C/10 in a Neware Battery Tester (BTS-4000).

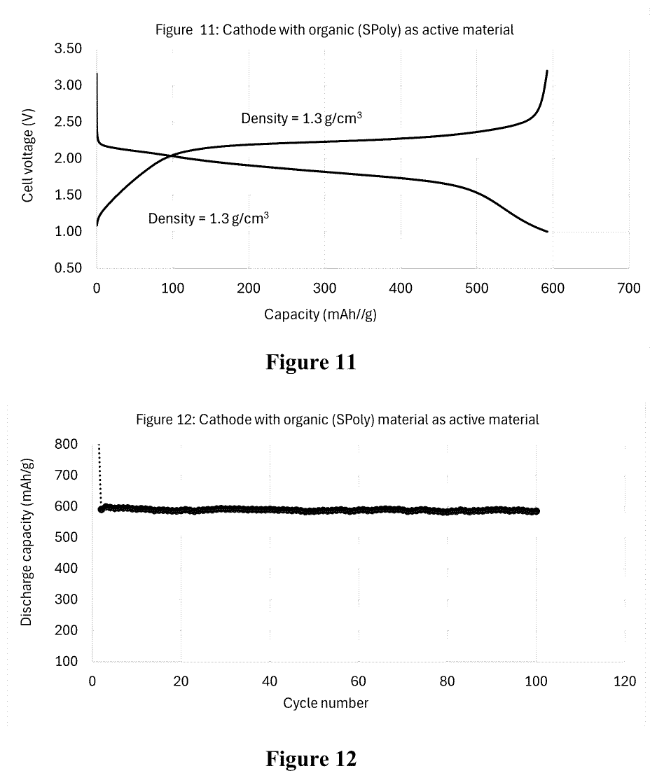

The data is presented in FIGS. 11 and 12. A stable voltage profile and capacities were observed when the cell was cycled within the voltage range of 1.0-3.2V (FIG. 11). The discharged capacity was to be 600 mAh/g at C/10 (FIG. 11). The cell was cycled from 1.0-3.2V voltage range for 100 cycles (FIG. 12) with a no capacity decay. This cell was built to compare the data with the organic-inorganic hybrid cathode active materials in terms of discharged capacity (mAh/g), specific energy (Wh/kg), and cycle life.

### Example 22: Third Representative Example: Li-Organic:Inorganic Hybrid (SPoly:LFP) Cathode Battery

After establishing the cyclability LFP of cathode (Example 20, FIGS. 9 and 10), and the cyclability of SPoly cathode (density 1.3 g/cm³) (Example 21, FIGS. 11 and 12), LFP and SPoly were combined them together according to the procedure exemplified in Example 11, to understand and evaluate their synergistic effects on density of the electrode, discharge capacity (mAh/g), specific energy (Wh/kg) and cycle life. The coating of the SPoly:LFP hybrid cathode was performed according to the procedure exemplified in Example 11. The addition of inorganic additive LFP improved the slurry rheology during the cathode fabrication, and the adhesion and cohesion of the cathode was found to be superior to the SPoly cathode. The final composition of the hybrid electrode came out to be SPoly:LFP:SPC65:CMC:SBR (77:7:12:3.5:0.5 wt %).

The hybrid electrode was further densified to 1.4 g/cm³ using a high-pressure hydraulic roller at 40° C. according to a procedure exemplified in Example 19. The areal loading of the cathode was 3.2 mAh/cm². A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the above-mentioned SPoly:LFP as the cathode active material. The cell was cycled at C/10 in a Neware Battery Tester (BTS-4000).

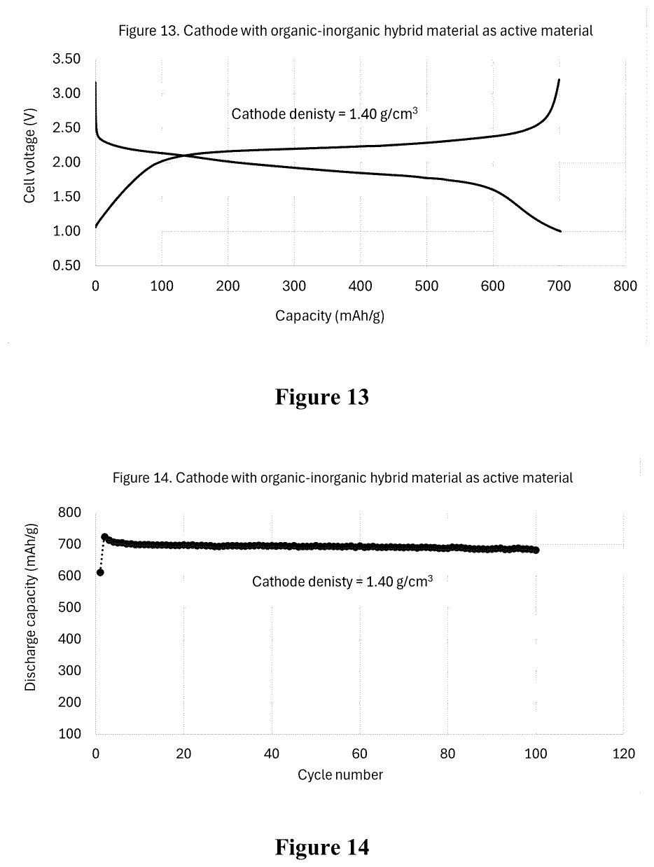

The data is presented in FIGS. 13 and 14. A stable voltage profile was observed when the cell was cycled within the voltage range of 1.0-3.2V (FIG. 13). The discharged capacity was to be 700 mAh/g at C/10 (FIG. 13), which is 100 mAh/g higher than the SPoly alone cathode. This higher capacity was attributed to the LFP particles creating a percolating network for electrolyte to properly wet the electrode even when the density of the electrode was very high (1.4 g/cm³). The cell was cycled from 1.0-3.2V voltage range for 100 cycles (FIG. 14) with a no capacity decay. The specific energy was found to be much higher for the hybrid cathode compared to SPoly cathode alone as the data is presented in Table 2 and discussed in Example 31.

### Example 23: Fourth Representative Example: Li-Organic:Inorganic Hybrid (SPoly:Gen1:LFP) Cathode Battery

Preparation and coating of the SPoly:Gen1:LFP hybrid cathode was performed as described in Example 7 and Example 16. The final composition of the hybrid electrode came out to be SPoly:Gen1:LFP:SPC65:CMC:SBR (74:5:5:3.5:0.5 wt %). The hybrid electrode was densified to 1.3 g/cm³ using a high-pressure hydraulic roller at 40° C. according to a procedure exemplified in Example 19. The areal loading of the cathode was 3.1 mAh/cm². A CR2032-type coin cells were assembled in an argon-filled glovebox (H₂O <1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the above-mentioned SPoly:Gen1:LFP as the cathode active material. The cell was cycled at C/10 in a Neware Battery Tester (BTS-4000).

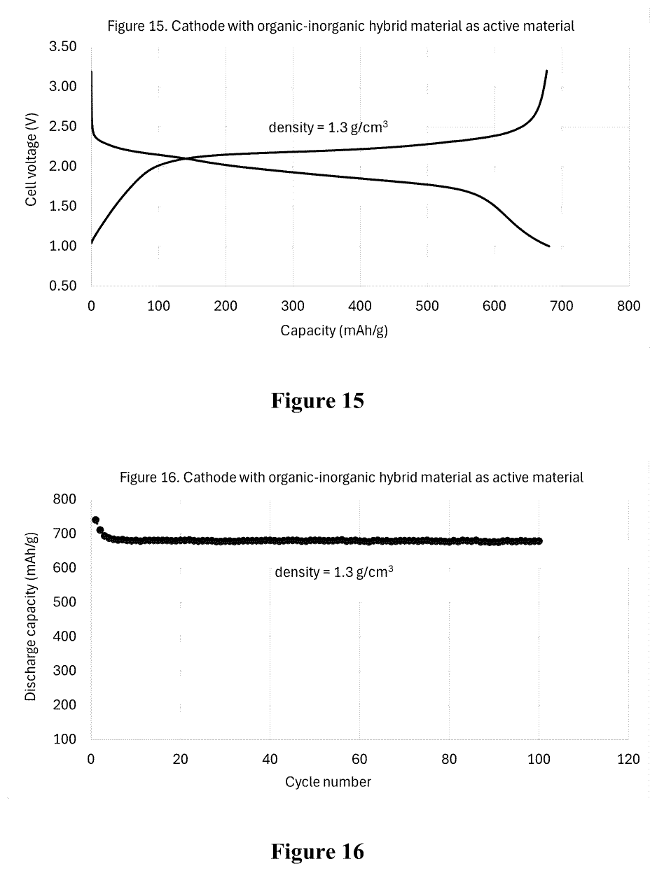

The data is presented in FIGS. 15 and 16. A stable voltage profile was observed when the cell was cycled within the voltage range of 1.0-3.2V (FIG. 15). The discharged capacity was to be 685 mAh/g at C/10 (FIG. 15), which is 85 mAh/g higher than the SPoly alone cathode (FIG. 11). This higher capacity was attributed to the LFP particles creating a percolating network for electrolyte to properly wet the electrode even when the density of the electrode was very high (1.3 g/cm³).

The S-linked polymer, Gen-1 (PAQS) was acts redox facilitator for the organic-inorganic hybrid cathode material. The cell was cycled from 1.0-3.2V voltage range for 100 cycles (FIG. 16) with a no appreciable capacity decay. The specific energy was found to be much higher for this organic-inorganic hybrid cathode compared to SPoly cathode alone as the data is presented in Table 2 and discussed in Example 31.

### Example 24: Fifth Representative Example Li-LTO Cathode Battery

Lithium Titanate Oxide (LTO) is an anode material for lithium-ion batteries. The reversible redox potential for LTO is about 1.55V vs. Li/Li⁺, which overlaps the redox potential of sulfurized carbon matrix (SPoly) at 1.85V vs. Li/Li⁺. LTO is also known for its ultra-fast charging, and long cycle life. The true density of LTO is about 3.43 g/cm³. Due to all these excellent properties of LTO, it was selected as inorganic material to be added to the SPoly as an additive, to increase the density of the cathode, would be able increase the capacity of the cell (mAh/g), and would be able to cycle the battery at a much faster rate.

First, a set of experiments were performed to understand the LTO electrode on its own to evaluate its efficacy to the hybrid electrode. LTO was then coated in H₂O with the composition of LTO:SPC65:CMC:SBR (84:12:3.5:0.5 wt %) on carbon coated aluminum foil. The coated material was dried at 40° C. overnight for overnight under coating fan. The areal loading of the coating had come out to be 3.0 mAh/cm². The electrode was densified to 1.3 g/cm³ using a high-pressure hydraulic roller at 40° C. A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+FEC20vol/LiFSI as non-aqueous electrolyte, and the afore-mentioned LTO as the cathode active material. The cell was cycled at C/10 in a Neware Battery Tester (BTS-4000).

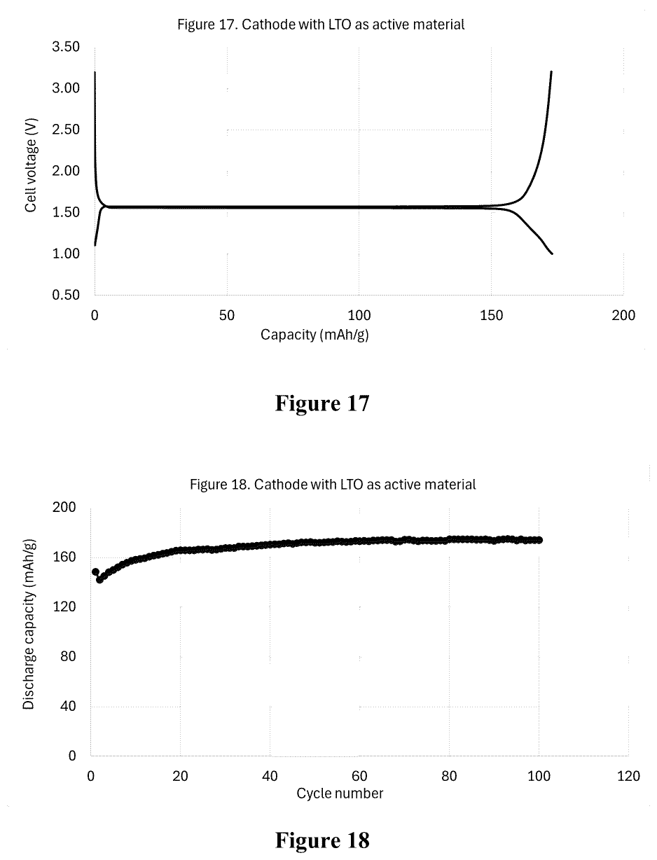

The data is presented in FIGS. 17 and 18. A stable voltage profile (1.54V) and capacity (170 mAh/g) were observed when the cell was cycled within the voltage range of 1.0-3.2V (FIG. 17). The discharged capacity was to be 170 mAh/g at C/10 (FIG. 17). The cell was cycled from 1.0-3.2V voltage range for 100 cycles. A stable capacity of 170 mAh/g was observed with no appreciable decay as shown in FIG. 18. The LTO cycling data gave us confidence that we could you use this material (TLO) as an additive to the sulfurized organic carbon matrix (SPoly) material to develop a high loading, high density, high rate organic-inorganic hybrid cathode for metallic Li, or K or Na batteries.

### Example 25: Sixth Representative Example: Li-SPoly:LTO Cathode Battery

After establishing the cyclability LTO of cathode (Example 24, FIGS. 17 and 18), and the cyclability of SPoly cathode (Example 21, FIGS. 11 and 12), we then moved to combined them together to understand and evaluate their synergistic effects on density of the electrode, discharge capacity (mAh/g), specific energy (Wh/kg) and cycle life. The coating of the SPoly:LTO hybrid cathode was performed with the procedure described in Example 12. It is noteworthy to mention that the addition of inorganic additive LTO improved the slurry rheology and viscosity during the cathode fabrication, and the adhesion and cohesion of the cathode was found to be superior to the SPoly cathode. The final composition of the hybrid electrode came out to be SPoly:LTO:SPC65:CMC:SBR (77:7:12:3.5:0.5 wt %).

The hybrid electrode was densified to 1.3 g/cm³ using a high-pressure hydraulic roller at 40° C. The areal loading of the cathode was 3.5 mAh/cm². The high areal loading (3.5 mAh/cm²) was due to the additional capacity of LTO (175 mAh/g) it brought to the SPoly electrode. A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the afore-mentioned SPoly:LTO as the cathode active material. The cell was cycled at C/10 in a Neware Battery Tester (BTS-4000).

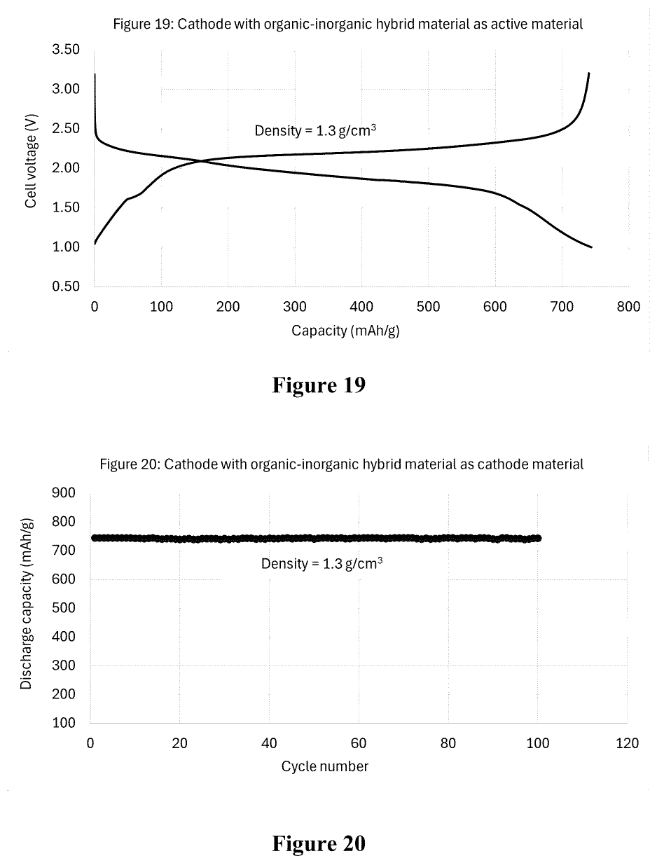

The data is presented in FIGS. 19 and 20. A stable voltage profile was observed when the cell was cycled within the voltage range of 1.0-3.2V (FIG. 19). The discharged capacity was to be 726 mAh/g at C/10 (FIG. 19), which is 126 mAh/g higher than the SPoly alone cathode. This higher capacity was attributed to the additional capacity of LTO added to the SPoly cathode. The LTO particles created a percolating network for electrolyte to properly wet the electrode even when the density of the electrode was very high (1.3 g/cm³). The cell was cycled from 1.0-3.2V voltage range for 100 cycles (FIG. 20) with a no capacity decay.

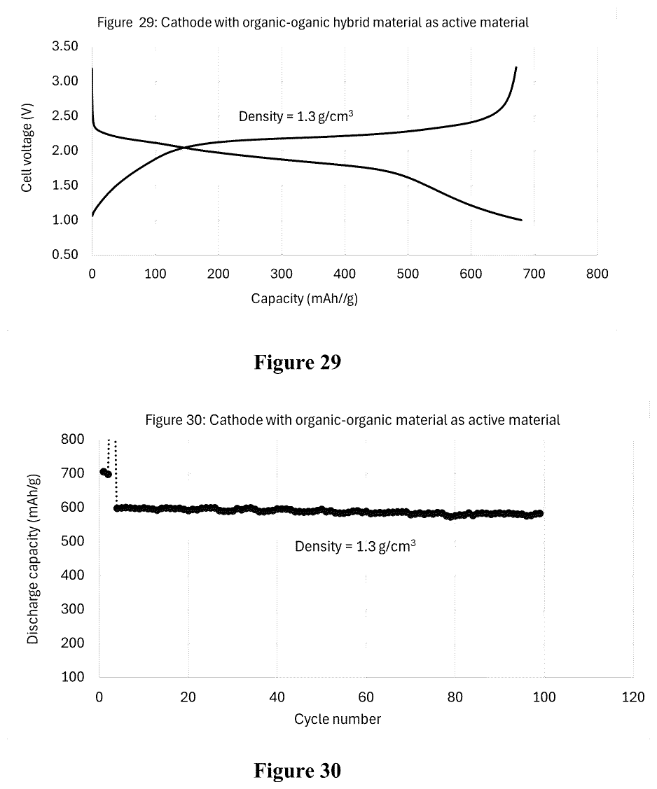

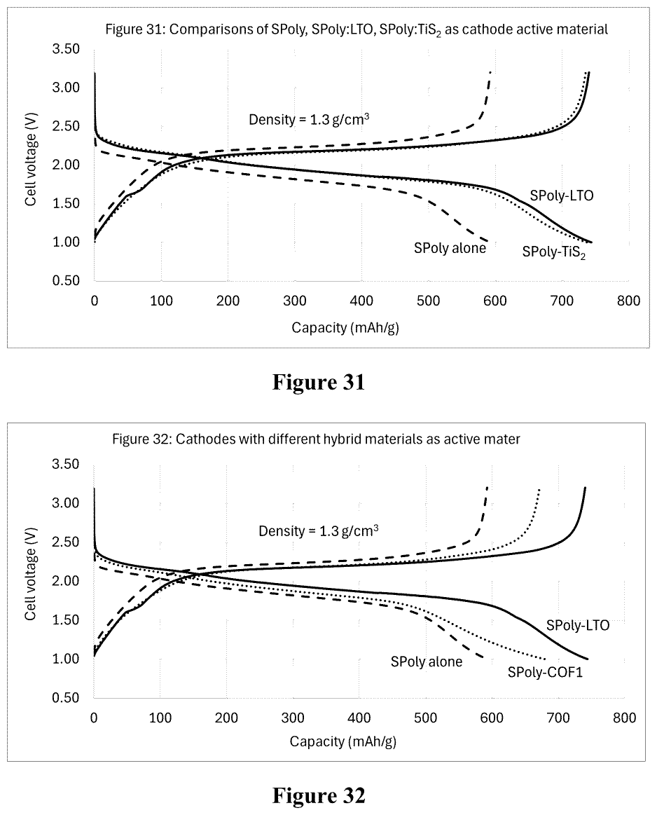

The capacity comparison of SPoly cathode (1.3 g/cm²) vs. SPoly:LTO (1.3 g/cm²) is presented in FIG. 31. The specific energy (Wh/kg) was found to be one of the highest for this hybrid organic-inorganic cathode. The data is presented in Table 2 and discussed in Example 31.

### Example 26: Seventh Representative Example: Li-SPoly:Gen1:LTO Cathode Battery

The coating of the SPoly:Gen1:LTO hybrid cathode was performed as described in Example 17. The final composition of the hybrid electrode came out to be SPoly:Gen1:LTO:SPC65:CMC:SBR (74:5:5:3.5:0.5 wt %). The hybrid electrode was densified to 1.3 g/cm³ using a high-pressure hydraulic roller at 40° C. as described in Example 19.

The areal loading of the cathode was 3.3 mAh/cm². The high areal loading (3.3 mAh/cm²) was due to the additional capacity of LTO (175 mAh/g) it brought to the SPoly electrode. A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the afore-mentioned SPoly:Gen1:LTO as the cathode active material. The cell was cycled at C/10 in a Neware Battery Tester (BTS-4000).

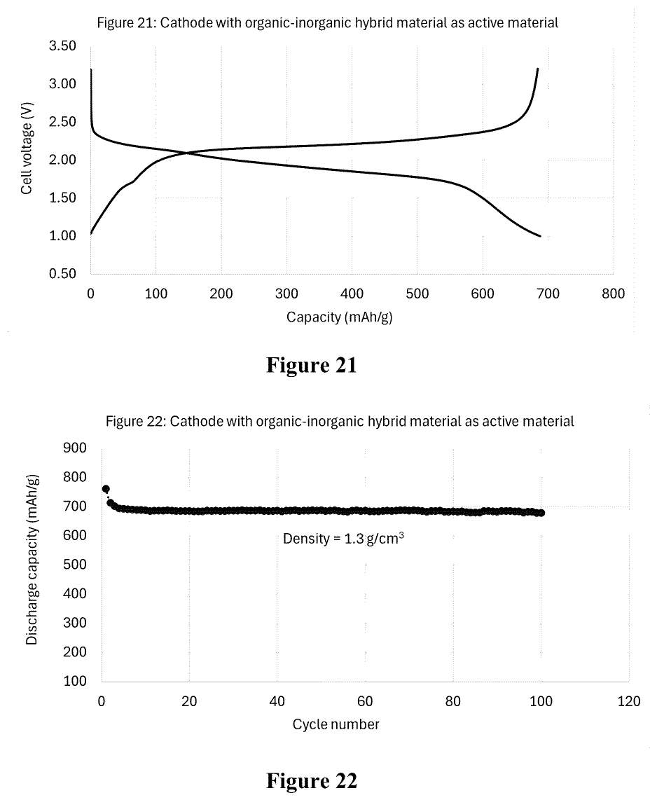

The data is presented in FIGS. 21 and 22. A stable voltage profile was observed when the cell was cycled within the voltage range of 1.0-3.2V (FIG. 21). The discharged capacity was to be 695 mAh/g at C/10 (FIG. 21), which is 95 mAh/g higher than the SPoly alone cathode. This higher capacity was attributed to the additional capacity of LTO added to the SPoly cathode. The LTO particles created a percolating network for electrolyte to properly wet the electrode even when the density of the electrode was very high (1.3 g/cm³). The cell was cycled from 1.0-3.2V voltage range for 100 cycles (FIG. 22) with a no capacity decay. The specific energy (Wh/kg) was found to be one of the highest for this hybrid organic-inorganic cathode. The data is presented in Table 2 and discussed in Example 31.

### Example 27: Eighth Representative Example: Li—TiS₂ Cathode Battery

Titanium disulfide (TiS₂) is a layered electrode material. It was one of the first materials studied as cathode active material for lithium metal batteries. It intercalates Li⁺ ion between its layers offering high energy density (239 mAh/g). The reversible redox potential for TiS₂ is in between 2.10-2.50V vs. Li/Li⁺, which overlaps the redox potential of sulfurized carbon matrix (SPoly) at 1.85V vs. Li/Li⁺. TiS₂ is also known for high electronic conductivity, thermal stability, fast charging, and long cycle life. The true density of TiS₂ is about 3.22 g/cm³. Due to all afore-mentioned excellent properties of TiS₂, we selected as inorganic additive to be added to the SPoly as an additive, to increase the density of the cathode, increase the capacity of the cell (mAh/g), and cycle the battery at a much faster rate.

First, a set of experiments was performed to understand the TiS₂ electrode on its own to evaluate its potential to enhance the hybrid electrode. TiS₂ was then coated in H₂O with the composition of TiS₂:SPC65:CMC:SBR (84:12:3.5:0.5 wt %) on carbon coated aluminum foil. The coated material was dried at 40° C. for overnight under coating fan. The areal loading of the coating had come out to be 3.0 mAh/cm². The electrode was densified to 1.4 g/cm³ using a high-pressure hydraulic roller at 40° C. A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+FEC20vol/LiFSI as non-aqueous electrolyte, and the afore-mentioned TiS₂ as the cathode active material. The cell was cycled at C/10 in a Neware Battery Tester (BTS-4000).

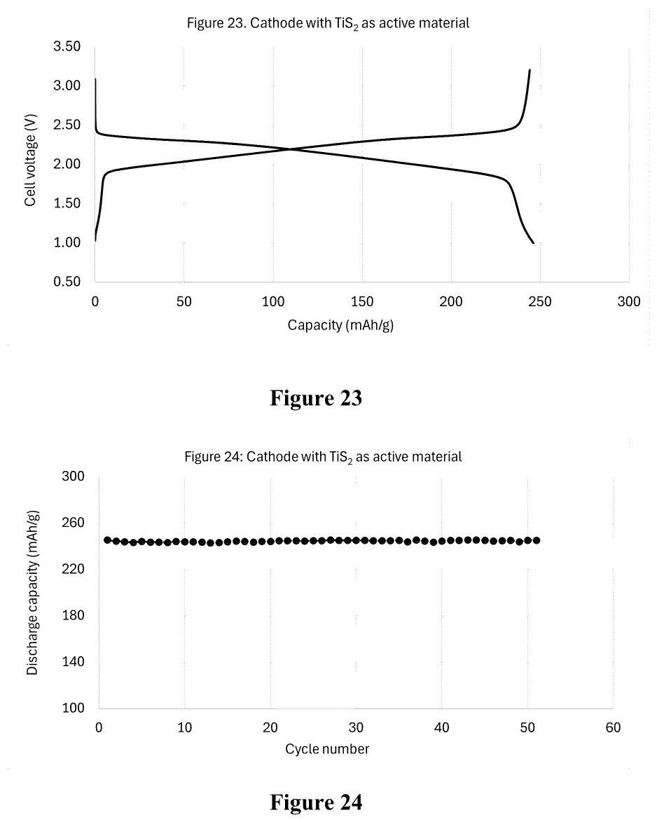

The data is presented in FIGS. 23 and 24. A stable voltage profile (2.20V) and capacity (236 mAh/g) were observed when the cell was cycled within the voltage range of 1.0-3.2V (FIG. 23). The discharged capacity was to be 236 mAh/g at C/10 (FIG. 23). The cell was cycled from 1.0-3.2V voltage range for 50 cycles. A stable capacity of 236 mAh/g was observed with no appreciable decay as shown in FIG. 24. The TiS₂ cycling data gave us high confidence that we could you use this material (TiS₂) as an additive to the sulfurized organic carbon matrix (SPoly) material to develop a high loading, high density, high rate organic-inorganic hybrid cathode for metallic Li, or K or Na batteries.

### Example 28: Ninth Representative Example: Li-SPoly:TiS₂ Hybrid Cathode Battery

After establishing the cyclability of TiS₂ cathode (Example 27, FIGS. 23 and 24), and the cyclability of SPoly cathode (Example 21, FIGS. 11 and 12), these two organic and inorganic materials were combined as hybrid mix according to the procedure exemplified in Example 9 to understand and evaluate their synergistic effects on density of the electrode, discharge capacity (mAh/g), specific energy (Wh/kg) and cycle life of the battery. The coating of the SPoly:TiS₂ hybrid cathode was performed as described in Example 13. The addition of inorganic additive TiS₂ improved the slurry rheology and viscosity during the cathode fabrication, and the adhesion and cohesion of the cathode was found to be superior to the SPoly cathode.

The final composition of the hybrid electrode came out to be SPoly:TiS₂:SPC65:CMC:SBR (77:7:12:3.5:0.5 wt %). The hybrid electrode was densified to 1.4 g/cm³ using a high-pressure hydraulic roller at 40° C. as exemplified in Example 19. The areal loading of the cathode was 3.6 mAh/cm². The high areal loading (3.6 mAh/cm²) was due to the additional capacity of TiS₂ (239 mAh/g) it brought to the SPoly electrode. A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the afore-described SPoly:TiS₂ as the cathode active material. The cell was cycled at C/10 in a Neware Battery Tester (BTS-4000).

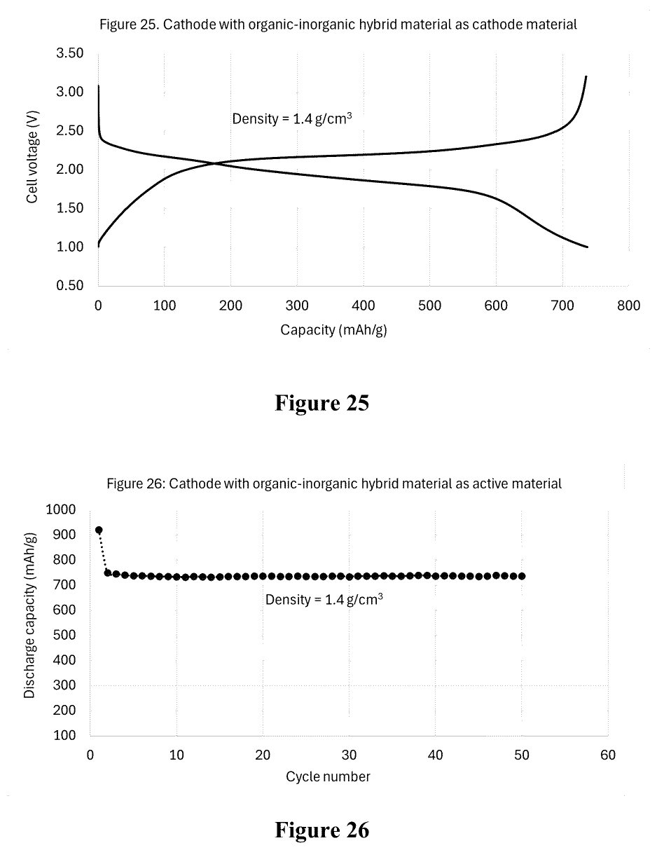

The data is presented in FIGS. 25 and 26. A stable voltage profile was observed when the cell was cycled within the voltage range of 1.0-3.2V (FIG. 25). The discharged capacity was to be 725 mAh/g at C/10 (FIG. 25), which is 125 mAh/g higher than the SPoly alone cathode. This higher capacity was attributed to the additional capacity of TiS₂ added to the SPoly cathode. The TiS₂ particles also created a percolating network for electrolyte to properly wet the electrode even when the density of the electrode was very high (1.4 g/cm³, low porosity). The cell was cycled from 1.0-3.2V voltage range for 50 cycles (FIG. 26) with a no capacity decay. The capacity comparison of SPoly cathode (1.3 g/cm²) vs. SPoly:TiS₂ (1.4 g/cm²) was presented in FIG. 31. The specific energy (Wh/kg) was found to be one of the highest for this hybrid organic-inorganic cathode. The data is presented in Table 2 and discussed in Example 31.

### Example 29: Tenth Representative Example: Li-SPoly:Al₂O₃Hybrid Cathode Battery

Aluminum oxide (Al₂O₃) is commonly known as alumina. It is a non-conducting ceramic material increasingly explored for its application as an inorganic additive in batteries. Even though it doesn't possess any redox properties, it was selected as inorganic material to increase the density of the electrode and create a protective layer on SPoly cathode to prevent side reactions, if any, between the electrode and electrolyte, enhancing the stability and lifespan of the batteries. It also has excellent thermal properties and has the improve the mechanical properties. The coating of SPoly:Al₂O₃ organic-inorganic hybrid cathode was obtained with the procedures exemplified in Example 14.

The final composition of the hybrid electrode came out to be SPoly:Al₂O₃:SPC65:CMC:SBR (77:7:12:3.5:0.5 wt %). The hybrid electrode was densified to 1.3 g/cm³ using a high-pressure hydraulic roller at 40° C. as exemplified in Example 19. The areal loading of the cathode was 3.5 mAh/cm². A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the afore-described SPoly:Al₂O₃ as the cathode active material. The cell was cycled at C/10 in a Neware Battery Tester (BTS-4000).

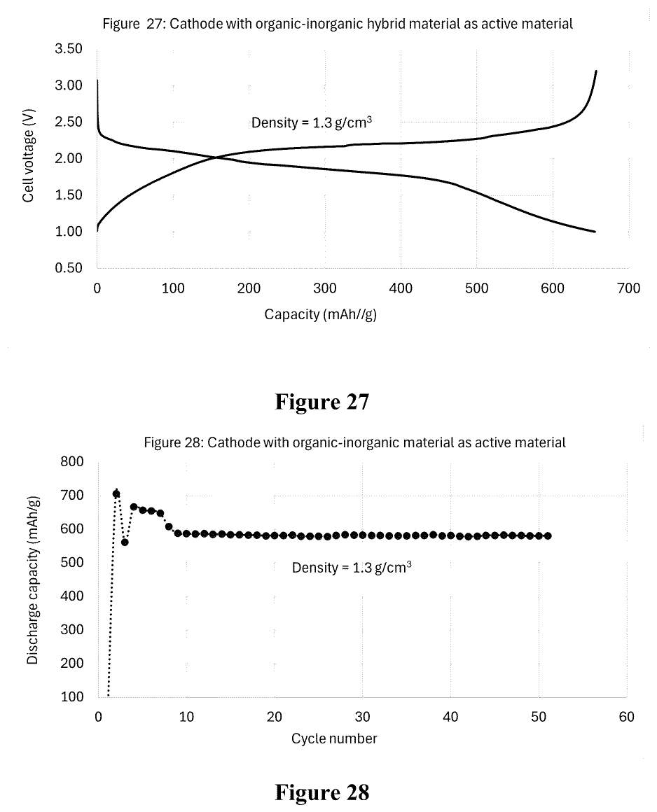

The data is presented in FIGS. 27 and 28. A stable voltage profile was observed when the cell was cycled within the voltage range of 1.0-3.2V (FIG. 27). The discharged capacity was to be 660 mAh/g at C/10 (FIG. 27), which is 60 mAh/g higher than the SPoly alone cathode. The Al₂O₃ particles also created a percolating network for electrolyte to properly wet the electrode even when the density of the electrode was very high (1.4 g/cm³, low porosity). The cell was cycled from 1.0-3.2V voltage range for 50 cycles (FIG. 28) with a no capacity decay. The specific energy (Wh/kg) was found to be one of the highest for this hybrid organic-inorganic cathode. The data is presented in Table 2 and discussed in Example 31.

### Example 30: Eleventh Representative Example: Li-SPoly:DAAQ-TFA-COF Cathode Battery

The preparation and coating of SPoly:DAAQ-TFA-COF organic-inorganic hybrid cathode was performed with the procedure exemplified in Example 8 and Example 15. The final composition of the hybrid electrode came out to be SPoly:DAAQ-TFA-COF:SPC65:CMC:SBR (77:7:12:3.5:0.5 wt %). The hybrid electrode was densified to 1.3 g/cm³ using a high-pressure hydraulic roller at 40° C. as described in Example 19. The areal loading of the cathode was 3.3 mAh/cm². A CR2032-type coin cells were assembled in an argon-filled glovebox (H₂O<1 ppm, O₂<1 ppm) with a 50 μm lithium metal as anode, microporous polypropylene membrane (Celgard 2400) as separator, 180+20volFEC/LiFSI as non-aqueous electrolyte under lean electrolyte condition, and the afore-described SPoly:DAAQ-TFA-COF as the cathode active material. The cell was cycled at C/10 in a Neware Battery Tester (BTS-4000).

The data is presented in FIGS. 29 and 30. A stable voltage profile was observed when the cell was cycled within the voltage range of 1.0-3.2V (FIG. 29). The discharged capacity was to be 685 mAh/g at C/10 (FIG. 29, which is 85 mAh/g higher than the SPoly alone cathode. The porous particle of DAAQ-TFA-COF particles created a percolating channel for electrolyte to properly wet the electrode even when the density of the electrode was very high (1.3 g/cm³, low porosity). The cell was cycled from 1.0-3.2V voltage range for 100 cycles (FIG. 30) with a no capacity decay. The specific energy (Wh/kg) data is presented in Table 2 and discussed in Example 31.

### Example 31: Performance of Representative Cathode Materials

The comparisons of specific energy (Wh/kg) all the lithium-organic:inorganic hybrid material batteries of Examples 21 to 29 are presented in Table 2.

TABLE 2
Data comparison for exemplary cathodes with and
without filler

| | S- | | | Total | Elec- | Speci- | | |
|---|---|---|---|---|---|---|---|---|
| | linked | Inor- | | Active | trode | fic | Cut- | Ex- |
| | Qui- | ganic | Inor- | mater- | Den- | Energy | off | am- |
| SPoly | none | Filler | ganic | ial | sity | Wh/kg | Vol- | ple |
| (wt | (wt | (wt | Filler | (wt | g/ | at 0.1 | tage | num- |
| %) | %) | %) | type | %) | cm³ | C. | V | ber |
| 84 | 0 | 0 | none | 84 | 1.3 | 1050 | 1.0-3.2 | 21 |
| 88 | 6 | 6 | LFP | 84 | 1.3 | 1234 | 1.0-3.2 | 23 |
| 91 | 0 | 9 | LFP | 84 | 1.4 | 1272 | 1.0-3.2 | 22 |
| 88 | 6 | 6 | LTO | 84 | 1.3 | 1275 | 1.0-3.2 | 26 |
| 91 | 0 | 9 | LTO | 84 | 1.3 | 1350 | 1.0-3.2 | 25 |
| 91 | 0 | 9 | TiS₂ | 84 | 1.4 | 1375 | 1.0-3.2 | 28 |
| 91 | 0 | 9 | A1₂O₃ | 84 | 1.3 | 1110 | 1.0-3.2 | 29 |

Additionally, the performance of the exemplary cathode materials of the disclosure comprising SPoly:LTO and SPoly:TiS₂ described in Examples 25 and 28 is reported in FIG. 31, where their corresponding voltage profile is reported in comparison with the voltage profile of an SPoly cathode described in Example 21.

The performance of the exemplary cathodes of the disclosures comprising SPoly:DAAQ-TFP:COF and SPoly:LTO described in Examples 30 and 25 is reported in FIG. 32, where their corresponding voltage profile is reported in comparison with the voltage profile of an SPoly cathode described in Example 21.

The results reported in Table 2 and FIGS. 31 and 32 show that the performance of the batteries is improved in all hybrid materials thus supporting the conclusion that is the particle size, surface area, and the density of the electrode that in all cases affect the cyclic properties such as discharge capacity, specific energy, volumetric energy density and cycle life.

In particular it will be apparent to a skilled person reviewing the data reported in Table 2, FIG. 31 and FIG. 32 that the cell with the SPoly (bulk density <1.0 g/cm³ and electrode density of 1.3 g/cm³) gave a discharge capacity of 600 mAh/g, which is 83% of theoretical capacity of SPoly (720 mAh/g based on 43% sulfur content). Additionally, when the SPoly was comixed with inorganic additives with smaller particle size and higher density, the cell capacity is significantly improved.

For example, it is apparent from the comparison of Table 2, and FIG. 31, that when SPoly was mixed with LFP (true density 3.6 g/cm³, particle size 6 um, surface area 11 m²/g) as an additive, the discharge capacity of the cell increased to 700 mAh/g, which is 97% of theoretical capacity of SPoly (720 mAh/g based on 43% sulfur content), as also shown by illustration of FIG. 13. The specific energy density is also significantly improved from 1050 Wh/kg to 1272 Wh/kg (Table 2). Similar trend was observed with other inorganic additives such as LTO (particle size 1.5 um, surface area 16 m²/g, true density 3.43 g/cm³), TiS₂ (particle size 50 um, surface area 10 m²/g, true density 3.22 g/cm³) and Al₂O₃ (particle size 0.05 um, surface area 85-100 m²/g, true density 3.99 g/cm³). (see Table 2, FIGS. 31 and 32).

Conversely data illustrated in the above comparison show that the agglomerate in stacks of SPoly particles with low bulk density had an adverse effect on cell performance when the electrode was densified to 1.3 g/cm³.

This data support the conclusion that the wettability of the electrode was severely affected resulting in unsatisfied polarization and low capacity (FIGS. 31 and 32) as will be understood by a skilled person. This data also support the conclusion that the addition of inorganic additives with smaller sizes and higher bulk densities to SPoly helped densify the electrodes with maintaining the percolation networks for electrolyte to soak the electrode.

Accordingly, the data shown in previous examples and the comparisons illustrated in Table 2, FIGS. 31 and 32 the cells in which the cathode comprised hybrid material of the disclosure, inclusive of inorganic particles having representative density size and surface area included in representative ratios, did benefit from dense electrode/electrolyte contact and shortened electronic/ionic transport channels, resulted significantly higher discharge capacity (FIGS. 31 and 32) and significantly higher specific energy (Table 2).

In particular, the data reported in Table 2 and FIGS. 31, show that the specific energy of SPoly cathode was found to be 1050 Wh/kg at C/10. The highest specific energy (1375 Wh/kg) was obtained when SPoly was mixed with TiS₂ in 91:9 wt ratio followed by LTO (1350 Wh/kg) with same ratio.

The experimental data presented in Table 2 and FIGS. 13 and 32, and in the previous examples, show that the organic-inorganic hybrid cathode with the composition of SPoly:LFP:SPC65:CMC:SBR (77:7:12:3.5:0.5 wt %) gave higher discharge capacity and specific energy than the cathode with sulfurized carbon matrix with the composition of SPoly:SPC65:CMC:SBR (84:12:3.5:0.5 wt %). Both cells were made with metallic lithium as anode, Celgard 2400 separator, and non-aqueous electrolyte. The data for both cells are presented in FIGS. 13, 14, and 11, 12.

In the experimental data presented in Table 2 and FIGS. 31 and 32 and in previous examples, the organic-inorganic hybrid cathode with the composition of SPoly:LTO:SPC65:CMC:SBR (77:7:12:3.5:0.5 wt %) gave higher discharge capacity and specific energy than the cathode with sulfurized carbon matrix with the composition of SPoly:SPC65:CMC:SBR (84:12:3.5:0.5 wt %). Both cells were made with metallic lithium as anode, Celgard 2400 separator, and non-aqueous electrolyte. The data for both cells are presented in FIGS. 19, 20 and 11, 12.

In the experimental data presented in Table 2 and FIG. 31 and in previous examples, the organic-inorganic hybrid cathode with the composition of SPoly:TiS₂:SPC65:CMC:SBR (77:7:12:3.5:0.5 wt %) gave higher discharge capacity and specific energy than the cathode with sulfurized carbon matrix with the composition of SPoly:SPC65:CMC:SBR (84:12:3.5:0.5 wt %). Both cells were made with metallic lithium as anode, Celgard 2400 separator, and non-aqueous electrolyte. The data for both cells are presented in FIGS. 25, 26, and 11, 12.

In the experimental data presented in Table 2 and FIGS. 31 and 32 and in previous examples, the organic-inorganic hybrid cathode with the composition of SPoly:Al₂O₃:SPC65:CMC:SBR (77:7:12:3.5:0.5 wt %) gave higher discharge capacity and specific energy than the cathode with sulfurized carbon matrix with the composition of SPoly:SPC65:CMC:SBR (84:12:3.5:0.5 wt %). Both cells were made with metallic lithium as anode, Celgard 2400 separator, and non-aqueous electrolyte. The data for both cells are presented in FIGS. 27, 28, and 11, 12.

The results from overall data analyses reported in Table 2 and FIGS. 31 and 32 and in previous examples support the conclusion that addition of inorganic materials into the sulfurized organic redox active material (SPoly), significantly improved the battery performance in terms overall specific energy (Wh/kg), cycle life and coulombic efficiency, in accordance with the present disclosure.

### Example 32: Anode

Anode active materials of the present of disclosure can comprise, various alkali-ion battery anode materials, in particular metallic lithium in the form of lithium foil, powdered lithium, lithium deposited onto a conducting or non-conducting substrate, such copper foil, lithium alloys such as, lithium-aluminum alloys, lithium-tin alloys. In some embodiments, anode active materials can be metallic sodium, metallic potassium, graphite, hard carbon, lithiated graphite, in situ lithiated graphite, silicon, in situ lithiated silicon, silicon-graphite, in situ lithiated silicon-graphite, hard carbon, lithiated hard carbon, sodiated hard carbon, in situ sodiated hard carbon silicon containing materials, lithiated silicon containing materials, phosphorus, or sodiated phosphorus materials.

### Example 33: Conductive Carbons

Conductive carbon additives can be used in connection with hybrid inorganic-organic material of the present disclosure

The conductive additive can be 2-20% by weight of one selected from the group of Carbon Black (Acetylene Black, Super P Li, C-energy SPC65, Ketjen Black-300, Ketjen Black-600), Imerys (Super P, C-energy), carbon nanotubes (CNano, Tuball), graphene (xGnP Grade R, xGnP Grade H, xGnP Grade C, xGnP Grade M), graphene oxide, Graphite (KS-4, KS-8, KC-4, KC-8), and aluminum powder, nickel powder or any combination thereof.

### Example 34 Binders

Conductive carbon additives can be used in connection with hybrid inorganic-organic material of the present disclosure

The binder can be 1-20% by weight of one or more selected from the group of polytetrafluoroethylene (PTFE), styrene-butadiene or styrene-butadiene rubber (SBR), poly(vinylidene-fluoride) (PVDF), poly(tetrafluoroethylene), various sodium salt of carboxymethylcellulose with different molecular weights and degree of substitutions (CMC-Na), polyacrylic acid (PAA), polyvinyl alcohol (PVA), polyethylene glycol (PEG or PEO), polyamide imide (PAI), polyacrylonitrile (PAN), xanthan Gum, Gum Arabic, and Agar any combination thereof. With increased stability of active material or network polymer, the amount of binders in the electrode can be reduced accordingly physical stability of the electrode composition. As used herein, a binder as used herein refers to a polymeric material which is non redox active under the battery working condition but enhance the adhesion and cohesion of the electrodes.

### Example 35: Separators

The electrochemical cells described in the present invention comprise of an anode, a cathode, an electrolyte, and a separator. A separator is placed in between cathode and anode and can be any porous non-conductive polymeric material which is non-reactive, capable of insulting anode active materials and cathode active materials, but capable of conducting the ions between them. Typical examples of separators include, but are not limited to, polyolefins such as polyethylenes and polypropylenes, glass fiber papers, and ceramic materials. In some embodiments, Celgard 2400 is used as separator. In some embodiments various polyethylene (PE) separators such as PE8, SW4, TOB-16, SV12, SVT22 are used as separators. In other embodiments, ceramic coated polypropylene SH2214 is used as separator. Separators of different thickness ranging from 5 micron to 50 micron are used in the invention.

### Example 36: Electrolytes

Nonaqueous electrolytes used in this invention include, but are not limited to, acyclic ethers, cyclic ethers, glymes, polyethers, sulfolane, sulfones, acetals, ketals, carbonates, dioxolanes and their mixtures thereof. Examples of acyclic ethers include, but are not limited to, 1,2-dimethoxyethane (DME), trimethoxyethane (TME), diethyl ether (DEE), dimethoxypropane, diethoxyethane.

Examples of cyclic ethers include, but are not limited to, 1,4-dioxane, 1,3-dioxolane, tetrahydrofuran, 2-methyltetrahydrofuran. Examples of polyethers include, but are not limited to, diethylene glycol dimethyl ether (diglyme), diethylene glycol methyl ethyl ether, triethylene glycol dimethyl ether (triglyme), tetraethylene glycol dimethyl ether (tetraglyme), higher molecular weight glymes, diethylene glycol divinylether, ethylene glycol divinylether, triethylene glycol divinylether, tetraethylene glycol divinylether. Examples of sulfones and sulfolanes include, but are not limited to, 3-methyl sulfolane, 3-sulfolene, dimethyl sulfone, diethyl sulfone, sulfolane, 3-flurosulfolane. Examples of carbonate solvents include, but are not limited to, dimethyl carbonate (DMC), diethyl carbonate (DEC), propylene carbonate (PC), ethylene carbonate (EC), fluro-ehtylene carbonate (FEC), vinylene carbonate (VC).

Examples of lithium salts used in this disclosure include, but are not limited to, LiTFSI, LIFSI, LiOTf, LiCO₄, LiBF₄, LiPF₆ LiSCN, LiI, LiAsF₆, LiFSI, LiN₃, LiF, LiOAc, lithium formate, LiSO₃CH₃. The range of concentrations of lithium salts used are from 0.2M to 2M (for example 0.5M to 6M concentrations can be used).

### Example 37: Electrolyte Preparation

All electrolytes were prepared inside the glove box with the H₂O and O₂ levels <10 ppm by mixing appropriate lithium salt and solvent as described in the following Table. H₂O contents of the electrolytes were measured by a Karl Fisher Titrator. H₂O levels were found to be <25 ppm in all the electrolytes.

| Electrolyte Composition | Electrolyte ID |
|---|---|
| 1M LiTFSI in DME | ANA-1 |
| 1M LiTFSI in DME + 100 mM LiNO₃ | ANA-2 |
| 2M LiTFSI in DME | ANA-3 |
| 1M LiTFSI in DME:13DOL (1:1 vol) | ANA-4 |
| 1M LiTFSI in DME:13DOL (1:1 vol) + 100 mM | ANA-5 |
| LiNO₃ | |
| 2M LiTFSI in DME:13DOL (1:1 vol) | ANA-6 |
| 2M LiTFSI in DME:13DOL (1:1 vol) + 100 mM | ANA-7 |
| LiNO₃ | |
| 1M LiFSI in DME | ANA-8 |
| 1M LiFSI in DME:13DOL (1:1 vol) | ANA-9 |
| 2M LiFSI in DME:13DOL (1:1 vol) | ANA-10 |
| 1M LiFSI + 1M LiFSI in DME:13DOL (1:1 vol) | ANA-11 |
| 2M LiTFSI in DME:13DOL:DEE (0.4:0.4:0.2 vol) | ANA-12 |
| 1M LiTFSI in DME:13DOL:DEE (0.4:0.4:0.2 vol) | ANA-13 |
| 1M LiClO₄ in DME:13DOL (1:1 vol) | ANA-14 |
| 1M LiTFSI + 1M LiClO₄ in DME:13DOL (1:1 vol) | ANA-15 |
| 3M LiTFSI in DME:13DOL (1:1 vol) | ANA-18 |
| 2M LiTFSI in Sulfolane | ANA-19 |
| 2M LiOTf in DME:13DOL (1:1 vol) | ANA-20 |
| ANA-18:BTFE (7:3 vol) | ANA-30 |
| ANA-18:PC (9:1 vol) | ANA-32 |
| ANA-18:EC (9:1 vol) | ANA-33 |
| ANA-18:DEC (9:1 vol) | ANA-34 |
| 4M LiTFSI in DME:13DOL (1:1 vol) | ANA-36 |
| 5M LiTFSI in DME:13DOL (1:1 vol) | ANA-37 |
| ANA-37:BTFE (8:2 vol) | ANA-38 |
| 1M LiTFSI in MPPyTFSI | ANA-39 |
| 1M LiFSI in MPPyTFSI | ANA-41 |
| 1.2M LiFSI in BTFE:TEP (3:1 mol) | ANA-42 |
| ANA-42:ANA-39 (8:2 vol) | ANA-43 |
| ANA-42:ANA-41 (8:2 vol) | ANA-44 |
| ANA-37:TEP (8:2 vol) | ANA-45 |
| 2M LiTFSI in BTFE:TEP (1:1 vol) | ANA-47 |
| 1.2M LiFSI in TEP:TEETFE (1:3 mol) | ANA-48 |
| 1.2M LiFSI in TEP:DEE (1:3 mol) | ANA-56 |
| 1.2M LiFSI in TEP | ANA-57 |
| 1.2M LiFSI in DMMP | ANA-58 |
| 1.0M LiFSI in TEP:ENFB (3:3 mol) | ANA-59 |
| 1.0M LiFSI in TEP:MPFB (2:3 mol) | ANA-60 |
| 1.0M LiFSI in TEP:TFETFP-E (2:3 mol) | ANA-61 |

### Example 38: Coin Cell Assembly with Lithium Metal as Anode

For the cell tests, CR-2032 type coin cells were assembled with the prepared and pressed cathodes and lithium foil anode separated by 25 μm Celgard 2400, unless otherwise mentioned, membrane separator. The cell was assembled in an argon glovebox with H₂O and O₂ contents <0.1 ppm. An 80 μL of electrolyte was added to each coin cell, unless otherwise mentioned. The active material loading of each cathode used was 3.00 mAh/cm², unless otherwise mentioned. The cell was cycled between 1.0-3.2V. The activation cycles were performed at C/10 for 4 cycles.

### Example 39: Screening of Inorganic Additives

Candidates for inorganic materials can be screened by performing electrode preparation as exemplified below.

The organic-inorganic hybrid cathode can be prepared according to the following three main steps, which in screening methods can be complemented with testing of properties and performances of the resulting materials.

### Mixing Candidate Inorganic Additive and Organic Redox Active Material:

The first step is that of mixing organic SPoly with an inorganic additive and conducting carbon in certain proportions described in some of the embodiments. The inorganic additive must be chemically inert to SPoly and a vice-versa, especially during the mixing process.

When performed to screen candidate inorganic additive, the mixing can be combined with testing of cross-reaction of inorganic and organic materials to select inorganic materials that are chemically inert to the matrix and discard the candidates that react with the matrix to an extent of changing the properties of the hybrid material and make it unsuitable for use as electrode materials. These reactions can be detected according to various methods identifiable by a skilled person. For example, candidate inorganic material which will either form an agglomerate which rapidly thickens the mixture, or will phase-separate in the mixture to give an inhomogeneous sample be discarded as suitable candidate as a component for our organic-inorganic hybrid electrode composition.

### Slurry Preparation and Electrode Coating:

Following the mixing the hybrid material is combined with a suitable solvent to provide a slurry used for electrode coating. For example to the mixed organic-inorganic material with conducting carbon was then added 1-5 wt % of CMC/H₂O solution.

When performed to screen candidate inorganic additive, the slurry preparation and electron coating can be combined with testing of cross-reaction of inorganic and organic materials to select inorganic materials that do not cross react with the solvent changing the properties of the slurry to make it unsuitable for electrode coating Thus when water and CMC, the inorganic additive must be chemically inert to water and CMC. If the additive reacts chemically with this solution, to either change color, agglomerate, or form a very viscous gel which is not flowable, that particular inorganic additive will be discarded candidate as a component for our organic-inorganic electrode composition.

### Densification of the Electrode:

In preparing an electrode densification is achieved by passing the coated electrode through a roller under high pressure, and at elevated temperature. The primary goal of densification is to ensure a compacted cathode with improved mechanical strength and electrical conductivity.

When performed to screen candidate inorganic additive, the densification can be combined with testing of cross-reaction of inorganic and organic materials to select inorganic materials which do not impair the required or desired properties of the resulting electrode, as will be understood by a skilled person. For example if the electrode comprising organic-inorganic hybrid material becomes brittle, or deformed, or damaged during the densification process, then that particular inorganic additive can be discarded as a component for organic-inorganic hybrid electrode composition of the disclosure.

### Testing of Cell Performance:

Cell performance testing records the discharge capacity (in mAh/g) at 0.1 C rate (1 hr charge/discharge) and cycle life.

When performed to screen candidate inorganic additive, the testing of cell performance can be performed with selected threshold of discharge capacity and/or cyclability to select inorganic materials which optimize the performance of the electrode according to set values defining a desired performance as will be understood by a skilled person.

For example, the testing of cell performance testing can be performed to select inorganic materials which have a discharge capacity of at least 600 mAh/g and a cycle life of at least 200 cycles.

In those embodiments, if the discharge capacity of the organic-inorganic hybrid cathode is found to be less 600 mAh/g, then that particular inorganic additive will be discarded as a component for our organic-inorganic hybrid electrode composition. Furthermore, if the cycle life is less than >200 cycles to 80% retention of the initial capacity, then that particular inorganic additive will be further discarded as a component for the organic-inorganic hybrid electrode composition of those embodiments.

Candidate inorganic material can be tested for type of material, sizes, surface areas, shapes and additional features of the inorganic additive particles identifiable by a skilled person upon reading of the present disclosure.

### Example 40: Coating of Graphite Electrode

The graphite material was purchased from Anovion Technologies (G2000, 10 μm and 20 μm particle size). In a sealed jar the graphite material (G2000, 20 um) and SPC65 carbon were taken together and thoroughly mixed. A 2.5 wt % solution of CMC (Textruecell, 2000PBA07) was slowly introduced into the powder. A 2.5 wt % CMC solution was kneaded into the dry powder of graphite and SPC65.

The dry powder then slowly turned into a dough, and then slowly turned into a flowable slurry. The kneading was very important to obtain the 60 wt % of solids in the slurry. The viscosity of the slurry was adjusted to be around 5,000 to 10,000 cP. After adjusting the slurry viscosity, was then added 1 wt % SBR and iso-propanol (IPA) to reduce the slurry edge bead.

The final mixture was mixed using a planetary mixture. The slurry was then coated onto a side 1 of copper foil. The side was dried on the coater oven, then side 2 was coated using the same roll to roll coater, and dried in the coater oven at 60° C. The final composition of the graphite electrode came out as graphite:SPC65:SBR:CMC (95:2.5:1.0:1.5). The loading of the graphite electrode was found to be 6.3 mAh/cm². All the graphite cells were made using this graphite electrode.

### Example 41: Lithiation of Graphite Electrode

A coated graphite electrode (Example 40) with an areal capacity of 6.3 mAh/cm² was punched out (1.54 cm²) and placed in a 2032 coin cell Can. A 35 μm thin lithium foil (7 mAh/cm²) was also punched out (1.54 cm²) in an argon glovebox, and placed on top of the graphite electrode. An electrolyte was added to the cell.

The coin cell was then closed and let it sit overnight in the argon glovebox. The golden colored lithiated graphite electrode was harvested, dried and used to make coin cells with various organic-inorganic hybrid cathode electrodes. The graphite electrode was lithiated in situ by placing a thin layer of Li foil (usually 50-35 μm) on top of graphite electrode (Example 40), then placed a separator (Example 35), and then an organic-inorganic hybrid cathode followed by electrolyte.

### Example 42: Twelfth Representative Example: In Situ Lithiated Graphite-Organic:Inorganic Hybrid (SPoly:LFP) Coin Cell

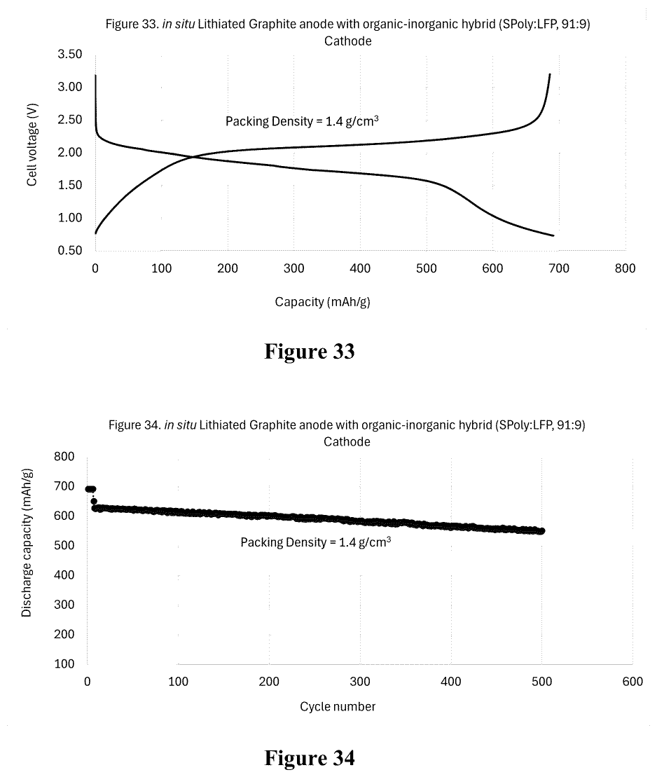

The SPoly:LFP (91:9) organic-inorganic hybrid cathode (coated as Example 11) was densified to electrode packing density 1.4 g/cm³ using a high-pressure hydraulic roller at 40° C. according to a procedure exemplified in Example 19. The areal loading of the cathode was 3.2 mAh/cm². After establishing the cyclability of SPoly:LFP (91:9) organic-inorganic hybrid cathode with lithium metal anode (Example 22, FIGS. 13 and 14), a CR2032-type coin cells were assembled in an argon-filled glovebox (H₂O<1 ppm, O₂<1 ppm) with an in situ lithiated-graphite (assembled as Example 41) as anode, microporous polypropylene membrane (Celgard 2400) as separator, 180+20volFEC/LiFSI as non-aqueous electrolyte under lean electrolyte condition, and the above-mentioned SPoly:LFP (91:9) as the cathode active material. The cell was cycled at C/10 in a Neware Battery Tester (BTS-4000). The data is presented in FIGS. 33 and 34. A stable voltage profile was observed when the cell was cycled within the voltage range of 0.7-3.2V (FIG. 33). The discharged capacity was found to be 691 mAh/g at C/10 (FIG. 33). The cell was cycled from 0.7V-3.2V voltage range for 100 cycles (FIG. 34) with a no capacity decay. The specific energy was found to be 1135 Wh/kg.

### Example 43: Coin Cell Assembly with In Situ Lithiated Graphite as Anode: SPoly:LTO

After establishing the excellent cyclability SPoly:LTO (91:9) of organic-inorganic hybrid cathode with metallic lithium as anode (Example 25, FIGS. 19 and 20), a CR2032-type coin cells were assembled in an argon-filled glovebox (H₂O<1 ppm, O₂<1 ppm) with an in situ lithiated-graphite (assembled as Example 41) as anode, microporous polypropylene membrane (Celgard 2400) as separator, 180+20volFEC/LiFSI as non-aqueous electrolyte under lean electrolyte condition, and the above-mentioned SPoly:LTO (electrode packing density 1.3 g/cm³) as the cathode active material. The cell was cycled at C/10 in a Neware Battery Tester (BTS-4000).

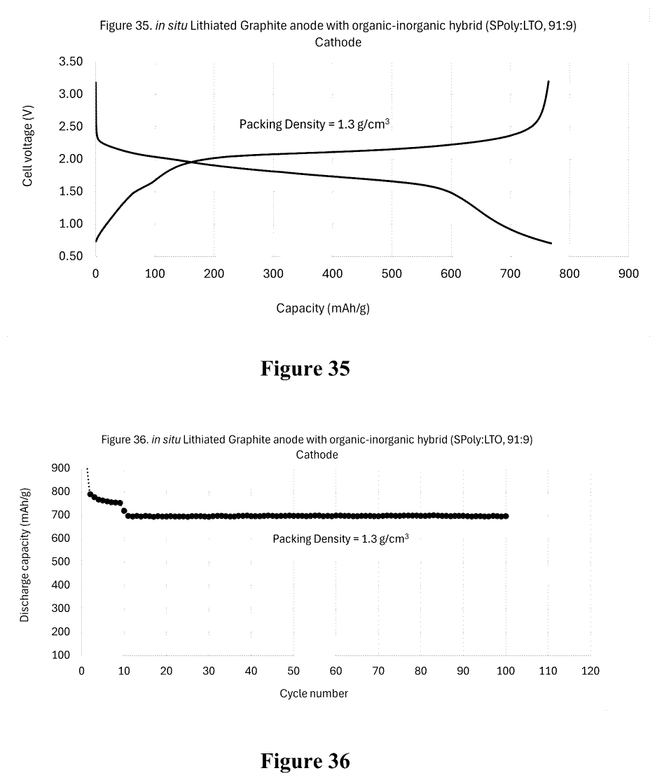

The data is presented in FIGS. 35 and 36. A stable voltage profile was observed when the cell was cycled within the voltage range of 0.7-3.2V (FIG. 35). The discharged capacity was found to be 768 mAh/g at C/10 (FIG. 35). The cell was cycled from 0.7V-3.2V voltage range for 100 cycles (FIG. 36) with a no apparent capacity decay. The specific energy was found to be 1276 Wh/kg. The higher discharge capacity (768 mAh/g) and higher discharge specific energy (1276 Wh/kg) were attributed to the additional capacity of LTO added to the SPoly within the voltage range (0.7-3.2V) of the battery cycling. The SPoly:LTO (91:9) hybrid cathode gave higher discharge capacity and specific energy than the SPOly:LFP (91:9) hybrid cathode due to the additional capacity of LTO within the cycling voltage range (0.7-3.2V), as mentioned above. The LTO particles created a percolating network for electrolyte to properly wet the electrode even when the density of the electrode was very high (1.3 g/cm³). The cell was cycled from 0.7-3.2V voltage range for 100 cycles (FIG. 36) with a no capacity decay.

### Example 44: Coin Cell Assembly with In Situ Lithiated Graphite as Anode: SPoly:TiS₂

After establishing the excellent cyclability SPoly:TiS₂ (91:9) of organic-inorganic hybrid cathode with metallic lithium as anode (Example 28, FIGS. 25 and 26), a CR2032-type coin cells were assembled in an argon-filled glovebox (H₂O<1 ppm, O₂<1 ppm) with an in situ lithiated-graphite (assembled as Example 41) as anode, microporous polypropylene membrane (Celgard 2400) as separator, 180+20volFEC/LiFSI as non-aqueous electrolyte under lean electrolyte condition, and the above-mentioned SPoly:TiS₂ (electrode packing density 1.4 g/cm³) as the cathode active material. The cell was cycled at C/10 in a Neware Battery Tester (BTS-4000).

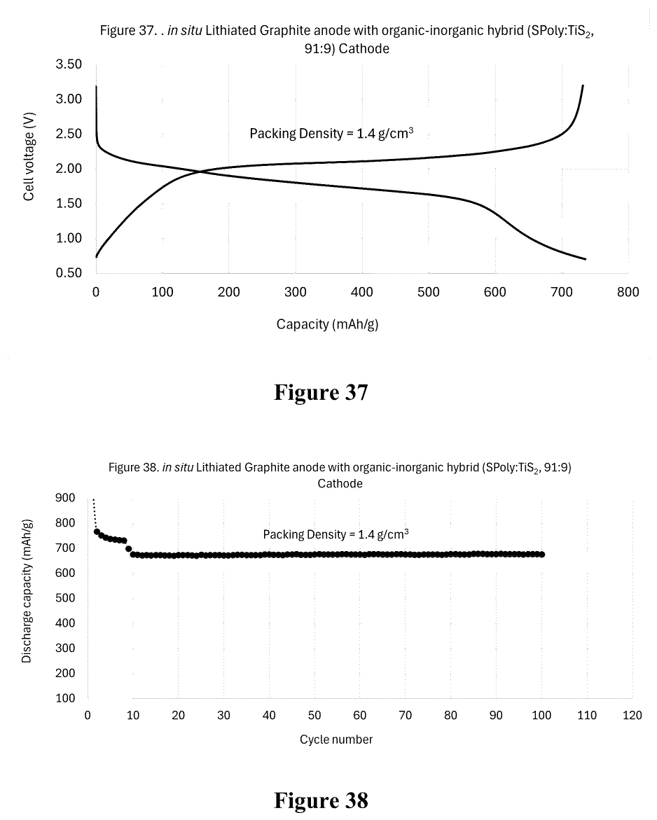

The data is presented in FIGS. 37 and 38. A stable voltage profile was observed when the cell was cycled within the voltage range of 0.7-3.2V (FIG. 37). The discharged capacity was to be 736 mAh/g at C/10 (FIG. 37). The cell was cycled from 0.7V-3.2V voltage range for 100 cycles (FIG. 38) with a no apparent capacity decay.

The specific energy was found to be 1225 Wh/kg. The higher discharge capacity (736 mAh/g) and higher discharge specific energy (1225 Wh/kg) were attributed to the additional capacity of TiS₂ added to the SPoly within the voltage range (0.7-3.2V) of the battery cycling. The SPoly:TiS₂ (91:9) hybrid cathode gave higher discharge capacity and specific energy than the SPOly:LFP (91:9) hybrid cathode due to the additional capacity of TiS₂ within the cycling voltage range (0.7-3.2V), as mentioned above. The TiS₂ particles created a percolating network for electrolyte to properly wet the electrode even when the packing density of the electrode was very high (1.4 g/cm³).

### Example 45: Coin Cell Assembly with In Situ Lithiated Graphite as Anode:SPoly:ccLTO

The coating of the SPoly:ccLTO hybrid cathode was performed by following the procedure described in Example 12. It is noteworthy to mention that the addition of inorganic additive ccLTO improved the slurry rheology and viscosity during the cathode fabrication, and the adhesion and cohesion of the cathode was found to be superior to the SPoly cathode. The final composition of the hybrid electrode came out to be SPoly:ccLTO:SPC65:CMC:SBR (77:7:12:3.5:0.5 wt %).

The hybrid electrode was densified to 1.3 g/cm³ using a high-pressure hydraulic roller at 40° C. The areal loading of the cathode was 3.3 mAh/cm². The high areal loading (3.3 mAh/cm²) was due to the additional capacity of ccLTO (175 mAh/g) it brought to the SPoly electrode. A CR2032-type coin cells were assembled in an argon-filled glovebox (H₂O<1 ppm, O₂<1 ppm) with a lithiated-graphite (as assembled in Example 34) as anode, microporous polypropylene membrane (Celgard 2400) as separator, 180+20volFEC/LiFSI as non-aqueous electrolyte under lean electrolyte condition, and the afore-mentioned SPoly:ccLTO as the cathode active material. The cell was cycled at C/10 in a Neware Battery Tester (BTS-4000).

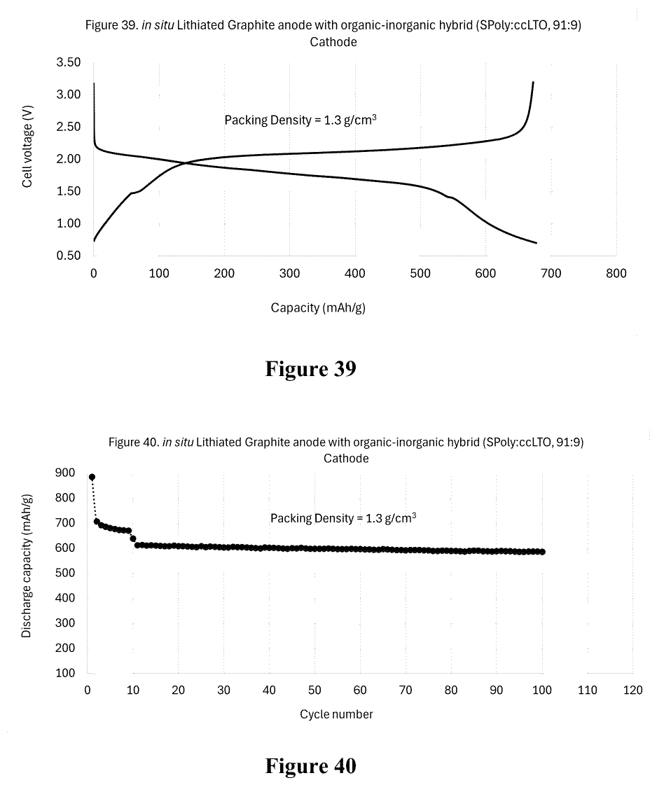

The data is presented in FIGS. 39 and 40. A stable voltage profile was observed when the cell was cycled within the voltage range of 0.7-3.2V (FIG. 39). The discharged capacity was to be 682 mAh/g at C/10 (FIG. 39). This higher capacity was attributed to the additional capacity of ccLTO added to the SPoly cathode. The ccLTO particles created a percolating network for electrolyte to properly wet the electrode even when the density of the electrode was very high (1.3 g/cm³). The cell was cycled from 0.7-3.2V voltage range for 100 cycles (FIG. 40) with a no capacity decay.

The examples set forth above are provided to give those of ordinary skill in the art a complete disclosure and description of how to make and use the embodiments of the organosulfur polymer, materials, compositions, systems and methods of the disclosure, and are not intended to limit the scope of what the inventors regard as their disclosure. All patents and publications mentioned in the specification are indicative of the levels of skill of those skilled in the art to which the disclosure pertains.

The entire disclosure of each document cited (including patents, patent applications, journal articles including related supplemental and/or supporting information sections, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed. Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The term “alkyl” as used herein refers to a linear, branched, or cyclic saturated hydrocarbon group typically although not necessarily containing 1 to about 15 carbon atoms, or 1 to about 6 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl and the like. Generally, although again not necessarily, alkyl groups herein contain 1 to about 15 carbon atoms. The term “cycloalkyl” intends a cyclic alkyl group, typically having 4 to 8, or 5 to 7, carbon atoms. The term “substituted alkyl” refers to alkyl substituted with one or more substituent groups, and the terms “heteroatom-containing alkyl” and “heteroalkyl” refer to alkyl in which at least one carbon atom is replaced with a heteroatom. If not otherwise indicated, the terms “alkyl” and “lower alkyl” include linear, branched, cyclic, unsubstituted, substituted, and/or heteroatom-containing alkyl and lower alkyl, respectively.

The term “heteroatom-containing” as in a “heteroatom-containing alky group” refers to an alkyl group in which one or more carbon atoms is replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and “heteroaromatic” respectively refer to “aryl” and “aromatic” substituents that are heteroatom-containing, and the like. It should be noted that a “heterocyclic” group or compound may or may not be aromatic, and further that “heterocycles” may be monocyclic, bicyclic, or polycyclic as described above with respect to the term “aryl.” Examples of heteroalkyl groups include alkoxyaryl, alkylsulfanyl-substituted alkyl, N-alkylated amino alkyl, and the like. Examples of heteroaryl substituents include pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups are pyrrolidino, morpholino, piperazino, piperidino, and additional substituents identifiable by a skilled person.

The term “alkoxy” as used herein intends an alkyl group bound through a single, terminal ether linkage; that is, an “alkoxy” group may be represented as —O-alkyl where alkyl is as defined above. A “lower alkoxy” group intends an alkoxy group containing 1 to 6 carbon atoms. Analogously, “alkenyloxy” and “lower alkenyloxy” respectively refer to an alkenyl and lower alkenyl group bound through a single, terminal ether linkage, and “alkynyloxy” and “lower alkynyloxy” respectively refer to an alkynyl and lower alkynyl group bound through a single, terminal ether linkage.

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Aryl groups can contain 5 to 24 carbon atoms, or aryl groups contain 5 to 14 carbon atoms. Exemplary aryl groups contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituents in which at least one carbon atom is replaced with a heteroatom, as will be described in further detail infra.

The terms “cyclic”, “cyclo-”, and “ring” refer to alicyclic or aromatic groups that may or may not be substituted and/or heteroatom containing, and that may be monocyclic, bicyclic, or polycyclic. The term “alicyclic” is used in the conventional sense to refer to an aliphatic cyclic moiety, as opposed to an aromatic cyclic moiety, and may be monocyclic, bicyclic or polycyclic.

The term “isomers” as used refers to heterocyclic aromatic groups that have the same core molecular but may differ in atomic connectivity and/or location of unsaturation and is meant to include all possible structural variants. For example, as shown below, “pyrrole isomers” refers to all possible substituted variants of 1H-pyrrole and 2H-pyrrole; “indole isomers” refers to all possible substituted variants of 3H-indole, 1H-indole and 2H-isoindole, and so on:

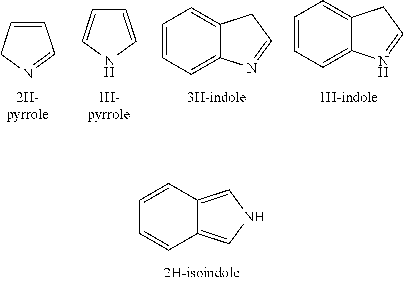

Likewise, as shown below, “triazole isomers” refers to all possible substituted variants of 1,2,4-triazole and 1,2,3-triazole; “oxadiazole isomers” refers to all possible substituted variants of 1,2,5-oxadiazole and 1,2,3-oxadiazole, and so on:

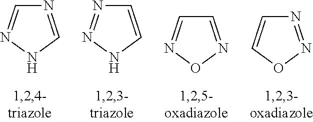

The terms “halo”, “halogen”, and “halide” are used in the conventional sense to refer to a chloro, bromo, fluoro or iodo substituent or ligand.

The term alkylene as used herein refers to an alkanediyl group which is a divalent saturated aliphatic group, with two carbon atoms as points of attachment, a linear or branched, cyclo, cyclic or acyclic structure. Exemplary alkylene includes propane-1,2-diyl group (—CH(CH3)CH2-) or propane-1,3-diyl group (—CH2CH2CH2-).

The term alkenylene refers to an alkenediyl group which is a divalent unsaturated aliphatic group, with two carbon atoms as points of attachment, a linear or branched, cyclo, cyclic or acyclic structure, at least one nonaromatic carbon-carbon double bond. Exemplary alkylene includes 2-butene-1,4-diyl group (—CH2CH═CHCH2-).

The term alkynylene refers to an alkynediyl group which is a divalent unsaturated aliphatic group, with two carbon atoms as points of attachment, a linear or branched, cyclo, cyclic or acyclic structure, at least one nonaromatic carbon-carbon triple bond. Exemplary alkylene includes 2-butyne-1,4-diyl group (—CH2C≡CCH2-).

The term “substituted” as in “substituted alkyl,” “substituted aryl,” and the like, is meant that in the alkyl, aryl, or other moiety, at least one hydrogen atom bound to a carbon (or other) atom is replaced with one or more non-hydrogen substituents.

Examples of such substituents include, without limitation: functional groups such as halo, hydroxyl, sulfhydryl, C1-C24 alkoxy, C2-C24 alkenyloxy, C2-C24 alkynyloxy, C5-C24 aryloxy, C6-C24 aralkyloxy, C6-C24 alkaryloxy, acyl (including C2-C24 alkylcarbonyl (—CO-alkyl) and C6-C24 arylcarbonyl (—CO-aryl)), acyloxy (—O-acyl, including C2-C24 alkylcarbonyloxy (—O—CO-alkyl) and C6-C24 arylcarbonyloxy (—O—CO-aryl)), C2-C24 alkoxycarbonyl (—(CO)—O-alkyl), C6-C24 aryloxycarbonyl (—(CO)—O-aryl), halocarbonyl (—CO)—X where X is halo), C2-C24 alkylcarbonato (—O—(CO)—O-alkyl), C6-C24 arylcarbonato (—O—(CO)—O-aryl), carboxy (—COOH), carboxylato (COO⁻), carbamoyl (—(CO)—NH2), mono-(C1-C24 alkyl)-substituted carbamoyl (—(CO)—NH(C1-C24 alkyl)), di-(C1-C24 alkyl)-substituted carbamoyl (—(CO)—N(C1-C24 alkyl)2), mono-(C5-C24 aryl)-substituted carbamoyl (—(CO)—NH-aryl), di-(C5-C24 aryl)-substituted carbamoyl (—(CO)—N(C5-C24 aryl)2), di-N—(C1-C24 alkyl),N—(C5-C24 aryl)-substituted carbamoyl, thiocarbamoyl (—(CS)—NH2), mono-(C1-C24 alkyl)-substituted thiocarbamoyl (—(CO)—NH(C1-C24 alkyl)), di-(C1-C24 alkyl)-substituted thiocarbamoyl (—(CO)—N(C1-C24 alkyl)2), mono-(C5-C24 aryl)-substituted thiocarbamoyl (—(CO)—NH-aryl), di-(C5-C24 aryl)-substituted thiocarbamoyl (—(CO)—N(C5-C24 aryl)2), di-N—(C1-C24 alkyl),N—(C5-C24 aryl)-substituted thiocarbamoyl, carbamido (—NH—(CO)—NH2), cyano(-C≡N), cyanato (—O—C≡N), thiocyanato (—S—C≡N), formyl (—(CO)—H), thioformyl ((CS)—H), amino (—NH2), mono-(C1-C24 alkyl)-substituted amino, di-(C1-C24 alkyl)-substituted amino, mono-(C5-C24 aryl)-substituted amino, di-(C5-C24 aryl)-substituted amino, C2-C24 alkylamido (—NH—(CO)-alkyl), C6-C24 arylamido (—NH—(CO)-aryl), imino (—CR═NH where R=hydrogen, C1-C24 alkyl, C5-C24 aryl, C6-C24 alkaryl, C6-C24 aralkyl, etc.), C2-C20 alkylimino (CR═N(alkyl), where R=hydrogen, C1-C24 alkyl, C5-C24 aryl, C6-C24 alkaryl, C6-C24 aralkyl, etc.), arylimino (—CR═N(aryl), where R=hydrogen, C1-C20 alkyl, C5-C24 aryl, C6-C24 alkaryl, C6-C24 aralkyl, etc.), nitro (—NO₂), nitroso (—NO), sulfo (—SO2-OH), sulfonato (—SO2-O—), C1-C24 alkylsulfanyl (—S-alkyl; also termed “alkylthio”), C5-C24 arylsulfanyl (—S-aryl; also termed “arylthio”), C1-C24 alkylsulfinyl (—(SO)-alkyl), C5-C24 arylsulfinyl (—(SO)-aryl), C1-C24 alkylsulfonyl (—SO2-alkyl), C5-C24 arylsulfonyl (—SO2-aryl), boryl (—BH2), borono (—B(OH)2), boronato (—B(OR)2 where R is alkyl or other hydrocarbyl), phosphono (—P(O)(OH)2), phosphonato (—P(O)(0)2), phosphinato (—P(O)(O⁻)), phospho (—PO₂), phosphino (—PH2), silyl (—SiR3 wherein R is hydrogen or hydrocarbyl), and silyloxy (—O-silyl); and the hydrocarbyl moieties C1-C24 alkyl (e.g. C1-C12 alkyl and C1-C6 alkyl), C2-C24 alkenyl (e.g. C2-C12 alkenyl and C2-C6 alkenyl), C2-C24 alkynyl (e.g. C2-C12 alkynyl and C2-C6 alkynyl), C5-C24 aryl (e.g. C5-C14 aryl), C6-C24 alkaryl (e.g. C6-C16 alkaryl), and C6-C24 aralkyl (e.g. C6-C16 aralkyl).

The term “acyl” refers to substituents having the formula —(CO)-alkyl, —(CO)-aryl, or —(CO)-aralkyl, and the term “acyloxy” refers to substituents having the formula —O(CO)— alkyl, —O(CO)-aryl, or —O(CO)-aralkyl, wherein “alkyl,” “aryl, and “aralkyl” are as defined above.

The term “alkaryl” refers to an aryl group with an alkyl substituent, and the term “aralkyl” refers to an alkyl group with an aryl substituent, wherein “aryl” and “alkyl” are as defined above. In some embodiments, alkaryl and aralkyl groups contain 6 to 24 carbon atoms, and particularly alkaryl and aralkyl groups contain 6 to 16 carbon atoms. Alkaryl groups include, for example, p-methylphenyl, 2,4-dimethylphenyl, p-cyclohexylphenyl, 2,7-dimethylnaphthyl, 7-cyclooctylnaphthyl, 3-ethyl-cyclopenta-1,4-diene, and the like. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like. The terms “alkaryloxy” and “aralkyloxy” refer to substituents of the formula —OR wherein R is alkaryl or aralkyl, respectively, as just defined.

The term “Periodic Table” refers to the version of IUPAC Periodic Table of the Elements dated Nov. 28, 2016 [12].

When a Markush group or other grouping is used herein, all individual members of the group and all combinations and possible subcombinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure. Whenever a range is given in the specification, for example, a temperature range, a frequency range, a time range, or a composition range, all intermediate ranges and all subranges, as well as all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations, which is not specifically disclosed herein.

“Optional” or “optionally” means that the subsequently described circumstance may or may not occur, so that the description includes instances where the circumstance occurs and instances where it does not according to the guidance provided in the present disclosure. For example, the phrase “optionally substituted” means that a non-hydrogen substituent may or may not be present on a given atom, and, thus, the description includes structures wherein a non-hydrogen substituent is present and structures wherein a non-hydrogen substituent is not present. It will be appreciated that the phrase “optionally substituted” is used interchangeably with the phrase “substituted or unsubstituted.” Unless otherwise indicated, an optionally substituted group may have a substituent at each substitutable position of the group, and when more than one position in any given structure may be substituted with more than one substituent selected from a specified group, the substituent may be either the same or different at every position. Combinations of substituents envisioned can be identified in view of the desired features of the compound in view of the present disclosure, and in view of the features that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

In summary, in several embodiments, described herein are organosilicon compound, related complex that allow performance of fluorocarbon compound or olefin-based reactions and in particular polymerization of olefins to produce polyolefin polymers, and related methods and systems are described.

In particular, it will be understood that various modifications may be made without departing from the spirit and scope of the present disclosure. Accordingly, other embodiments are within the scope of the following claims.

### REFERENCES

1. IUPAC, Compendium of chemical terminology (the “Gold Book”). 2nd ed. 1997: Blackwell Science Oxford.
2. Goldbook, I. quinones. 2014; Available from: goldbook.iupac.org/terms/view/Q05015.
3. Patai, S. and Z. Rappoport, The Quinonoid Compounds vol 1. 1988, John Wiley & Sons Ltd., Hoboken.
4. Patai, S. and Z. Rappoport, The Quinonoid Compounds, vol 2. 1988, John Wiley & Sons Ltd., Hoboken.
5. Wikipedia-Quinone. Quinone 2022; Available from: en.wikipedia.org/wiki/Quinone.
6. Pindrus, M.A., et al., Effect of aggregation on the hydrodynamic properties of bovine serum albumin. Pharmaceutical Research, 2017. 34: p. 2250-2259.
7. Wang, J., et al., A novel conductive polymer-sulfur composite cathode material for rechargeable lithium batteries. Advanced materials, 2002. 14(13-14): p. 963-965.
8. Ahmed, M. S., et al., Multiscale understanding of covalently fixed sulfur-polyacrylonitrile composite as advanced cathode for metal-sulfur batteries. Advanced Science, 2021. 8(21): p. 2101123.
9. Shadike, Z., et al., Review on organosulfur materials for rechargeable lithium batteries. Materials Horizons, 2021. 8(2): p. 471-500.
10. Pan, Z., et al., Progress and perspectives of organosulfur for lithium-sulfur batteries. Advanced Energy Materials, 2022. 12(8): p. 2103483.
11. Zhang, S.S., Understanding of sulfurized polyacrylonitrile for superior performance lithium/sulfur battery. Energies, 2014. 7(7): p. 4588-4600.
12. IUPAC. Periodic Table. 2016; Available from: iupac.org/wp-content/uploads/2015/07/IUPAC_Periodic_Table-28Nov16.pdf.

1. A hybrid organic-inorganic redox active composite material, comprising an organic redox active material and an inorganic additive in a ratio from 3:1 to 49:1.
wherein the organic redox active material has a redox active material density and comprises a sulfurized carbon matrix represented by Formula (V), 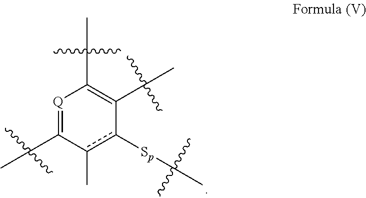
in which Q is a bonded sp2 carbon atom (C) or a nitrogen (N), wherein [symbol] represents a single or double bond, Sₚ represents a polysulfide and p ranges from 2 to 8, wherein the sulfurized carbon matrix has a weight-average molecular weight (MW) ranging from 2000 to 2,000,000 Daltons, and
in which the sulfurized carbon matrix has a sulfur content based on total weight of the sulfurized carbon matrix equal to or greater than 5 wt % and less than 20 wt %, equal to or greater than 20 wt % and less than 40 wt %, equal to or greater than 40 wt % less than 60 wt %, equal to or greater than 60 wt % less than 70 wt %, equal to or greater than 70 wt % less than 80 wt %,
wherein the inorganic additive is an inorganic material which has an inorganic material density higher than the redox active material density preferably ≥2 g/cm³, and lower than to 6.0 g/cm³, and which is chemically inert with respect to the organic redox active material.

2. The hybrid organic-inorganic redox active composite material of claim 1 wherein the organic redox active material and the inorganic additive in a ratio from 4:1 to 35:1.

3. The hybrid organic-inorganic redox active composite material of claim 1, comprising an organic redox active material and an inorganic additive in a ratio 9:1, or in 91:9 or 93:7 or 95:5.

4. The hybrid organic-inorganic redox active composite material of claim 1, wherein the inorganic additive is an inorganic material which has an inorganic material density >3.0 g/cm³.

5.-21. (canceled)

22. The hybrid organic-inorganic redox active composite material of claim 1, wherein the inorganic additive material comprises one or more inorganic particles having an inorganic particle size of 100 um or lower, 50 um or lower, 25 um or lower, 10 um or lower, 1 um or lower.

23-28. (canceled)

29. The hybrid organic-inorganic redox active composite material of claim 1, wherein the inorganic additive material comprises one or more of LFP, LTO, carbon-coated lithium iron phosphate (ccLFP), carbon-coated lithium titanate (ccLTO), alpha-Al₂O₃, a metal sulfide, gamma-Al₂O₃, TiS₂, MoS₂, LMFP, LCO, NMC532, NMC622, NMC811, TiO₂, FeS₂, Lithium Vanadium Phosphate (LVP), microporous aluminosilicate zeolite materials.

30. The hybrid organic-inorganic redox active composite material of claim 1, wherein the inorganic additive material comprises LFP particles.

31-36. (canceled)

37. The hybrid organic-inorganic redox active composite material of claim 1, wherein the inorganic additive material comprises LTO particles.

38.-48. (canceled)

49. The hybrid organic-inorganic redox active composite material of claim 1, wherein the sulfurized carbon matrix of the Formula (V) is sulfurized carbon matrix (SPoly).

50. The hybrid organic-inorganic redox active composite material of claim 1, wherein the hybrid organic-inorganic redox active composite material comprises at least one of lithium iron phosphate (LFP), lithium titanate (LTO), carbon coated lithium titanate (ccLTO), TiS₂, various forms of aluminum oxide Al₂O₃, Lithium Manganese Iron Phosphate, LiMn_{0.6}Fe_{0.4}PO₄ (LMFP), Lithium Manganese Phosphate LiMnPO₄ (LMP), Lithium Cobalt Phosphate LiCoPO₄ (LCP), Lithium Cobalt Oxide, LiCoO₂ (LCO), Lithium Nickel-Manganese-Cobalt Oxide (LiNi_{0.5}Mn_{0.3}Co_{0.2}O₂) (NMC532), Lithium Nickel-Manganese-Cobalt Oxide (LiNi_{0.6}Mn_{0.2}Co_{0.2}O₂) (NMC622), Lithium Nickel-Manganese-Cobalt Oxide (LiNi_{0.8}Mn_{0.1}Co_{0.1}O₂) (NMC811), MoS₂, electronically conductive TiOₓ, Iron disulfide (FeS₂), Lithium Vanadium Phosphate (LVP), Zeolite X, Zeolite Y, and Cu—Y zeolites.

51.-107. (canceled)

108. A cathode material comprising the hybrid organic-inorganic redox active composite material of claim 1.

109. The cathode material of claim 104, further comprising a binder, and a conductive additive, wherein the binder can optionally be selected from one of poly(vinylidene-fluoride), poly(tetrafluoroethylene), sodium carboxymethylcellulose, lithium carboxymethylcellulose, styrene-butadiene rubber (SBR), polyacrylic acid (PAA), polyvinyl alcohol (PVA), polyethylene glycol (PEG), polyethylene oxide (PEO), polyamide imide (PAI), or any combination thereof, wherein the conductive additive is selected from one of graphite, carbon black, acetylene black, Super-P carbon, aluminum powder, nickel powder, various Super-P carbons and Ketjenblack (KB) or any combination thereof.

110. The cathode material of claim 105, wherein the binder is present in 1 to 20% by weight of the redox active composite, and the conductive additive is present in 2 to 70% by weight of the redox active composite.

111. (canceled)

112. The cathode material of claim 108 having an electrode packing density of <1.3 g/cm³ to 1.5 g/cm³ or higher.

113. (canceled)

114. The cathode material of claim 108, having an electrode packing density of 1.2 to 1.8 g/cm³ or higher.

115. An electrochemical cell, the electrochemical cell comprising an anode, a cathode and a non-aqueous electrolyte or an aqueous electrolyte, wherein the cathode electrode comprises, the cathode material of claim 108.

116. The electrochemical cell of claim 115, wherein the anode comprises alkali-ion battery anode material.

117. The electrochemical cell of claim 116, wherein the alkali-ion battery anode material comprises lithium anode material, or graphite anode material or lithiated graphite material, or in situ lithiated graphite anode material, or silicon anode material or in situ lithiated silicon anode material, or a hard carbon anode material, or potassium anode material, or sodium anode material, or in situ sodiated hard carbon anode material aluminum (Al) anode material, Magnesium (Mg) anode material, Al—Mg alloys anode material, Li—Al alloys anode material or a combination thereof.

118. (canceled)

119. The electrochemical cell claim 116, wherein the alkali-ion battery anode material comprises lithiated graphite material, or in situ lithiated graphite anode material, or a combination thereof.

120.-121. (canceled)

122. A battery comprising one or more electrochemical cells of claim 115.

123.-139. (canceled)

140. The cathode material of claim 109, wherein the cathode material comprises 50 to 95 wt % of the hybrid organic-inorganic redox active composite material, 2 to 20 wt % of the conductive additive, and 1 to 20 wt % of the binder.

141. The cathode material of claim 140, wherein the organic redox active material is SPoly, the inorganic additive is lithium iron phosphate (LFP), and the cathode material comprises a dry composition of SPoly, LFP, conductive carbon, sodium carboxymethylcellulose (CMC), and styrene-butadiene rubber (SBR) in a weight ratio of 77:7:12:3.5:0.5.

142. The electrochemical cell of claim 117, wherein the anode comprises a graphite anode material comprising graphite, conductive carbon, styrene-butadiene rubber (SBR), and sodium carboxymethylcellulose (CMC) in a weight ratio of 95:2.5:1.0:1.5.

143. A method of manufacturing an electrochemical cell, the method comprising: dry mixing a sulfurized carbon matrix and an inorganic additive to form a dry mixture; adding the dry mixture to an aqueous binder solution to form a slurry; coating the slurry onto a current collector and drying to provide a cathode; and assembling the cathode, an anode, and a non-aqueous electrolyte to form the electrochemical cell.

144. The method of claim 143, wherein forming the slurry comprises adding the dry mixture to a solution comprising sodium carboxymethylcellulose (CMC) and H₃PO₄, mixing to wet the dry mixture, and subsequently adding a styrene-butadiene rubber (SBR) solution.

145. The method of claim 143, wherein assembling the electrochemical cell comprises in situ lithiating the anode by placing a lithium metal foil having a thickness of 35 μm to 50 μm on the anode prior to placing a separator and the cathode.

146. The electrochemical cell of claim 117, wherein the anode comprises silicon, lithiated silicon, silicon-graphite, or in situ lithiated silicon-graphite and wherein the anode has an areal capacity loading of 3.0 mAh/cm² or higher.

147. The cathode material of claim 108, wherein the cathode material has an areal capacity loading of 3.0 mAh/cm² or higher.

148. The electrochemical cell of claim 142, wherein the graphite anode material has an areal loading of 6.3 mAh/cm².

149. The hybrid organic-inorganic redox active composite material of claim 1, wherein the inorganic additive material comprises one or more of LFP, LTO, ccLFP, ccLTO, alpha-Al₂O₃, gamma-Al₂O₃, a metal sulfide, LMFP, LCO, NMC532, NMC622, NMC811, TiO₂, Lithium Vanadium Phosphate (LVP), and microporous aluminosilicate zeolite materials.
